(19) United States
(12) Patent Application Publication
(10) Pub. No.: US 2014/0059443 A1
(43) Pub. Date: Feb. 27, 2014

(54) SOCIAL NETWORK FOR MEDIA TOPICS OF INFORMATION RELATING TO THE SCIENCE OF POSITIVISM

(71) Applicant: JOSEPH AKWO TABE, Silver Spring, MD (US)

(72) Inventor: JOSEPH AKWO TABE, Silver Spring, MD (US)

(21) Appl. No.: 13/594,843

(22) Filed: Aug. 26, 2012

(51) Int. Cl. G06F 3/01

(52) U.S. Cl. 715/738

(57) ABSTRACT

Social media network environment for topics of information to impact social measurements, bringing generational awareness to improve community cultural and economic values. The network environment is a platform for sharing knowledge relating to fashion media, model media, and dress code media “FMDC” for human observations. The platform extracts database information and analyzes queried occurrences to identify stored patterns for communications through a centralized system, providing substance of things hoped for, revealing the evidence of things not commonly seen, which is CHANGE. CHANGE is embraced for sustainable cultural independence, for by CHANGE the society receives good reports that things which are seen were not spiritually made of things which do appear, but are made through creative minds and discoveries that may lead to economic growth, not as a means of inquiry, but rather as a dimension of social sustainability to gracefully improve corporate and community cultural interest through economic vision.

I HEREBY CLAIM PRIORITY BENEFITS FROM application Ser. No. 11/254,973, filed Nov. 12, 2005, application Ser. No. 13/481,756, filed May 25, 2012, which claims priority from application Ser. No. 13/004,912, filed Jan. 12, 2011, which claims priority benefit from application Ser. No. 12/910,833, filed Oct. 24, 2011, which claims priority benefit from application Ser. No. 12/852,481, filed Aug. 7, 2010, which claims priority benefit from application Ser. No. 12/795,567, filed Jun. 7, 2010, currently allowed, which claims priority benefit from application Ser. No. 11/475,286, filed on Feb. 28, 2006, now U.S. Pat. No. 7,769,342, which is a continuation in part of Ser. No. 10/814,087, filed on Mar. 31, 2004, now U.S. Pat. No. 7,116,942, which is a continuation in part of Ser. No. 09/559,330, filed Apr. 12, 2000, now U.S. Pat. No. 6,782,240, which claims priority benefit from provisional application Ser. No. 60/131,134, filed Apr. 27, 1999. This application further claims priority benefit from application Ser. No. 11/821,776, filed Jun. 25, 2007, now U.S. Pat. No. 7,872,575, which is a continuation in part of application Ser. No. 10/660,473, filed Sep. 12, 2003, now U.S. Pat. No. 7,271,720, which claim priority benefit from provisional application Ser. No. 60/426,800, filed Nov. 18, 2002. application Ser. No. 10/995,093, filed Nov. 24, 2004, now U.S. Pat. No. 7,839,273. Application Ser. No. 11/634,535, filed Dec. 5, 2006. Application Ser. No. 12/607,086, filed Oct. 28, 2009. Application Ser. No. 11/977,365, filed Oct. 24, 2007. All of these applications are incorporated by reference herein in their entirety.

### FIELD OF THE INVENTION

Disclosed embodiments provide a centralized transportation communication vehicle comprising a platform for advancing science, transportation and engineering knowledge, includes social network for enabling, scientist, engineers, and transportation industries, garages, transportation maintenance fleet, government agencies, police department, fire department, Homeland security department to talk to each other seamlessly in real time through the centralized system. Certain embodiments provide an engine for extracting science, engineering, and transportation topics of information from a centralized transportation database having information relating to different makes and models of transport vehicles. Some embodiments provide the engine comprising a computer apparatus configured for enabling communication with different systems and responsive to different platforms. Other embodiments provide a communication apparatus in communication with a centralized transportation searchable vehicle operable for enabling Internet and web-based searches for topics of information relating specifically to engineering topics and any make and model of transportation equipment for identifying preventive maintenance and repair patterns of that particular equipment in which the topics were stored so that additional topics can be extracted from the database for social network, knowledge sharing, and to aid file sharing within various transportation companies and mining terrorist data within the centralized transportation database.

Disclosed embodiments further provide a centralized transportation vehicle comprising a support system operable for categorizing files referenced by initial search results. The disclosure further provide neural network integrates seamlessly with all existing transportation industries, including car rental companies and all garages in the nation and around the world through their local existing systems and enabling these systems to talk to each other and communicate better in real time interaction, real responsive, real resourceful and real responsible to transportation system analysis, preventive maintenance scheduling and reprogramming, and monitoring of a terrorist person's activities through at least a name search. The centralized transportation vehicle comprises a computer apparatus in communication with a communication apparatus configured with an interface module.

Disclosed embodiments further relates to management and sharing of science, engineering, and transportation topics of information through networks of computational devices, and more particularly to database system operable for generating request of engineering and transportation information, providing at least one topic of information as an example of information associated with at least a terrorist name in a local existing system desiring a rental car, engineering topics, and transportation topics, and retrieving responses to the name, the engineering topics, and the transportation topics of information such that enhancement of identification of relevant topics of information is made accessible using such a network for repeating the searching and analyzing and extracting data for additional topics of information that is desired. The desired topics of information is further provided for tracking the last rental company and/or transportation information by the named terrorist within the centralized system. Certain embodiments provide the centralized transportation communication vehicle comprising Standard Transportation Engineering Social Network “STESN.”

At least one aspect of the engineering social network is about public declaration, a social media consisting of a network that comprises of dynamic database driven platform that enables interactive web content creation, collaboration, and exchange. The network is a social platform for publicly declaring the will of positivism, comprising the gathering of human knowledge that are reliably organized for shared studies, dealings with the body of facts and truths governing a support system that acquires knowledge for human observations to explain the phenomena of social media in the environment of natural fashion media, model media, and dress code media “FMDC.” The FMDC network further comprises of a social platform for providing substance of things hoped for, revealing the evidence of things not commonly seen. This evidence of things not commonly seen is CHANGE, which can be embraced with the hope for sustainable cultural independence, for by CHANGE the society receives good reports that things which are seen were not spiritually made of things which do appear, but are made through creative minds and innovative discoveries that may lead to economic growth, not as a means of inquiry, but rather as a dimension of social sustainability to gracefully improve corporate and community well being through social, cultural, environmental, and economic vision by the goodness of change.

The centralized transportation vehicle is a STESN comprising International search engine tool to facilitate locating the desired transportation topics of information in a network such as the STESN WEB-SITE. An end user usually would have to access the STESN web site that will host the centralized transportation vehicle or STESN International search engine for routing transportation topics of information. STESN would allow the end user to submit one or more search queries relating to the desired information type. Generally, STESN International search engine is a computer program that when queried for transportation topics of information, communicates with a database to retrieve either related information or pointers to the location of related information, or both, by evaluating the STESN server database.

STESN further provide a Standard Transportation Excellent Maintenance Solution “STEMS” for all transportation vehicles with links to transportation agencies, Police department, Homeland security department and the like. However, no such method ever existed that is centralized and opened for every transportation corporation and that will enable department of transportation “DOT” to provide file history of a particular vehicle instantly without having to go to the actual site or business operation of the company operating such vehicle to search for the hard copy files of that particular vehicle in question. Moreover, no such method ever existed that will enable drivers name search and critical solutions to a malfunctioned vehicle component without the insertion of a diagnostic tool. Disclosed embodiments further provide apparatus for enabling solutions for a failed component. The failed or malfunction component is queried precisely described in a system such as the Internet and a solution is enabled through STESN. Additionally, no such method ever existed that will schedule a preventive maintenance inspection for any particular vehicle when such vehicle has attained a certain mileage indicative of a respective mileage or fuel consumption requirement to enable a scheduled maintenance inspection. However, most if not all inventions arise from a combination of old elements in the art to address a particular need or unsolved problem. Disclosed embodiments provide centralized transportation vehicle operable to distribute science, engineering, and transportation topics of information through computing devices in association to provide science, engineering, and transportation services or functions. Embodiments provide a user interface and associated computer readable medium for a user interface within a media management application environment. Disclosed embodiments is more particularly directed to science, engineering, and transportation topics of information through distributed server-based application model operable to connect individual application client devices for exchanging and sharing science, engineering, and transportation topics data with one or more members of a varying set of server applications over a conventional communications infrastructure such as the web.

### BACKGROUND OF THE INVENTION

Disclosed embodiments provide advanced Internet platform configured for providing computer users with enhanced user interface environment comprising at least a form of media communication through remote computers. The media communication can be in the form of science topics of information, fashion media topics, model media topics, dress code media topics, fashion social media topics, centralized communications, engineering topics, transportation topics, audio music, music videos, television programs, sporting events or any other form of positive audio media and/or, positive video media that a user wishes to share, watch, or listen to.

Science and engineering education is a global endeavor and globalizing engineering education and standards would challenge the longstanding scientific preambles of the United States. Advances to globalize science and engineering are needed and would bring economic leadership to the nation. Establishing a centralized science/engineering social network for educational institutions and engineering professionals would present a social forum for knowledge of works to be shared and would expedite the rate at which students develop to phasing/solving real world problems. Knowledge on real world problems such as global warming and environmental emergencies would be easily shared by students and engineering professionals through a centralized science and engineering social network. Through the centralized network, engineering professionals would be able to identify the best, brightest, and most innovative science and engineering talents. These talents are needed for industrial advancements, but are not easily identified without the implementation of science and engineering social Network.

In reality, the network provides a socially sustainable community that have the capacity to deal with change and to adapt to changing situations and attributes that may be essential for globalization through fashion, model, and dress code “FMDC.” FMDC network is a network of change, providing a communication environment that has the capability of moving data between storage areas sufficiently scheduled for media communications for reasons of performance and convenience, establishing private communication environment for individuals and groups such as colleges, universities, churches, stores, organizations, cultural entities, businesses, corporations to explain the phenomena of social media in model media, fashion media, and dress code media, communicating to one another through a centralized system.

Disclosed embodiments provide a Standard Transportation Engineering Social network “STESN.” Through STESN, our nation would be ensured of standard education, economic development, and social/environmental security of the American homeland. The network would recapitalize America's strengths in homeland security. Investment in a centralized science and engineering social network would bring economic, security, science, and educational benefits to the nation. Major American businesses and industries would acquire the skills needed in today's global marketplace for scientist and engineers. STESN would serve as a learning environment and also as means of exposure to widely diverse engineering students. These students would develop added engineering cultures, ideas, and science/engineering viewpoints through STESN. Additionally, experienced technicians are hard to find because those with such knowledge are retired. As a result, STESN would present continuous distribution of that knowledge around the world. Moreover, keeping track of foreign motor carriers crossing U.S borders has always been difficult and STESN services are what motor carriers would need in order to safely operate on U.S soil. Certain embodiments provide a communication apparatus comprising a communication point between DOT and these motor carriers, engineering students and engineering professionals, science students and scientist. Knowledge in science and engineering is crucial if United State industries and the nation itself are to maintain their competitive edge in science, engineering, and industrial developments. In the midst of two struggles such as international struggle against terrorism which is a global threat, and sustaining our national scientific and technological capacities, development in standard transportation and engineering social network is crucial for information, communications, and for sharing other innovative approach to these struggles.

Disclosed embodiments provide a centralized transportation search engine comprising Standard Transportation Engineering Social Network “STESN.” STESN relates to providing a search engine for searching transportation topics of information, providing transportation topics advertisements, providing a knowledge base social network for university engineering students and engineering professionals, providing preventive maintenance scheduling, responsive to files storage medium for transportation companies, and providing solutions to failed transportation components. In the disclosure, embodiments provide a neural network operatively configured with at least a programmable architecture being configured with at least one dedicated processing elements. The communication apparatus further comprising at least a software program configured with at least a memory device comprising values being accessible to said dedicated processing elements.

Certain embodiments provide a centralized transportation and engineering market place for engineering and transportation services. The services are important transportation and engineering topics of information that could not be found elsewhere. These services include bodies of transportation knowledge that are stored in computer codes, and would be readily described when such information is queried. Additionally, experienced technicians are hard to find because those with such knowledge are retired. As a result, STESN will serve as the continuous distributor of that knowledge around the world while also helping DOT keep track of foreign motor carriers crossing U.S borders and the type of services that those motor carriers need in order to safely operate on U.S soil. STESN is an online transportation search engine for searching transportation topics of information, a social network for engineering students and engineering professionals, and system for national security. STESN allows transportation companies to control their cost while generating higher traffic to their website. STESN also serves as the centralized communication point between foreign motor carriers and DOT. Automotive part stores advertisements are connected to consumers through STESN to the web-sites of their choice of stores. Parts stores are connected to STESN for advertisements and include a click to go system for selected parts for purchase. Advertisers on TESN would be able to take advantage of their trademarks or bid on a word.

The objectives of disclosed embodiments is to advance science and engineering knowledge and knowledge of works through standard transportation engineering social network that would deliver forefront computational and network capabilities for scientist and engineers to extend their frontiers of science. Developing new talent in science and engineering requires finding new ways to teach. The STESN objective is to present a comprehensive effort to embrace at all levels the enduring change in science and engineering. Creating real change would require a compelling science and engineering network for diversity, and integrating the network into an organization's mission, strategy, operating structure, and culture is paramount. STESN is the vehicle that would drive the organizational mission because complex problems can best be solved by cross functional teams and that people who work, live, and learn in integrated science and engineering settings develop stronger interpersonal communications and applied science skills. STESN would embody programs to educate students of different disciplines and reach new innovative aspects of science, engineering, and technologies.

STESN further objective is to enable a chart function where the leaders of educational institutions, businesses and industries would present the visibility of crisis and refresh the public and students on the social compacts, and direct partnerships toward solutions for the crisis. These leaders would be able to engage national crisis and post a national strategy, addressing the crisis and the level of competitiveness needed to address the science and engineering aspect of the crisis. STESN further objective is to enable a collaborative network forum, which is required to make sustainable change across the spectrum of education, science, engineering, technology, innovation, and crisis. The network would further enable United States to regain its technological edge. The contents of the network site would be defined and students would fulfill their current difficult tasks by connecting with science and engineering professionals.

Disclosed embodiments further provide a centralized transportation vehicle comprising a search engine system that includes an entity extractor, a categorizer, and a query generator for managing and sharing science, engineering, and transportation activities such that when a topic on science, engineering, and transportation information is queried, responses are retrieved to enrich knowledge, transportation preventive maintenance scheduling, generating solution to queried transportation component failure, extracting names of terrorist desiring a rental car, and analyzing failed transportation component through a centralized database. The search engine system further comprises a communication apparatus comprising at least a hardware device. Some embodiments provide the hardware device comprising at least one dedicated processing elements being configured with at least an input array, at least an output array, and/or at least a query array. Certain embodiments provide an entity extractor configured to identify a set of entities as described in the engineering. Science and transportation topic of information through selected files, forms, or document content for enabling searching the information related thereto using an information retrieval system. Disclosed embodiments further provide the categorizer operable to define an organized classification of the science, engineering, and transportation files, forms, or document content with each class in the organization of component content having associated therewith a classification label. In the disclosure, the classification label corresponds to a category of topics of science, engineering, and transportation information in the information retrieval system. The categorizer is configured to assign the selected science, engineering, and transportation files, forms, or document content a classification label from the organized classification of science, engineering, and transportation component content. Certain embodiments provide a query generator operatively configured to automatically formulate a query that restricts a search for science, engineering, and transportation topics of information. The search could be restricted at the information retrieval system for the particular information concerning the set of entities to the category of science, engineering, and transportation topics of information in the information retrieval system identified by the assigned classification label to enable speedy responses to information from the centralized transportation vehicle. The centralized transportation vehicle is in communication with a computer apparatus comprising at least a database comprising at least information for science, engineering, and transportation topics.

Disclosed embodiments further provide the centralized transportation vehicle comprising interactive interface device being communicatively connected to at least the computer apparatus. The interactive device further comprising at least a data bus comprising a platform for writing input into at least a data memory for at least an array to enable enhancement of continued proliferation of powerful and suitable science, engineering, and transportation operation. Certain embodiments provide the interactive device configured for allowing computational devices to talk to each other through the use of networks connections. Computational devices include computers and other portable devices such as wireless telephones, mega telecommunication, personal digital assistants, and automobile-based computers, electronic devices, and portable devices. Such portable computational devices are pervasive devices. The networks connecting computational devices for the instant invention include wireless and wired networks which are formed using land lines such as copper wire or fiber optic cable, and wireless networks which employ earth and/or satellite-based wireless transmission links and a combination of wired and wireless network portions. These networks are organized using a client/server architecture in which server computational devices manage science, engineering, and transportation operational resources such as preventive maintenance files, solutions to failed transportation component, fuel consumption per vehicle in a fleet, computational transportation devices processing power which could be requested by client computational devices such as users of the network. That is, other computational devices not operated directly by an end user such as at least proxy servers, which act on behalf of other machines, could represent either clients or servers.

The communication apparatus is further configured for optimizing and for sharing science, engineering, and transportation topics of information. Certain embodiments provide the communication apparatus further comprising at least a cache engine operatively configured with at least one array. The cache engine further comprises at least a markup language configured with at least one array for entering searchable science, engineering, and transportation topics of information. Some embodiments provide the computer apparatus further comprising a spider, a crawler, each configured for disseminating science, engineering, and transportation topics of information. Disclosed embodiments further provide a web configured for disseminating science, transportation and/or engineering topics of information. Certain embodiments provide the centralized transportation search vehicle further comprising a structured science, transportation and engineering network environment communicatively connected to at least a one support system configured with at least an index and/or a catalog comprising science, transportation and/or engineering data. Some embodiments provide the data further includes at least one of; parts purchasing, science and engineering assignments, science and engineering research environment, standard maintenance solution, preventive maintenance scheduling, preventive maintenance forms, fuel consumption log, mileage log, solutions to failed components, equipment sales, parts graphics, marketing, name search, sounds, text, video, engineering and/or science topics of information, engineering materials and/or tools, and at least an advertisement.

The centralized transportation vehicle is provided with a system that generates a query for end users using an entity extractor, a categorizer, a query generator with a short run aspect vector. The entity extractor is configured to identify set of entities in selected file content for searching information related to science, engineering, and transportation operation and maintenance scheduling through the information retrieval system. The categorizer is further configured to establish an organized classification of individual company file content per equipment with each class in the organization of the content having associated classification labels that correspond to a category of information in the information retrieval system. The file content further contains equipment components per make and models relevant for retrieval of solutions to specific queries. The categorizer assigns the selected file content a classification label from the organized classification of content in relation to responding to the queried information in real time. The query generator gathers each query that restricts a search at the information retrieval system to the category of information in the information retrieval system identified by the assigned classification of the individual companies. The category of information allows the query generator comprising a short length aspect vector generator to generate terms for refining the query using context information surrounding the set of entities in the selected file content so that files and transportation files, forms, or documents are made searchable through the centralized transportation vehicle. These files could be integrated seamlessly with all existing transportation industries, commercial transportation companies, all fleet STESN, and all garages in the nation and around the world through their local existing system and enable these system to talk to each other and communicate better in real time interaction, real responsive, real resourceful, and real responsible to science, engineering, and transportation system analysis, preventive maintenance scheduling and reprogramming, and enable the centralized database interaction with these existing companies through their local computers.

Embodiments provide INTERNET comprising a very widely used network for centralizing science, engineering, and transportation vehicle to connect end users to the science, engineering, and transportation clients to topics of information. The INTERNET provides a global network of computational devices which communicate using a set of protocols called TCP/IP “transmission control protocol/Internet protocol”. A particularly popular aspect of the Internet is the World Wide Web (WWW, or “web”), which is a collection of interlinked science, engineering, and transportation files, forms, or documents formatted in hypertext markup language (HTML) to be used for separating science, engineering, and transportation topics of information from other web-based information. These science, engineering, and transportation files, forms, or document s, or “web pages”, may incorporate text, graphics, audio, and/or video content, and may include suitable links to one another, often called “hyperlinks” or simply “links”. Science, engineering, and transportation files, forms, or document s or files are requested by client computers through an application program called a web browser configured with at least a software comprising at least one support system being responsive to structured directory of transportation and/or engineering topics for providing communications to at least one science, engineering and transportation network infrastructure. Disclosed embodiments further provide the support system responsive to global communications via Internet occurrences of science, engineering, and transportation topics of information.

Certain embodiments provide STESN comprising an online transportation search engine for searching science, engineering, and transportation topics of information, a social network for engineering students, scientists, engineering professionals, and a system for national security. Engineering professionals would be able to assist students on technical matters on their projects through similar functions. STESN comprised of science and engineering social network and web-service application consisting of virtual science, engineering, and transportation business analytical tool. The tool includes portfolio for science, engineering, and transportation company's preventive maintenance programs and an online market place for transportation parts and research distributions. Engineering professionals will utilize this network to assign research projects, assist on projects, and post jobs. Skillful use of STESN will bring in businesses equal to a million times the cost. Commercial motor carriers need the service of STESN. STESN website would be the virtual science, engineering, and transportation business, comprising analytical tool and portfolio for transportation company's preventive maintenance programs, as well as online market place for transportation parts and research distribution. The web plan would include search engine comprising of computers, devices, communication apparatus, and browsers. The system would be configured with a support system for engineering social network, making it easier for people to meet for personal science and engineering benefit.

Disclosed embodiments provide the support systems communicatively connected to computer devices. The computer devices are operatively configured with communication apparatus, which include Internet and gateway. The communication apparatus is communicatively connected to an interface comprising I/O network. Software, comprising an operating system is configured with the communication apparatus. The computer devices further comprises database comprising science, engineering, and transportation topics of information. The browser is communicatively connected to the operating system, which is communicatively connected to the network I/O which connects to the gateway. Certain embodiments provide a cache engine communicatively connected to the communication apparatus. Some embodiments provide the cache engine comprising a query and a makeup language for searching science and engineering topics of information. The query further comprises apparatus for entering science, engineering, and transportation topics of information. A spider and a crawler are further provided for disseminating transportation topics of information. The support system is configured for social network and further comprises structured functions, including chat functions. The computer device further comprises a server tool configured with the software for enabling a server tool to communicate with other electronic devices through the Internet. Certain embodiments provide application tool for permitting a user to access the database. Some embodiments provide a model layer for enabling network communications, and a presentation layer for coding data.

The files are requested from server computers, or “web servers”. The transmission of the files over the web uses an additional Internet protocol called hypertext transfer protocol (HTTP). A significant feature of the Internet is that it is substantially free of central organization. A server hosting web page for the centralized transportation system is connected to the Internet and the transportation topics of information are routed by the centralized transportation vehicle or STESN International search engine to the server for retrieval of information specific to the queried topics of information from the server database. The centralized transportation system would also enable decentralization of science, engineering, and transportation topics of information and also allows extremely wide access and an ever-increasing variety and availability of information relating to various transportation vehicles, identifying and locating specific pieces of information on a specific topic such as vehicle component failure on a particular brand of vehicle that can be extremely difficult to diagnose. Generally, a database system is developed and a STESN International search engines and directories would route all the science, engineering, and transportation topics of information to the server containing the database developed to aid users in finding specific types of information unique to science, engineering, and transportation vehicles. The database system would typically contain an entry for each web page and other science, engineering, and transportation files, forms, or document to enable the database to be searchable relatively quickly without any intervention or the need to retrieve actual web pages in order to perform a search.

The communication apparatus is further configured with an entry for retrieval of information from the database. The entry further includes a network address of the end user page consisting of one or more keywords associated with the page content. The network address may further include a brief summary of the topic of information to be searched. The STESN search engine is used to describe any such database system to distinguish itself from directory. STESN routes all transportation topics of information from the internet to the database server, collecting science, engineering, and transportation topics of information automatically using programs such as spiders, robots and/or crawlers. The robots, spiders, and/or crawlers are configured to visit the centralized transportation web page and collect the needed data by downloading files in relation to the queried topics of information and also process the file. Prior art devices such as AltaVista, Google, Yahoo, and Excite are not toned for routing science, engineering, and transportation topics of information. Prior art devices also have no way of directing or enabling scheduling of preventive maintenance based on vehicle mileage or fuel consumption. In addition, a directory may be used with the STESN International search engine to describe the end user or a database for which entry information is submitted.

The centralized transportation vehicle is a process-driven science, engineering, and transportation management system for managing data relating to science codes, engineering code, and transportation codes and modules. The science, engineering, and transportation management system includes a server repository platform that stores science information, engineering information, and vehicle information, wherein one of the information is referred to as planes having components each describing a respective science codes, engineering codes, and mechanical failure codes.

Disclosed embodiments provide STESN in communication with computers in the science, engineering, and transportation industries, including putting transportation technologies together by directing end users to transportation topics of information through the centralized transportation vehicle. In the disclosure, embodiments would provide easier means for employees of these industries to share files and data resources through a centralized science, engineering, and transportation network system. The shared network will enable communication with every transportation industries, every garage, and all commercial transportation companies, engineering companies, and science companies seamlessly through a resourceful time sharing via shared Internet access. The centralized transportation vehicle includes science and engineering searches through a centralized transportation system. The centralized transportation system further includes server-based network to enable reliability of solutions to local and distance transportation industries. The server network is operable to connect industrial employees through a local social network environment to include topics of information resourceful to their business maintenance program and preventive maintenance, providing step by step repair procedures for a failed vehicle component. The server network is further operable for accessing more than one hundred million end users per second to its database. The database is accessed through desktop computers, notebooks, wireless devices, and megatel devices from any state in the U.S. and any part of the world.

The Web context is configured based on queries, such that, when a user submits a query containing science, engineering, and transportation topics of information, STESN search engine would respond with a list of links pointing to information resource for the STESN web page hosting derived from matching entries on science, engineering, and transportation topics of information in the search engine's database. Disclosed embodiments provide the term “link” comprising any representation or symbol representing at least an address that points to the location of an information resource, such as a web page. Typically, a link on a Web is a pointer found in one file which references another file. The link on the Web commonly refers to a Uniform Resource Locator (URL), the global address for science engineering, and transportation files, forms, or documents and other resources commonly accessible on the Web. The centralized science, engineering, and transportation network system uses direct attached storage to the server hard drive configured with a network attached storage to consolidate files stored. The server software periodically dumps files into a backup server for future corporate use.

Disclosed embodiments further provide a centralized science, engineering, and transportation network system configured with server adaptors to maximize productivity and end user longevity. Certain embodiments provide the server adaptor configured to allow end users to end users communication through STESN search engine. Thus, the entire network system will periodically need maintenance and the URL may be modified at random times by their web masters. When a webmaster changes the content of a web page, including adding or removing content or deleting the page altogether, STESN search engine database would not immediately reflect these changes. A typical search will produce a single link that either point to STESN web site or its modified web site. Accordingly, when a user clicks on the URL and an error results comes on, if the user is unable to access the envisioned content, STESN search engine would strive to keep track of the Web by continuously finding, indexing, and cataloging web pages. Some embodiments provide a server adaptor software configured to automatically re-route traffic signals when any of the server port experiences a failure or is disconnected. Files are always monitored and allow access to multiple server files containing client data to enable prevention of any loss of information when the hardware experiences a failure.

Disclosed embodiments further provide a multiple file storage system being centralized for maximum protection. Certain embodiments provide the centralized science, engineering, and transportation network system being configured with a switch to connect client system and servers together to create a client server network within the system and a social environment for communications. Some embodiments further provide the backup storage software being operable for providing backup file scheduling such as tape backup and server file storage backup in weekly, daily, or monthly intervals. The backup storage allows the centralized science, engineering, and transportation system access to remotely recover any lost file. Other embodiments provide a process comprising a network system operable to eliminate single point failure by advancing an application/technology to keep single components on hand for emergency use. In the disclosed embodiments, indexing is provided for storing of links pointing to information resources including some or all of the data associated with the information resource.

The science, engineering, and transportation management system is provided and includes sets of tools for performing innovative renovation of science, engineering, and transportation component and analytical breakdown of possible solutions for topics information. Disclosed embodiments further provide science, engineering, and transformation social network system comprising a process-based interface to science, engineering, and transportation topics of information with end users and a social platform for advancing science and engineering knowledge. Certain embodiments provide the interface configured with a support system being operable for mapping desired communications using Protocols, Processes, and Plans. Protocols are the constructs that each stores a script for invoking a respective scripted tool to execute a particular function. Some embodiments provide Protocols comprising a software module being operable as input parameters for retrieving relevant science, engineering, and transportation information or for generating an output parameter of the function invocation specified as variables being supplied at execution time. In other disclosure, embodiments provide STESN search engines in communication with computer applications called spiders or robots for indexing the different elements of web sites on the Internet and for gathering content information for STESN search engine database. Essentially, STESN search engine robot is configured to index significant number of information resources in the Internet. The robot is further configured for updating links in STESN search engine database in a queried dependency manner so that science, engineering, and transportation topics of information are better shared to:

1. Improve knowledge and productivity

2. Improve homeland security and data mining

3. Improve environmental safety

4. Cut maintenance cost

5. Gain maintenance and repair flexibility

6. Share resources to gain optimal output in minimal time

7. Increase collaboration through file sharing

8. Improve corporate data security

9. Detect intrusion through multiple firewall configuration

10. Enable corporate privacy control and prevents confidential information

11. Enable anti spam filtration of unwanted queries

12. Utilize bus to offer point to point lanes to the database

13. Deliver peak performance to meet demands for industrial multitasking

14. Enables continuous background virus check and scanning at firewall

15. Enable multimedia application with intensified multitasking between industries

16. Connecting more employees with maximum performance through a social environment

17. CENTRALIZED ENGINEERING SOCIAL NETWORK

The cycle time for STESN search engine robots is the time between sampling the same web site and incorporating any changes into STESN search engine database. The sampling requires a significant period of time—as long as several months. Moreover, if a particular site is not accessible when a robot comes around to examine it, the robot will not index the web pages on that web site until some future time. In the worst case scenario, the URL pointing to the web site (including any URLs to any of its web pages) could be excluded from the STESN search engine database entirely. As more web sites come online, the amount of time for STESN search engine robot operation to cover the entire Internet would continue to increase, requiring additional computing resources.

Embodiments provide a time-delay between indexing and re-indexing any one content resource, e.g., a web page. Certain embodiments provide the indexing and re-indexing comprises information stored in the STESN search engine database that is stale, e.g., outdated or not “fresh” URLs. In the disclosed embodiments, over a given time period an equal amount of computing resources are dedicated to refreshing each link stored in the STESN search engine database. However, given the large number of dynamically changing Internet resources to monitor, and only limited resources (bandwidth and storage) available to do the monitoring, there is a need in the relevant technology for a system and a method of deciding which resources should be updated first and when.

An illustration of a client-server network containing STESN search engine server is shown through out the drawings. In the disclosure, the network connects various computational devices, such as STESN search engine server, clients, including science, engineering, and information content servers. Although these computational devices are shown outside of the oval representing the network system, for clarity, these devices are actually a part of the network as well. In the embodiment, the network system is the World Wide Web, and may include millions of web involving science, engineering, and transportation content servers being located anywhere in the world. Each science, engineering, and transportation content server may store, or “host”, one or more web sites. Each web site includes one or more web pages, as described above. Disclosed embodiments further provide science, engineering, and transmission media communicatively connected to STESN search engine server, clients, and transportation content servers hosting the web sites to a network system. Certain embodiments provide the network system further comprising other transmission media and computational devices being wired or wirelessly interconnected to a centralized science, engineering, and transportation communication environment in a network.

In a typical searching sequence, communication is established over the network between at least a client and STESN search engine server. Some embodiments provide the communication environment further comprising a web browser program on the client machine. Other embodiments provide a search criteria being entered by a user of the client machine, and being transmitted to the STESN search engine server. STESN search engine server being operable for searching the information available on the network, including science, engineering, and transportation topics of information. The topics of information are made searchable on the information content servers containing science, engineering, and transportation files, forms, or documents relevant to the search criteria. The search includes searching the database stored on STESN search engine server. The database further includes previously-formed entries corresponding to web pages accessible over the network environment. The results of the search are transmitted back to the requesting client. The client may, for example, access particular web pages that are included in the results directly over network environment as desired by the user.

The large and constantly expanding size of the Internet and World Wide Web presents difficult challenges for using search engines in the above-described process. For example, most engines are at this time, unable to index (create database entries for) the entirety of science, engineering, and transportation files, forms, or documents that are available on the Internet, or even a substantial fraction of these science, engineering, and transportation files, forms, or documents. The storage space and computational time constraints which limit the ability of the engines to index science, engineering, and transportation files, forms, or documents may also limit the complexity of the database entries for science, engineering, and transportation files, forms, or documents which are indexed, such that only a rough categorization and/or analysis of search results may be performed. This may create various problems for a user without STESN search engines. The problems most prior art engines are facing include excessive numbers of “hits”, or science, engineering, and transportation files, forms, or documents matching the search queries being returned by these engines.

With prior art devices, the science, engineering, and transportation files, forms, or documents are returned in response to a search query which may incorrectly be matched to the subject of the query, and incorrectly or insufficiently be categorized, and if categorized at all, it may not be in a way apparent to the end user. In some cases of STESN, for example, priority of search results returned may be influenced by factors such as advertisements on web sites. Resource limitations on the STESN search engine server often prevent the use of algorithms which might improve the accuracy and categorization of search results. The algorithms for categorization and searching through STESN are often very good, particularly utilizing techniques from the field of artificial intelligence. The fundamental problem advantage is believed to be the resource restrictions on STESN search engines. Hence STESN search engines often use quick algorithms for categorization and searching. Typically this involves examining only a few keywords or hyperlinks in a Web page and rapidly returning the results. Incremental classification is often done in a semi-automated or manual fashion. It would therefore be desirable to develop a system and method to improve the accuracy of network search results without increasing resource requirements for STESN search engine server. The desired method would allow improvement of results of both a current search and future searches involving science, engineering, and transportation topics of information.

Disclosed embodiments provide processes comprising constructs that store science, engineering, and transportation definitions comprising descriptions of particular tasks to be performed. The task to be performed is described using one or more protocols and/or one or more other processes. By this definition, a process is a grouping of protocols and other processes, wherein the functions described by the protocols and processes perform desired tasks. Certain embodiments provide processes further comprising logical statements written in any scripting language operable to further perform error and recovery operations for the centralized transportation vehicle. Some embodiments provide like protocols and processes comprising written generic format that identifies a type of software module that can be the target of the task of the relationship between the centralized transportation vehicle and the end users, but does not identify a specific software module or modules on which the task is to be performed from local computers. Other embodiments provide the end users comprising servers.

In the disclosure, processes can be used to develop Plans for industrial standard science, engineering, and transportation excellence, including maintenance solution to direct and supply information unique to transportation motor carriers. Disclosed embodiments further provide STESN comprising science, engineering, and transportation telecommunication environment configured for web based facility. Certain embodiments provide STESN comprising a Plan with developed script that may be executed by a script engine for the centralized transportation vehicle to complete the task described by a connected process. The web based facility is configured to enable on-line services to science environment, engineering environment, and transportation vehicles by handling transportation preventive maintenance programs on the web based facility. The web-based facility further provides prescribed solutions to failed transportation vehicle components in accordance with DOT and equipment manufacturer's format. Plans may also be created by users having a minimal amount of system knowledge by utilizing the contained software for the web based facility to generate transportation preventive maintenance inspection programs and forms, and to provide solutions to transportation component failure without any physical connection to the transportation vehicle. This is accomplished by an automated Plan development tool that polls the user to select a Process to be developed into the Plan.

Disclosed embodiments further provide the polling being achieved by using natural language expressions stored within the Processes themselves and comprises interface switching module being connected to the server database or warehouse. Certain embodiments further provide the Processes being operable for designating range of assigned characters in text and binary comparison with coded characters in the database in response to queried input. Some embodiments further provide the input comprising initial communication for enabling science, engineering, and transportation network environment and online communications, providing solutions to queried information. In addition, the user may be polled to the software modules that are operated on and/or created by a selected Process. This is accomplished using the Process information indicating the allowable types of software modules that may be associated with the Process to enable a web based server and a computer to be coupled and further enable interface switching for connecting an input signal from an end user to a network computing terminal based on at least a condition. In this manner, a user can initiate the execution of complex operations without understanding the complexities of, or the interrelationships between, tools and tool interfaces. Furthermore, the condition being in accordance with user security number, wherein the security number is stored such that the centralized transportation network terminals, in accordance with other selected conditions, would enable entry capable of accessing contents within the database on selected user security corresponding to the conditions, and wherein the user may need no understand of the interdependencies existing between the software modules that are to be the target of the initiated operation. Plans further include a designation of the software modules that are to be used as input and output parameters of the various task. A Plan may be provided to a script engine for the centralized transportation vehicle for execution either immediately after the plan is created from a process, or on a scheduled basis through a controlled means. The control means further comprises relocating range of science, engineering, and transportation assignment while maintaining a defined task in exchange for at least a solution to the assignment.

In the preferred embodiment, the Protocols, Processes, and Plans are each stored as vehicle/engine in the science, engineering, and transportation management system repository for updating connectivity to the database, for updating the range of the assignments when a connection is disabled or enabled, and for processing signal connectivity to updating execution of prescribed functions corresponding to updating functions in response to the operational set mode signals for generating matching solutions to defined science topics, engineering topics, and transportation failed components. This vehicle, which comprises science, engineering, and Centralized transportation System Components, are stored in a manner that is similar to the way in which the Asset components describing the software modules are stored. Furthermore, the associations between Protocols, Processes, and Plans are stored as relationships between the respective centralized transportation vehicles in a manner that is similar to the way relationships between the software modules are represented science, engineering and transportation topics.

Disclosed embodiments provide the Protocols, Processes, and Plans comprising centralized transportation vehicle operable within science, engineering, and transportation management system. In the exemplary embodiments of the transportation disclosure, first, a step by step directory to finding defective components is enabled and providing solutions for repairing the defective component is further enabled through a web based online analytical rundown of the transportation failure. At least the system is configured for providing industrial quo solutions to enabling vehicular preventive maintenance. Next, the system is further configured for ensuring industrial transportation safety by means of online distribution of transportation data and providing solutions to mechanical and electromechanical component failure. The system is further configured for supplying thorough transportation analysis through a system of network distribution of solutions to transportation industries. The distribution further comprises distributing at least a routine transportation safety procedure online. The transporting safety procedure includes equipment such as transport planes, transport vehicles, and marine equipment, executing standard preventive maintenance inspection and enabling at least solutions to failed components. STESN provides centralized system for university science and engineering students and professional engineers to socialize through a support system comprising central network further comprising a neural network operatively configured with a programmable architecture configured with one dedicated processing elements.

Disclosed embodiments further provide centralized transportation vehicle comprising a search engine for science, engineering, and transportation topics of information. Certain embodiments provide tools operable within a network system to create, update, and manage the search engine. Some embodiments provide the network system comprising asset components used to perform similar functions on the science and engineering network environment and transportation system network environment, providing components failure analysis. The tools are configured responsive to science and engineering topics/problems and for assembling solutions and enabling preventive maintenance program from at least the fuel consumption data collected from each vehicle. The relationships existing between the various Network System Components “NSC” allow an end user or an automated development tool to readily discover the interdependencies existing between the constructs, expediting communications to the database warehouse for describing plurality languages to files containing compiled component failures and solutions to fixed transportation maintenance program, invoking master database and variable PDL file descriptions in conjunction with queried text for online maintenance procedures. Online maintenance procedure imposes activation of the master database and variable PDL file context, enabling online transportation solutions to be distributed through web based routing of transportation topics of information. Other embodiments provide impact analysis of science, engineering, and transportation topics of information, including failure analysis after a modification is made to a structure engineering component or one of the Transportation System components. Additionally, the repository interface includes automated functions that can be invoked by both the automated Plan development tool and the script engine for the centralized transportation vehicle to simplify Plan development and the execution science, engineering, and transportation topics of information.

Disclosed embodiment provide centralized transportation vehicle comprising the Internet and/or the World Wide Web configured for vast repository of information that is extremely distributed internationally and locally by means of identifying science, engineering, and transportation topics of information. The topics of information further include the location and manner in which the information was produced. The science, engineering, and transportation topics of information are extracted from the Web by the end users through communications with the centralized transportation vehicle. The centralized transportation vehicle enables individual users to traverse or surf the Web to locate the solutions for science, engineering, and transportation topics of information of interest. The centralized transportation vehicle is further configured to manually extract science, engineering and transportation information unique to the topic being queried. The centralized transportation vehicle is configured for routing science, engineering, and transportation topics of information and provides an innovative technique for extracting these topics of information from a centralized database by extracting relevant information automatically with minimal human intervention.

In another preferred embodiment, the definition of the Centralized Transportation Vehicle further comprises a centrally driven engine for routing science, engineering, and transportation topics of information to end users, providing a centralized network system for science and engineering schools-universities-professional environment, and transportation industries. Each of the engines for the Centralized Transportation Vehicle comprises a System Components, as well as the relationships that may exist between the components, being created using a pre-defined element type of the topics information or relationship type definition that is also stored within the repository. In one disclosure, embodiments provide a computer implemented method of extracting and sharing science, engineering, and transportation topics of information from a database. The database is made searchable for occurrences of at least one topic of information. An occurrence of a topic of information that was found is analyzed to identify a pattern in which the topic of information was stored. Additional topics of information are extracted from the database utilizing the pattern. In some embodiments, the process is repeated until a predetermined number of topics are found or until no new patterns are identified.

The model definition simplifies the system design and makes operation more robust because the various tools in the system is configured to be synchronized with the element and relationship type definitions instead of having to be aware of special-case and particularized element descriptions. Additionally, modifications to the components can be more readily accomplished because a whole class of element definitions can be modified by making a single change to an element type definition. The type definitions further allows the automated Plan development tool to efficiently query the user for process and other Asset element selections.

Embodiments involve the recordation of Plan execution status. Plan Execution Record constructs are created after the execution of any Plan. These constructs are stored as Science, Engineering, and Transportation System components for recording information and status about Plan execution that are useful in science, engineering, and transportation files, forms, or documents. Plan Execution Record Constructs comprise software development process for standard science, engineering, and transportation excellent maintenance solution.

The centralized transportation vehicle would become readily apparent to those skilled in the art from the following detailed description of the preferred embodiments and the drawings are shown simply by way of exemplary illustration of the best mode contemplated for carrying out the invention. As will be realized, the invention is capable of other and different embodiments, and its several details are capable of modifications in various respects, all without departing from the scope of the invention.

### SUMMARY OF THE INVENTION

Embodiments provide at least a user interface associated with a computer readable medium within a media management application environment. Embodiments provide the user interface comprising a plurality of science topics for displaying at least one topics of information in a list of one or more media file sources. Certain embodiments provide at least a list of user selectable media file identifiers from a group consisting of science topics of information, wherein selected information is associated with a listed media file identifiers for identifying fashion topics, model topics, and dress code topics. At least one identifier further comprises instructional topics of information as to how a user can cause one of the science topics to display selected topic information associated with the listed media file identifiers. Some embodiments provide at least one of: a gaming platform; a media player platform; a control interface platform; a commence platform; an electronic commence platform; an advertisement platform; a fashion platform; a model platform; a dress code platform; an educational platform; and a learning platform. Other embodiments provide at least one aspect of the user interface comprising displaying an instant messaging through at least one platform as a media file source. In one disclosure, the media file source may comprise messaging platform for users. Embodiments further provide a messaging platform environment for user communicate with one another. Certain embodiments provide at least one selection platform comprising means for messaging user to cause at least one science topics to be displayed as information associated with media files found in a media platform

Fighting terrorism is a value that is more important to the world than how the world perceive privacy right. The most important problem facing the world today is not privacy right, but rather, the constant involvement of terrorist activities in non-combat environment. The centralized transportation vehicle is a communication vehicle comprising an engine for re-enforcing terrorist monitoring in a transportation crime enforcement network both locally, nationally, and around the world. Disclosed embodiments provide centralized transportation vehicle in communication with computing devices operable to provide specific science, engineering, and transportation services or functions. Certain embodiments are directed towards a distributed server-based application model comprising varying set of server application where individual application client devices connect to and exchange science, engineering, and transportation data with one or more members of the group over a conventional communications infrastructure such as the web.

Some embodiments provide a transportation vehicle comprises human knowledge comprising organized bodies of knowledge that are shared by people so as to produce useful feeds that comprise of reliable knowledge about at least an FMDC topics of information to aid and educate the society through the environment of social enterprise. Social enterprise consist of social measurements relating to the way society operates through a systematic examination of truth, existence, reality, causality, exhibiting the freedom of shared knowledge relating to at least one FMDC topics of information. Social measurements comprise of asserting the influence of FMDC for the betterment of the society by contributing to product offerings through a blend spirit of positivism and methodological evolution of information backed by the organizing principles underlying the science of Fashion, Models, and Dress Code.

The methodological evolution of FMDC information is geared towards societal change that comes with time, and time blends with technologies and innovations. That is why FMDC sharing is embodied to change the way knowledge is derived about an object, a business, a corporation, an institution, an educational institution, a testimony, a Pastor, an art, an event, a project, a play, a book, a culture, a Bishop, a struggle, a success, the society and its environment. Social measurements further leads to generational awareness, brand awareness, leadership awareness, business awareness, corporate awareness, educational awareness, professional awareness, ethical awareness, religious awareness, institutional awareness, social awareness, cultural awareness, sociological awareness, professional awareness, causal awareness, and service efficiency to the society relating to the positivism in fashion media, model media, and dress code media. Individuals, businesses, corporations, religious groups, cultural groups, and community organizations/associations must have the freedom to choose how to improve their product life in the context of fashion media, model media, and dress code media for their product line. Just as true prophecy never come by the will of man, but from God through the Holy Spirit to bring Lamb upon our feet and Light upon our paths, so must the positivism of good products/objects be lightened to bring out the truth by modeling the products/objects to create a clear path for knowledge and economic growth.

The present invention further relates to a centralized transportation vehicle for providing science and engineering knowledge. The centralized transportation vehicle further comprises a search engine for transportation industries, garages, transportation maintenance fleet, government agencies, police department, fire department, and homeland security agencies, allowing these agencies and companies to talk to each other seamlessly through a centralized system. The system is configured for extracting science, engineering, and transportation topics of information from a centralized transportation database having information relating to science and engineering and to different makes and models of transport vehicles. Embodiments further relates to management and sharing of science, engineering, and transportation topics of information through networks of computational devices, and more particularly for generating request of science, engineering, and transportation topics information and retrieving responses to the topics of information such that enhancement of, and identification of relevant science, engineering, and transportation topics of information is made accessible using such a network system.

The network system is configured to integrate seamlessly with all existing schools, universities, science and engineering professional establishments, transportation industries, including car rental companies and all garages in the nation and around the world through their local existing system. The network system is further configured for enabling these system to talk to each other and communicate better in real time interaction, real responsive, real resourceful and real responsible to science topics, engineering topics, and transportation system analysis, preventive maintenance scheduling and reprogramming, and monitoring of a terrorist activities in a centralized transportation database through at least a name search. Detected data referencing at least a terrorist desiring at least science, engineering, and transportation topic of information is made available to the government and/or homeland security agencies, enabling these agencies to thwart transportation and other activities involving the terrorist. The database is configured to provide data which are monitored by at least a cache. The cache further comprises a cache engine operable for finding science, engineering, and transportation patterns, and for finding other patterns in which terrorist carries other activities.

The centralized transportation vehicle further comprises Standard Transportation Engineering Social Network “STESN” comprising a search engine tool to facilitate locating the desired science, engineering, and transportation topics of information in the network. The network may comprise STESN WEB-SITE. Disclosed embodiments provide STESN-WEB-SITE comprising a centralized communication environment for end user to access STESN. STESN-WEB-SITE is further configured to host the centralized transportation vehicle or STESN search engine configured for routing science, engineering, and transportation topics of information and for submitting one or more search queries responsive to the information type. Generally, STESN search engine is a computer program in communication with a server database containing science, engineering, and transportation topics of information. When queried for science, engineering, and transportation topics of information, the system retrieves either related topics information or pointers to the location of related topics information, or both, by evaluating the server database.

The centralized transportation vehicle comprises STESN search engine system that includes an entity extractor, a categorizer, and a query generator for managing and sharing science, engineering, and transportation topics activities such that when a topic on science, engineering, and transportation information is queried, responses are retrieved to enrich topics of information. The topics of information further include transportation preventive maintenance scheduling, generating solutions to queried transportation component failure and analyzing failed transportation component through a centralized database. The entity extractor is configured to identify at least a set of entities as described in the science, engineering, and transportation topic of information through selected topic files, forms, or documents content. The files, forms, and documents contents are provided for enabling searching the information related thereto using an information retrieval system. Disclosed embodiments further provide a classification label corresponding to category of topics of science, engineering, and transportation topics of information in the information retrieval system. Certain embodiments provide a categorizer configured for assigning the selected science, transportation files, forms, or document content a classification label from the organized classification of science and engineering topics and transportation component content. A query generator is configured to automatically formulate a query that restricts a search for science, engineering, and transportation topics of information at the information retrieval system. The information retrieval system comprises particular information concerning the set of entities for the category of science, engineering, and transportation topics of information in the information retrieval system. The information is to be identified by the assigned classification label being provided to enable speedy responses to science, engineering, and transportation topics of information from the centralized transportation vehicle.

The entity extractor identifies the set of entities in selected file content for searching science, engineering, and transportation topics of information, including related transportation operation and maintenance scheduling through the information retrieval system. The files are requested from server computers, or web servers. Disclosed embodiments provide a server comprising a computer apparatus configured for hosting web page for the centralized transportation vehicle. The server is connected to the Internet and the science, engineering, and transportation topics of information are routed through the transportation vehicle or STESN search engine. The server is configured for retrieval of information specific to the queried topics of information from another server comprising a database system. Generally, a database system is developed and STESN search engine is in communication with the database system and end user. The search engine directories would route all the science, engineering, and transportation topics of information from the server containing the database system. The database system is developed to aid users in finding specific types of information unique to science, engineering, and transportation vehicles preventive maintenance and safeties.

STESN search engine is often used for communications with the database system, distinguishing itself from directory by routing all science, engineering, and transportation topics of information from the internet to the database server system. STESN is further configured for collecting science, engineering, and transportation topics of information automatically using programs such as spiders, robots and/or crawlers, which will visit the centralized transportation vehicle web page and collect the needed data by downloading files in relation to the queried topics of information and process the files. The centralized transportation vehicle is a process-driven science, engineering, and transportation management system for managing data relating to science, engineering, and transportation codes and modules. In one instance of the disclosure, STESN is configured to link computers in the science, engineering, and transportation industries, including science and engineering technologies together by directing end users to topics of information through the centralized transportation vehicle, making it easier for employees of these industries to share files and data resources through a centralized transportation network system.

The centralized transportation vehicle comprises of a centralized science, engineering, and transportation social network system that includes server-based network to enable reliable science and engineering network and solutions to local and distance transportation industries. The Web context for the network system is based on queries, such that, when a user submits a query containing science, engineering, and transportation topics of information, the network system in communication with the search engine would respond with a listing of links pointing to information resource. The search engine is further configured for matching entries on science, engineering, and transportation topics of information with the information on the database server. The centralized transportation network system uses direct attached storage to the server hard drive comprising a network attached storage to consolidate files stored. The centralized transportation network system is further configured with a server adaptor to maximize productivity and end user longevity. The network adaptor is configured for allowing end users to communicatively be connected to the search engine.

The centralized transportation network system is further configured with at least a switch being operable to connect client system and servers together to create a client server network within the system. Disclosed embodiments further provide a backup server for allowing the centralized transportation system access to remotely recover any lost file. Certain embodiments provide a transformation system comprising a process-based interface for science, engineering, and transportation topics of information in communication with end users. Some embodiments provide a search engine comprising computer applications consisting of spiders and robots being operable for indexing different elements of web sites on the Internet and for gathering content information for other databases relating to contents of science, engineering, and transportation topics of information. In the disclosure, embodiments provide STESN search engine configured with spiders and robots for indexing significant number of science, engineering, and transportation topics of information resources for Internet applications. Ordinarily, the spiders and the robots are further configured for updating the links to the science, engineering, and transportation database server in a queried dependency manner so that science, engineering, and transportation topics of information are made searchable with less delay time, and the search results are shareable. The search engine is further configured to provide corporate privacy control and protect confidential information.

The network system is configured to connect various computational devices with the search engine. The science, engineering, and transportation database server is communicatively connected to the search engine to store or host one or more web sites. Each web site includes one or more web pages. In a typical searching sequence, communication is established over network between a client and STESN search engine server. In the disclosure, embodiments provide a computer application in communication with a web browser program on the client computer. Search criteria are entered by a user of the client machine, and transmitted to the STESN I search engine server comprising the computer application. STESN search engine server is further configured for searching the information available on the network that relates to science, engineering, and transportation topics of information. The information includes files, forms, and/or documents relevant to the search criteria. The information stored in the database server in communication with the search engine server. The database includes previously-formed entries corresponding to science, engineering, and transportation contents which are accessible over the network.

Disclosed embodiments provide a computer apparatus comprising techniques for extracting science, engineering, and transportation topics of information through search patterns from a database such as the Web. Certain embodiments provide the techniques comprising one or more topics of information that act as the initial seed for the search. Some embodiments provide the database or databases comprising a searchable medium for occurrences of the topics of information. Other embodiments provide the technique comprising of patterns being identified in the array in which they are stored. These patterns are used to extract more topics from the database and the process can be repeated for new topics. Information can be extracted from a database efficiently and accurately with little or no human interaction. Disclosed embodiments further provide a computer implemented method of extracting information from a database. Certain embodiments provide the database being searched for occurrences of at least one topic of information. Some embodiments provide the occurrence of topics of information comprises the information that was found, is being analyzed to identify a pattern in which similar topic of information was stored. Other embodiments provide the topics of information being extracted from the database utilizing the pattern. In some embodiments, the process is repeated until a predetermined number of topics are found or until no new patterns are identified.

Disclosed embodiments provide a computer implemented method of extracting science, engineering, and transportation topics of information from a database. The database is searched for occurrences of topics of information. Occurrences of the topics of information that were found are analyzed to identify a pattern in which the topics of information were stored. Certain embodiments provide the pattern comprising prefix text, a middle text and suffix text, where the prefix text precedes desired information in the science, engineering, and transportation topics of information and the middle text is between desired information in the topics of information and the suffix text follows desired information in the topics of information. Additional topics of information are extracted from the database utilizing the pattern and the process is repeated for additional topics of information. At least one science topics of information includes social enterprise, comprising bringing the actualization of potentials in Fashions, Models, and Dress Codes “FMDC” through an objective reality of social bodies being shared in a shared environment by observers that are governed in the support system. The support system is communicable through electronic network environment by means of observation to sharing a common reality that is not commonly absolute by all observers. The shared environment further comprises the Internet comprising electronic communication environment for sharing productive/objective topics of information on centralized network. The support system further comprises a dynamic website that includes dynamic database driven web-pages by means of server site programming. Certain embodiments of the dynamic website provide a support system that comprises of a platform for client site programming operable for communicating with the dynamic web-pages. The support system is further configured with interactive interface. The interactive interface is configured with a software based system that provide peer-to-peer communication environment to enable knowledge based sharing system that is properly configured for efficient communications and that supports decision making. A multicast approach may be employed to deliver these communications between clients within the network and to update the network with additional tools for further interactions and/or interactive communications. The multicast approach includes technologies to deploy the multicast service in existing multiprotocol label switching virtual private network “MPLS/VPN” for transmitting multicast data between FMDC clients within the FMDC network through their private networks by encapsulating the original multicast packets.

The organized bodies of knowledge through the support system would allow the mind and spirit of observers to generate its own reality, in that, what is true in one observer's mind may not be true for other observers. The reality here comprises of the knowledge of positivism, which is the knowledge based on actual positive sense in near real physical, visual and/or virtual experience based on social and/or sociological facts that may lead to economic knowledge in social values. For example, just as a human brain may be pronounced dead by a doctor, the heart in that same body may bring to life another separate body of faith in need of a heart transplant. This is the spirit of positivism.

Other features and advantages of disclosed embodiments would become readily apparent upon review of the following description in association with the accompanying drawings.

### BRIEF DESCRIPTION OF THE DRAWINGS

FIG. 1 illustrates an exemplary embodiment of a centralized transportation vehicle in a server system for communications, includes a cache engine, an indexer, and another server is configured with software for network.

FIG. 2 illustrates an exemplary embodiment of a system for the network environment, comprising web-enabled devices in communication with the centralized transportation vehicle.

FIG. 3 illustrates further exemplary embodiment of the network comprising multiple computer system configured for Internet applications, further includes a decision engine, a wireless device and a server system for the network.

FIG. 4 shows a flow chart illustrating the exemplary process of extracting science, engineering, and transportation topics of information from a database.

FIG. 5 shows further exemplary embodiment of the network in communication with the search engine for routing information in the network and for extracting information from the database.

FIG. 6 shows further exemplary embodiment comprising the process of identifying a pattern from topics of information that have been found in a database.

FIG. 7 shows exemplary embodiment of a table of initial topics of information to be searched from the database and the process of verifying that a topic of information has been found in the network.

FIG. 8 is seen an exemplary embodiments of the communication apparatus in a network environment.

FIG. 9 is seen further exemplary embodiments of the communication apparatus in a structured environment.

FIG. 10 is seen further exemplary embodiment of the communication apparatus in a network environment.

FIG. 11 is an exemplary embodiment of a mobile phone with a touch screen panel operable for communications; interactive gaming; music applications; a slider operable for accessing multimedia buttons.

FIG. 12 is an exemplary embodiment of a mobile phone with numeric keypads operable to provide voice over texting applications; a slide out keyboard; and a resistive touch screen character recognition.

FIG. 13 is an exemplary embodiments of nanotechnology application of CMOS multiple antenna on a chip and nano-wires for transporting energy.

FIG. 14 is an exemplary embodiment of the antenna apparatus and the energy transport medium.

FIG. 15 is an exemplary embodiment of the CMOS multiple antennas on a chip comprising substrate microfiber embedded with meta-material.

FIG. 16 is seen further exemplary embodiments of communication device comprising energy platform.

FIG. 17 is an exemplary embodiment of a charge transport comprising microfiber material being configured with silicon substrate.

FIG. 18 is seen a communication environment comprising a monitoring station, agencies, and a government building.

FIG. 19 is seen further embodiment of a monitoring station comprising a fiber tower network.

FIG. 20 is seen a transmitter being configured with energy apparatus comprising a battery cell which may be charged wirelessly.

FIG. 21 is seen a transmitter and a receiver being configured with energy apparatus comprising a battery cell which may be charged wirelessly.

FIG. 22 is seen an embodiment comprising the circuit diagram of the communication apparatus, including a privacy indicator.

FIG. 23 is seen further exemplary embodiment of the communication apparatus comprising at least an input device, including a keyboard.

FIG. 24 is seen further exemplary embodiment of the communication apparatus comprising, storage medium, a processing unit in communication with a memory device.

FIG. 25 is seen further exemplary embodiment of a social network environment.

FIG. 26 is seen an exemplary embodiment of a signup environment.

FIG. 27 is seen an exemplary embodiment of a login environment.

### DETAILED DESCRIPTION OF PREFERRED EMBODIMENTS

The terminology used herein is for the purpose of describing particular embodiments only and is not intended to be limiting of embodiments. As used herein, the singular forms “a”, “an”, “at least”, “each”, “one of”, and “the” are intended to include the plural forms as well, unless the context clearly indicates otherwise.

It would be further understood that the terms “include”, “includes” and/or “including”, where used in this specification, specify the presence of stated features, integers, steps, operations, elements, and/or components, but do not preclude the presence or addition of one or more other features, integers, steps, operations, elements, components, and/or groups thereof. In describing example embodiments as illustrated in the drawings, specific terminology is employed for the sake of clarity. However, the disclosure of this patent specification is not intended to be limited to the specific terminology so selected and it is to be understood that each specific element includes all technical equivalents that operate and/or function in a similar manner. It would be further noted that some embodiments of the enclosed communication apparatus is used concomitantly and/or not used concomitantly with a search engine. In some embodiments, the communication apparatus comprises a platform array responsive to media communications. In some embodiments, the communication apparatus further comprises of a platform array responsive to signal radiation. Other embodiments herein describe apparatus configured for entertainment, education, and social network.

The foregoing and/or other objects and advantages would appear from the description to follow. Reference is made to the accompanying drawing, which forms a part hereof, and in which is shown by way of illustration specific embodiments in which the embodiments may be practiced. These embodiments being described in sufficient detail to enable those skilled in the art to practice the teachings, and it is to be understood that other embodiments may be utilized and that further structural changes may be made without departing from the scope of the teachings. The detailed description is not to be taken in a limiting capacity, and the scope of the present embodiments is best defined by the appended claims. Referencing the drawings, wherein reference numerals designate identical or corresponding parts throughout the several views, exemplary embodiments of the present patent application are hereafter described. The numbers refer to elements of some embodiments of the disclosure throughout. As used herein, the terms “and/or” and “at least one of” include any and all combinations of one or more of the associated listed items.

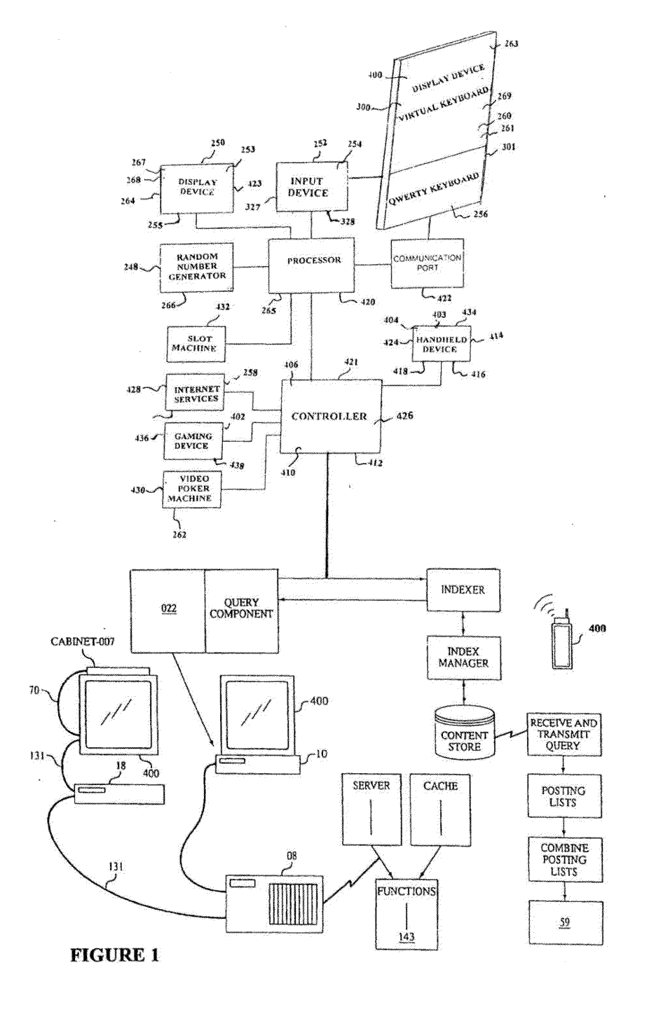

Referring to FIG. 1 is seen an exemplary embodiment of the search engine comprising a communication apparatus. The communication apparatus further includes a cell phone 400. The communication apparatus further comprises at least an input device 252, including a keyboard 254. The keyboard 254 may consist of a virtual keyboard 255 and/or QWERTY keyboard 256 in further communication with a random number generator 248. The communication apparatus further comprises a centralized transportation search engine comprising science, transportation and engineering topics data processing system operable on a social platform 258 operatively configured for multicast virtual private network for advancing science, transportation and engineering knowledge. The social platform 258 comprises a social network application in communication with the processor 420. Disclosed embodiments further provide the keyboard disposed on an LCD display screen 260 being configured with sensors 327 operable for object recognition. The social platform further comprises an environment for communications of science, engineering, and/or transportation topics of information. At least one science topics of information further comprises fashion world media consisting of a social platform for publicly declaring the will of positivism, sharing human knowledge for organized studies, dealings with the body of facts and truths to explain the phenomena of social media in the environment of natural fashion media, model media, and dress code media “FMDC,” exhibiting a dimension of social sustainability to gracefully improve corporate and community well being through social, cultural, environmental, and economic vision by the goodness of change. Change can be embraced with the hope for sustainable cultural independence.

Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265, and camera 263. Disclosed embodiments further provide the communication apparatus further comprising at least one of: a mobile communication device 400, a gaming device 402, a media device 403, and an interface device 404. The communication apparatus further comprises a computer apparatus 400 comprising a computer recordable medium 10 being operable on a computer readable program being recorded to cause at least one computer device to receive plurality of science, transportation and engineering reference documents. The computer apparatus further comprises database comprising topics of information relating to science topics, transportation topics and/or engineering topics. The computer apparatus is further operable for storing a frequency through which a module generates content when queried and is further operable for determining keyword compatibility based on the frequency. Disclosed embodiments provide the interface device comprising at least an integrated phone/PDA 400 being configured with integrated connectivity apparatus 406 operable to provide global roaming for communications and for accessing science, engineering, and transportation topics of information. At least a communication port 422 is provided with the communication apparatus 400. Certain embodiments of the disclosure provide the communication apparatus comprising a GSM phone 400 being operable on plurality microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video, social network, and phone book.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still, other embodiments provide a communication apparatus comprising of carbon fiber 408 and/or silicon substrate microfiber consisting of resistive touch screen 260 and/or character recognition 269 and/or a communication board 300. Certain embodiments provide housing 301 for the communication apparatus 400 comprising a carbon fiber 408 and/or a silicon microfiber. Disclosed embodiments further provide a communication apparatus being configured with at least a WAP browser 410 and/or an integrated GPS device 412 and/or an MP3 music device 414 and/or a camera apparatus 416 in communication with an interactive interface apparatus. The interactive interface apparatus operatively configured with at least a multi-protocol label switching comprising a label switched path operable on at least a support system operatively configured for mapping desired communications and to execute at least a process to at least a reference document. Disclosed embodiments further provide a communication apparatus further configured with an internal antenna apparatus 418 being configured with a controller 421 in communication with a predictive text messaging applications 423. Disclosed embodiments further provide the support system communicatively connected to at least a dedicated processing element being operable for providing carrier based multicasting virtual private networks. Certain embodiments provide the communication apparatus 400 being configured with at least one of: infrared sensor 326, calendar 268, FM radio 424, Bluetooth technology 426, and GPRS Internet services 428. Disclosed embodiments further provide the communication apparatus 400 comprising a video poker machine 430 and/or a slot machine 432, and/or a handheld device 434 and/or a gaming device 436 and/or a play station 438 in communication with communication port 422. Preferred embodiments provide the communication apparatus 400 comprising a search engine for routing science, engineering, and transportation topics of information.

At least one interactive interface apparatus is a user interface associated with a computer readable medium within a media management application environment. Embodiments provide the user interface comprising a plurality of science topics for displaying at least one topics of information in a list of one or more media file sources. Certain embodiments provide at least a list of user selectable media file identifiers from a group consisting of science topics of information, wherein selected information is associated with a listed media file identifiers for identifying fashion topics, model topics, and dress code topics. At least one identifier further comprises instructional topics of information as to how a user can cause one of the science topics to display selected topic information associated with the listed media file identifiers. Some embodiments provide at least one of: a gaming platform; a media player platform; a control interface platform; a commence platform; an electronic commence platform; an advertisement platform; a fashion platform; a model platform; a dress code platform; an educational platform; and a learning platform. Other embodiments provide at least one aspect of the user interface comprising displaying an instant messaging through at least one platform as a media file source. In one disclosure, the media file source may comprise messaging platform for users. Embodiments further provide a messaging platform environment for user communicate with one another. Certain embodiments provide at least one selection platform comprising means for messaging user to cause at least one science topics to be displayed as information associated with media files found in a media platform

Some embodiments provide the network 20 comprising distributed collection of nodes interconnected by communication links 131 and segments for transporting reference document data between end nodes. Other embodiments provide the end notes comprising computer devices and workstations. Disclosed embodiments provide the network comprising local area networks (LANs); wide area networks (WANs). The communication apparatus 400 further comprises circuit board comprising electronic system's applications being configured for embedded network for at least one of: a wired communications device, a wireless communications device, a cell phone, a handheld communication device, laptop computer, desktop computer, telemetry device, a switching device, MP3 player, a router, a repeater, a codec, a LAN, a WLAN, a Bluetooth enabled device, a digital camera, a digital audio player and/or recorder, a digital video player and/or recorder, a computer, a monitor, a television set, a satellite set top box, a cable modem, a digital automotive control system, a control module, a communication module, a digitally-controlled home appliance, a printer, a copier, a digital audio or video receiver, an RF transceiver, a personal digital assistant (PDA), a digital game playing device, a digital testing and/or measuring device, a digital avionics device, a media device, a medical device, and a digitally-controlled medical equipment.

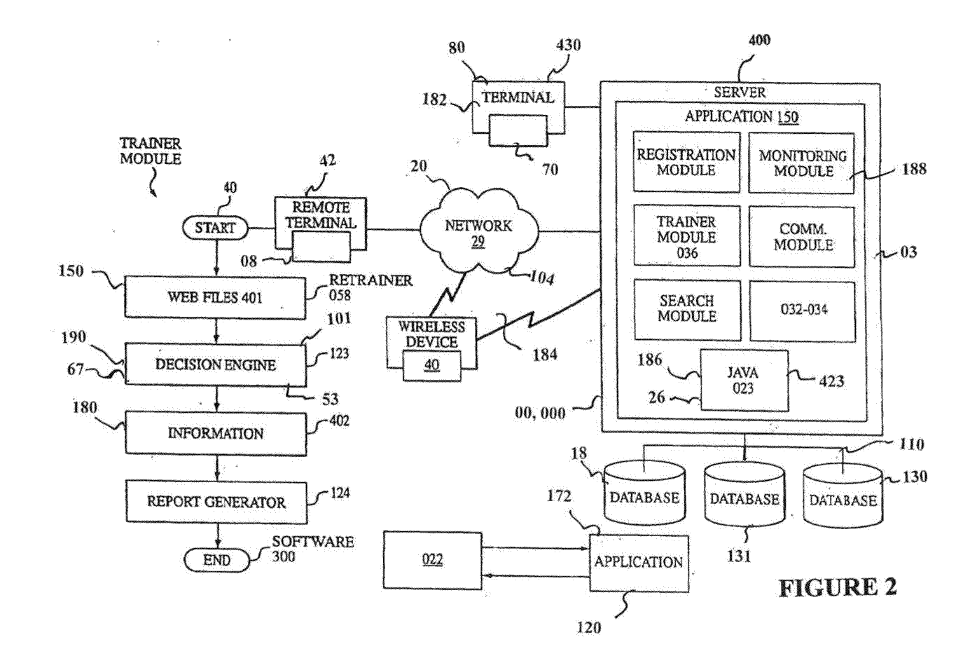

Referring to FIG. 2 is seen an exemplary embodiment of a network environment, comprising a communication apparatus 400 in communication with an output device 70 operable for outputting science, engineering, and transportation topics of information. Disclosed embodiments further provide the communication apparatus 400 further comprising at least a computer apparatus 430 configured with software 300 further comprises an operating system. Certain embodiments provide the computer apparatus 430 comprising at least a server 00, 000 in communication with a client module 120 for determining that at least a key word maps to science, engineering, and transportation object identifier. The communication apparatus 400 is communicatively connected to the client interactive interface module 172 in communication with network 20 comprising a link to a profile being configured for providing network services for science, transportation and engineering topics. The communication apparatus 400 further comprising at least a software program 300, wherein at least one software program is configured with at least a memory device 180 in communication with search module 190 comprising values being accessible to the dedicated processing elements 423. The communication apparatus further comprising at least a hardware means comprising the dedicated processing elements being configured with an input array 182, an output array 184, and/or a query array 186. The computer apparatus 430 further comprising at least a database comprising an application module 130 configured for providing information relating to science, engineering, and transportation topics and/or topics of information. At least one information further comprises science information relating to sociological knowledge that are reliably shared to produce useful feeds relating to a person, a product, a culture, an association, entertainment, a sport, an event, a career, a show, a business, an organization, a program, an educational institution, a corporation, consisting of topics of information to aid and educate the society through the environment of social media, asserting the influence of positivism for the betterment of the society. Certain embodiments provide a monitoring module 188 operable for monitoring and storing the frequency through which each module generates content when queried. Some embodiments provide a communication module 192 in communication with registration module 194 operable for determining keyword compatibility based on the frequency.

The client interactive interface module 172 is communicatively connected to at least one computer apparatus 430, further comprising at least a decision engine 123 disposed with a data bus comprising a platform for writing input into at least a data memory for at least one array. Other embodiments further provide the decision engine 123 operatively configured with a report generator 124 in communications with network connection keys. The network connection keys in communication with files, forms, documents, and/or industrial files 18, network files 110, graphic user interface 101, sensors 104, web files 401, and system memory 53. Certain embodiments provide the communication apparatus being further configured with system bus architecture 67 in communication with an input device 80. Disclosed embodiments provide report generator 124 in communication with an instruction program 26. Certain embodiments provide the instruction program 26 configured with trainer module 036 and retrainer module 058. The trainer module 036 and retrainer module 058 are configured with CPU 03. The CPU 03 is in communication with a java class 023, a clickn Vest Servlet class 032, and a Servletrunner application 034.

Disclosed embodiments further provide the files, forms, and documents further comprising data relating to science, engineering, and transportation topics of information. The communication apparatus further comprises a wireless device 40 comprising applications operable for optimizing and/or for sharing transportation and/or engineering topics of information. Certain embodiments provide the communication apparatus comprising a remote terminal and/or a network terminal 022. The communication apparatus further configured with a readout tool 08 in communication with an address book 131 communicatively connected to content store. Disclosed embodiments further provide the computer apparatus 430 further comprising at least a module for determining that at least a key word maps to an object identifier for science, engineering, and transportation topics of information.

The network terminal 022 is provided in communication with a query component. Certain embodiments provide the communication apparatus 400 in a network environment 29 comprising at least a server application 150. The server application 150 further includes at least one of: a registration module 194, a monitoring module 188, a trainer module 036, a communication module 192, a search module 190, and/or java application software 023. Certain embodiments provide the java application software 023 in communication with a database server 000. Disclosed embodiments provide the communication apparatus 400 further comprises ports and/or terminals comprising a network terminal 022 in communication with the application module 130. Certain embodiments provide the communication apparatus being turn on by at least a start button in communication with at least a control device. Other embodiments provide the control device comprising a wireless device 40 communicatively configured for communications with remote terminals 42. Disclosed embodiments further provide a communication apparatus comprising at least one of: report generator module 124, information module 402, retrainer module 058, web-files module 401, a clickn Vest Servlet class 032, and a Servletrunner application 034, and/or a decision engine.

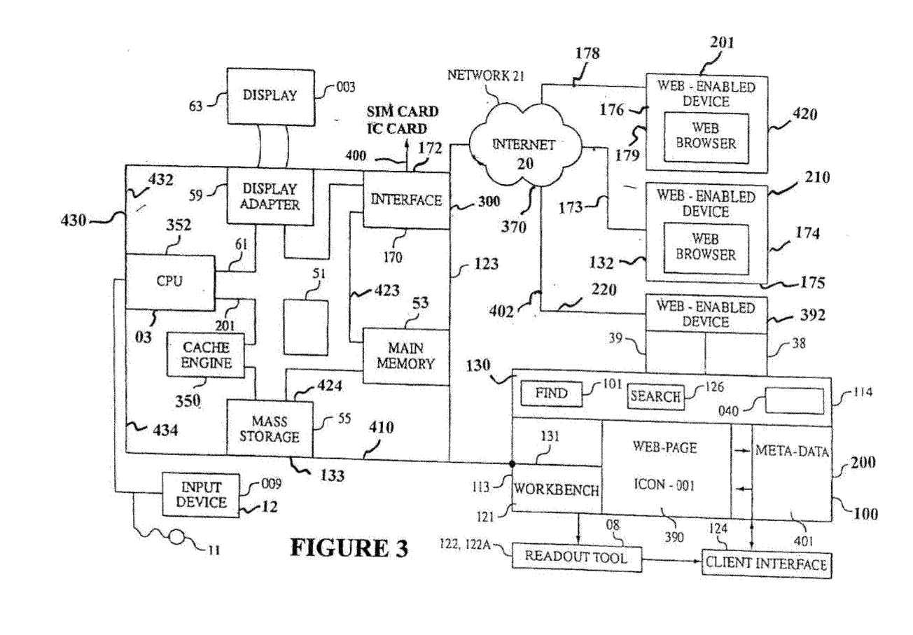

Referring to FIG. 3 is an illustration of a network environment 21 comprising a communication apparatus 400 in communication with a computer system comprising a display device 003, a sound card 61, speakers 63, a cache engine 350, a network interface 170, a display adapter 59, intelligence logic 352, a media device 201, and a central processor 51. The communication apparatus further include an input device 009 comprising at least a keyboard 11 and a mouse 12. The communication apparatus further include an IC card and a SIM card in communication with network interface 170. The CPU 03 is operable with the intelligence logic 352 to process commands and applications, in communication with memory 53, decision engine 123 and web-enabled devices. Disclosed embodiments further provide the web enabled devices comprising a browser 040. The network 21 is responsive to communications through the Internet. Certain embodiments provide a communication apparatus being configured with the browser 040, a server search report 39, and client search programs 38. Disclosed embodiments further provide a communication apparatus configured with graphic user interface 101, a search program manager 126, a browser 040, an ICON 001, and a storage medium comprising at least a meta-data 114. At least a web-page manager 392 is provided comprising addresses 131, corporations 200, industries 100, schools and ware houses 121 and a workbench 113. The computer system further comprises an affinity analyzer 122, a data analyzer 122A, a readout tool 08, a web-page 390, a report generator 124, web file module 401, and client interface being operable with software application 300.

The communication apparatus 400 comprises science, transportation and engineering topics of information. Disclosed embodiments provide the communication apparatus 400 further comprising a data processing system 410 operable on a social platform 420. The social platform 420 comprises a social network environment operatively configured for multicast virtual private network. Disclosed embodiments provide the virtual private network 178 comprising apparatus operable for transmitting same data to multiple receivers in a network. Certain embodiments provide the multicast virtual private network 178 comprising at least a multicast packet 176 configured for replication with at least a router 179. The multicast private network comprises a network interface 170 for advancing science, transportation and engineering knowledge. The network interface 170 further comprises: at least a computer apparatus 430 comprising a computer recordable medium 432 being operable on a computer readable program 434. The computer readable program 434 is configured to cause at least one computer device to receive plurality of science, transportation and engineering reference documents in communication with client interactive interface module 172 operatively configured with at least a multi-protocol label switching 173 being operable on at least a support system 210 operatively configured for mapping desired communications. Disclosed embodiments further provide the multicast-protocol label switching 173 comprising apparatus configured to direct data from network note 20 to network note 21 in communication with a virtual link. Certain embodiments provide the multi-protocol label switching comprising apparatus configured for carrying data from network note 20 to network note 21 in communication with a virtual link. At least one support system 210 is configured with the social platform 420 and communicatively connected to at least a dedicated processing element 423.

The multi-protocol label switching 173 is further configured to speed up network traffic flow to effectively mange structured reference documents comprising science, engineering, and transportation topics of information. Other embodiments provide the virtual private network 178 further comprising the router 179 in communication with the multiprotocol label switching network 173. The router 179 configured for the distribution of science, engineering, and transportation topics of information across a shared multiprotocol label switching network. Disclosed embodiments provide the router further includes Internet protocol addresses for establishing multiple switched paths with the multiprotocol label switching network. Other embodiments provide the multiple switched paths comprising plurality point to point paths assignments for science, engineering, and transportation social network. Some embodiments provide the router 179 further configured for maintaining communications with the database 130 containing science, engineering, and transportation reference documents for the topics of information. Other embodiments provide the database further comprising prefix of the topics of information that matches science, engineering, and transportation topics addresses in the packet's network destinations address field. Disclosed embodiments further provide the Internet protocol configured to determine at least a direction for the packet transmission from the router to at least a remote computer system. In the disclosure, the packets further include Internet protocol data-gram comprising network addresses for remote destinations.

The dedicated processing elements 423 being operable for providing carrier based multicast virtual private networks 178. Some embodiments provide multi-protocol label switching 173 consisting of labels 175 comprising packets 176 to forward decisions made on the contents of the labels. Disclosed embodiments further provide the communication apparatus 400 further operable for categorizing transportation and engineering files referenced by initial search results, comprising implementing at least a method for receiving at least a query that maps to objects identifier for transportation and engineering topics. The virtual network further comprises interactive collaboration within a secure science, engineering, and transportation reference document. The virtual network further comprises a server-based social network operable for community distribution of knowledge. The network is configured with document management system comprising a server database that includes at least a professional functionality and a plurality of interactive functionalities. Scientists, engineers, and transportation personnel may assemble into the network through the social platform. Interactive functionalities include allowing networks of scientists, engineers, students, universities, transportation personnel to share knowledge and documents in a remote secured environment.

Disclosed embodiments provide the communication apparatus 400 being configured with software applications 300, further operable to remotely create, delete, edit and manage science, engineering, and/or transportation documents and view information about the documents in a plurality of customized locations. At least one customized location further comprises FMDC network consisting of a social enterprise for bringing the actualization of potentials in Fashions, Models, and Dress Codes “FMDC” through an objective reality of social bodies being shared in a shared environment by observers that are governed in the support system. The support system is further communicable through the network environment by means of observation to sharing a common reality that is not commonly absolute by all observers. The support system further allows the mind and spirit of observers to generate its own reality, in that, what is true in one observer's mind may not be true for other observers. The reality here comprises of the knowledge of positivism, which is at least the knowledge based on actual positive sense in near real physical, visual and/or virtual experience based on social and/or sociological facts.

Certain embodiments provide the communication apparatus 400 further comprising at least a neural network 220 in communications with at least a cache engine 350 being operable for responding to at least a transportation and engineering topic request using a server response data that is cached at a network operable with at least a programmable architecture 424. Disclosed embodiments provide the programmable architecture 424 being configured with at least one dedicated processing elements 423. Certain embodiments further provide the cache engine 350 in communication with cache database 133. Some embodiments provide the search engine 402 in communication with the cache engine 350 configured for applications that include internet 370. Other embodiments provide the search engine 402 in communication with at least a crawler 174 and an index database 132. Disclosed embodiments further provide the communication apparatus 400 comprising a display adaptor 59 operable for communications with fleet STEMS, corporations 200, transportation industries 100, web file modules 401, and client interface 172.

Embodiments provide the computer readable program 434, further comprises computer readable medium comprising software code for a media management application, the code configured to implement functions comprising: generating an application environment within a user interface, the environment comprising a plurality of platforms; displaying in a first of the platforms a listing of one or more sources from which media files may be accessed; displaying in a second of the platforms a listing of user selectable media file identifiers, each identifier associated with a media file and with the one or more sources of science topics; displaying in at least one of the platforms first selected information associated with the listed media file identifiers; displaying in a another platform instructional information as to how a user can cause at least one platform to display second selected information associated with the listed media file identifiers; and displaying in at least one platform science topics of information and/or a media player control interface through which the user can direct the playing of the media files associated with the listed identifiers.

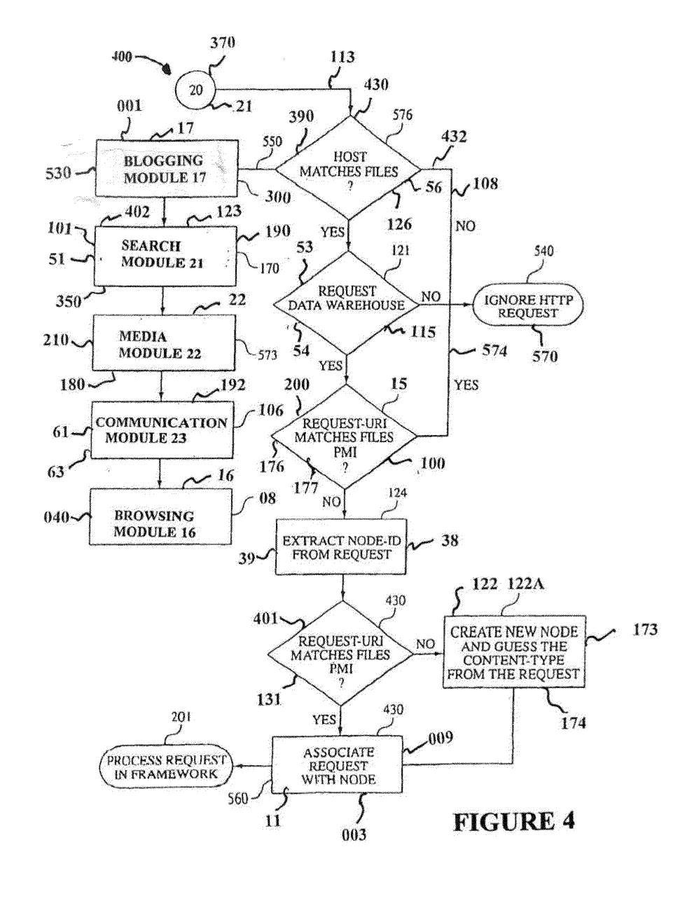

Referring to FIG. 4 is an exemplary illustration of the intelligence logic for the communication apparatus 400, comprising a blogging module 17 configured with application session layer 550 and software 300, a search module 190 in communication with network interface 170, a media module 22 configured with signal booster chip 573, a communication module 192 in communication with signal booster chip 573 and antenna circuit 106, and a browser module 16 in communication with a readout tool 08. At least a file memory device 53 is provided in communication with the software 300. Disclosed embodiments provide the communication apparatus 400 comprising a data warehouse 121 communicatively connected to the search module 190 being configured with a primary memory interface “PMI” 54, in communication with primary programs 15. Certain embodiments provide the communication apparatus configured with a client identification node “ID NODE” in communication with affinity analyzer 122 and data analyzer 122A. The media module 22 is communicatively connected to the media device 201, and the search module is communicatively connected to HTTP report generator 124 in communication with presentation layer 540. Some embodiments provide a computer apparatus 430 configured with a default gateway 432 in communication with a transport layer 560.

Certain embodiments provide the communication apparatus being operable on a platform 576 operable for processing mileage, fuel consumptions, host files, and science/engineering information. The PMI 54 further comprises at least a content file in communication with at least a subscription identifier 56 being programmable for providing at least a hash table network 176. Disclosed embodiments provide the hash table network 176 further comprising a decentralized distribution of the structured reference documents consisting of science, engineering, and transportation topics of information. The distribution hash table 177 is operable for providing a lookup network service, providing connections and records, including a peer to peer network communications for scientists, engineers, and transportation personnel. At least one cache engine 350 is operatively configured with at least one array operable for implementing steps for intercepting science, engineering, and transportation topics at network element comprising one or more science, transportation and/or engineering data packets that at least a client application addressed to a server application.

The search engine further comprises at least a markup language configured with at least one array for determining at least an application layer message that is contained in at least one portion of at least one data packets for specifying a particular request necessary for entering the searchable science, transportation and/or engineering topics of information. The search engine 402 further comprises at least one of: a spider 173, a crawler 174, at least one being operable for disseminating science, transportation and/or engineering topics of information. Embodiments further provide network environment 20 comprising a communication apparatus 400 configured for processing request in framework, in communication with remote computer systems configured for providing mileage readings and fuel consumptions. The communication apparatus 400 is further configured with search columns 21 and file columns 22. Certain embodiments provide the communication apparatus 400 configured with column 23 comprising forms 16, preventive maintenance programs “PMI” 15, and host files. Some embodiments provide the communication apparatus 400 configured with an indexer 108 in communication with data warehouse 121, social platform layer 574, and report generator 124. Other embodiments provide the communication apparatus 400 operable for data warehouse request. The communication apparatus is further configured to associate request with notes and to create new notes if a queried note with associated name does not exist.

In the disclosure, request to URI is compared for matches to files and ignoring HTTP request is enabled. Embodiments provide apparatus operable for extracting notes that contains Identifications from request. The network environment comprises the communication apparatus 400 in communication with a computer system comprising a display device 003, a sound card 61, speakers 63, a cache engine 350, a network interface 170, a display adapter 59, intelligence logic, a media device 201, and a central processor 51. The communication apparatus further include an input device comprising at least a keyboard 009 and a mouse 11. The communication apparatus further include an IC card, SIM card, and interface. The CPU is operable with the intelligence logic to process commands and applications, in communication with memory 53, decision engine 123 and web-enabled devices. The network 21 is responsive to communications through the Internet. Certain embodiments provide a communication apparatus being configured with a browser, a server search report 39, and client search programs 38. Disclosed embodiments further provide a communication apparatus configured with graphic user interface 101 comprising interactive interface apparatus, a search program manager 126, a browser 040, an ICON 001, and storage medium comprising at least a meta-data and/or a database server 115. At least a web-page manager is provided comprising addresses 131, corporations 200, industries 100, schools and ware houses 121 and a workbench 113 containing science, engineering, and transportation topics of information. The computer system further comprises an affinity analyzer 122, a data analyzer 122A, a readout tool 08, a web-page 390, a report generator 124, files 401, and client interface being operable with software application 300.

Embodiments provide computer readable medium comprising software code for a media management application, the code configured to implement functions comprising: generating an application environment within a user interface, the environment comprising a plurality of platforms; displaying in a first of the platforms a listing of one or more sources from which media files may be accessed; displaying in a second of the platforms a listing of user selectable media file identifiers, each identifier associated with a media file and with the one or more sources of science topics; displaying in at least one of the platforms first selected information associated with the listed media file identifiers; displaying in a another platform instructional information as to how a user can cause at least one platform to display second selected information associated with the listed media file identifiers; and displaying in at least one platform science topics of information and/or a media player control interface through which the user can direct the playing of the media files associated with the listed identifiers. In one embodiment, the present invention includes a user interface for a media management application comprising: managing science topics of information; managing engineering topics of information, managing transportable data comprising transportation topics of information, a media management application environment comprising a plurality of platforms; a first platform in which is displayed a listing of one or more information sources from which media files may be accessed; a second platform in which is displayed a listing of user selectable media file identifiers, each media file identifier associated with a media file comprising one or more information sources; at least one platform in which is displayed first selected information is associated with the listed media file identifiers; at least one platform in which is displayed instructional information as to how a user can cause the another platform to display second selected information associated with the listed media file identifiers; and at least one platform in which is displayed a media player control interface through which the user can direct fashion contents, model contents, dress code contents, and the playing of media files associated with the listed identifiers.

At least one application layer 530 message is a java message consisting of transportation and/or engineering topics of information configured for Web based applications. The search engine 402 further comprising a structured science, transportation and engineering network environment 20 communicatively connected to at least one support system 210 comprising a social platform 573 configured with at least an index and/or a catalog comprising science, transportation and/or engineering data. The data further includes at least one of; parts purchasing, standard maintenance solution, preventive maintenance scheduling, preventive maintenance forms, fuel consumption log, mileage log, solutions to failed components, equipment sales, parts graphics, marketing, name search, sounds, text content file, terrorist name monitoring, video, Internet protocol television 180 comprising a communication system, engineering and/or science, engineering materials and/or tools, and at least an advertisement. Disclosed embodiments further provide the communication apparatus 400 comprising at least one software program 300 further configured for communications with at least one support system 210 being responsive to structured directory of science, transportation and/or engineering topics and providing communications relating to at least science, transportation and/or engineering topics of information in a network infrastructure.

At least one support system 210 is further responsive to global communication via Internet 370 for routing the occurrences of science, transportation and/or engineering topics of information. Certain embodiments provide the computer apparatus 430 operatively configured with the software program 300. Some embodiments provide the software program 300 further comprises at least a protocol being programmed for providing directory approaches to routing science, transportation and/or engineering topics of information and for analyzing at least an occurrence of the information. Other embodiments provide the information further comprises of keywords that are communicable to prioritize keywords in the list that frequently occur in a set of science, transportation and engineering topics documents. Disclosed embodiments further provide the Internet protocol television 180 comprising apparatus for delivering Internet television services consisting of structured science, engineering, and transportation topics of information.

At least one protocol is operable for accessing and/or for delivering structured data containing science, transportation and/or engineering topics of information over the Internet 370. At least one computer apparatus 430 is configured to cause a computer device in communication with the cache engine 350, operable to apply integral reference content rate for each science, transportation and engineering topics in at least a set of annotation type. The cache engine 350 is further operable for caching data operations being requested from at least one computer apparatus 430. The computer apparatus 430 is further operatively configured with at least one network data storage medium in communication with at least a network client. The network storage medium further comprising a cache memory for caching structural functions and further operable for requesting data structures comprising science, engineering, and transportation topics of information by network client through the network environment 20.

At least one software program is operatively configured with at least one support system 210, further comprising at least a mapping circuit comprising a lookup table which is indexed by a pattern ID value for providing at least one science, transportation and/or engineering topics of information using at least a pattern responsive to at least a potential query of the topics. Disclosed embodiments further provide the communication apparatus 400 comprising a support system 210 configured with at least a chat function for topics of information comprising at least one of; engineering social network, science and/or engineering project sharing and/or project development, science topics of information relating to the will of positivism, transportation preventive maintenance, transportation services, transportation failure analysis, transportation solution to failed components, transportation fuel consumption, transportation mileage classifications, and transportation vendor's classifications and/or information, transportation equipment sales, parts graphics, marketing, at least a name search, sounds, text, content file, video, Internet protocol television communication system, engineering tools, and at least advertisement.

The fashion world media “FWM” platform is a network environment that allows individuals and companies to capture large audiences through presentation of fashion brands, trends, styles, and awareness. Let your public declarations reflect every possible influence on the broad areas of fashion which isn't defined solely by clothing choices, but is also conveyed through the manner in which people carry themselves that in turn inform and reflect their personalities and world views. Yes, fashion touches on prevailing styles, customs, and behaviors, both individually and collectively. Further, the FMW platform is configured to allow individuals and corporations the opportunity for a ready forum to announce, display, reveal, share and advertise their products. Users of the network are encouraged to project and embrace creative minds to achieve all stated goals. Indeed, this forum is a centralized fashion tool to reach worldwide clienteles thereby facilitating online brand passion, fashion passion, brand postings, and customer loyalty. The expected positive community impact will not only succeed at the above-listed goals, but must also be seen as a potentially effective medium for enhancing brand success, business awareness and, in the long-run, growing a versatile community with noticeable cultural and economic improvements. Let organized, structured fashion be the guide in all social network environments.

Some embodiments provide the will of positivism comprising at least one of: spoken words, written words, advertised objects, advertised products. The positivism is bringing out the actualization in real positive sense through a social environment. For example: “In the beginning of creation Heaven and earth was first created by God and the power of His word brought light to the surface of the earth. God created us out of His own image and empowered us to take control of all His creations. The power of God's words is on our tongue and He made us beautifully out of His likeness.” The will of positivism can be derived from God's word to reflect one's inner thought, such as: “Let the world hear our voices through our fashions, our models, and our dress codes.

Let the voice of the community create a model based on the community cultural interest. Let the voice of a religious affiliation create a model based on their culture.

Let the voice of a business or a corporation creates a model based on the uniqueness of their product offerings. FMDC network is a network of change for media communication. FMDC is about publicly declaring the science of positivism in you, a person, a product, a business, a corporation, an institution, a career, a job, a culture, an event, a show, an educational institution through fashion media, model media, and dress code media. The network further provides an environment for signing and for uploading of fashion, model, and dress code, and for automatically creating a virtual private network “VPN” within FMDC network so that one can share positive declaration with friends, family members and others. The network further comprises a public network such as the Internet to connect clients at remote sites together in FMDC network so that they can share their will of positivism with others. The VPN is desired to reveal the science of positivism for mass communications, and for providing peer-to-peer network connectivity between clients, friends, businesses, corporations, and more.

FMDC network is a social platform for providing substance of things hoped for, revealing the evidence of things not commonly seen. This evidence of things not commonly seen is CHANGE, which can be embraced through fashion media, model media, and dress code media with the hope for sustainable cultural independence. For by CHANGE societies would receive good reports, for things which are seen are not spiritually made of things which do appear as a means of inquiry, but rather appear as a dimension of social sustainability to gracefully improve corporate and community well being through social, cultural, environmental, and economic vision. FMDC network further provides a communication environment for individuals and groups such as colleges, universities, churches, stores, organizations, cultural entities, businesses, entertainment/sport entities, events, corporations and more, to present the positivism of these groups or their product through a social media environment consisting of fashion media, model media, and dress code media, so that the science of positivism for their product offerings may be shared through a centralized system.

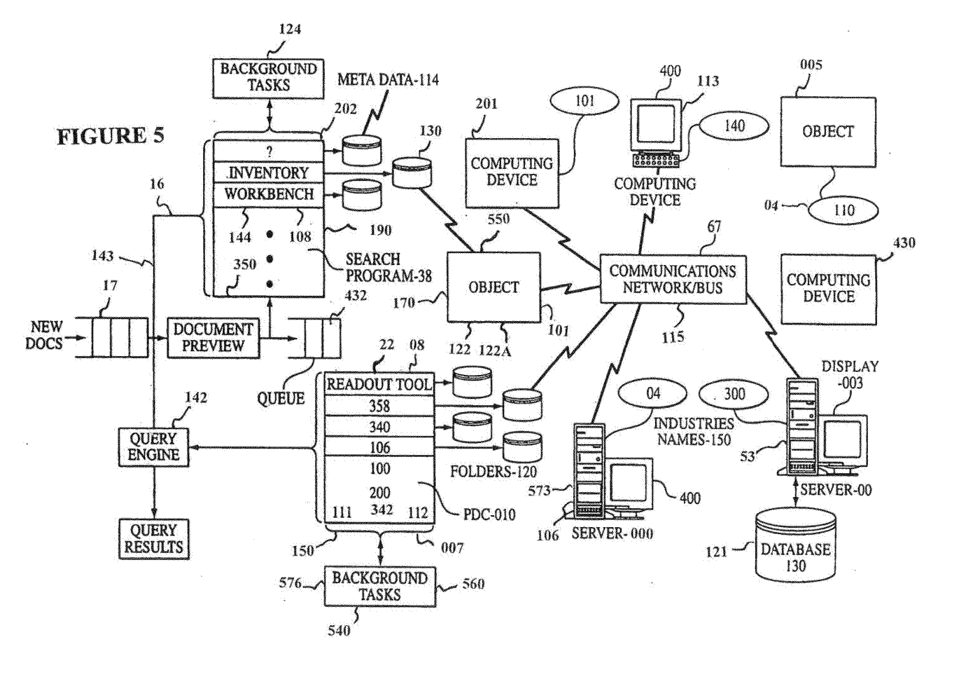

Referring to FIG. 5 is seen exemplary embodiments of the communication apparatus 400 comprising a query component configured with an indexer 108 in communication with an index manager 202. Embodiments further provide a network environment comprising a server 000, 000 and a cache engine 350 in communication with functions 143 configured for operations with software 300. The functions 143 further include social platform 573 comprising social network environment being operable to receive and transmit communications to at least one of: a memory 53, a cabinet 007 comprising a content store for science, engineering, and transportation topics of information. Disclosed embodiments further provide a centralized science, engineering, and transportation network system configured with server 00 and 000 comprising adaptors to maximize productivity and end client longevity. Certain embodiments provide the server adaptor configured to allow end client to end client communication through STESN search engine. Certain embodiments provide communication network system comprising a bus 67 further configured to periodically provide maintenance, in communication with the URL. The URL may be modified at random times by their web masters. The communication network bus 67 is further configured to produce a single link that either point to STESN web site or its modified web site by continuously finding, indexing, and cataloging the web pages. Some embodiments provide password module 140 in communication with the server adaptor software configured to automatically reroute traffic signals when any of the server port experiences a failure or is disconnected. Other embodiments provide a query engine 142 in communications with files and forms modules being monitored to allow access to multiple server files containing client data to enable prevention of any loss of information when the hardware experiences a failure.

Disclosed embodiments further provide the query engine 142 configured for communications with multiple file storage system being centralized for maximum protection and for providing real time query results. Certain embodiments provide the query engine 142 in communication with communication apparatus 400 further comprising computer apparatus 430 is configured with user interface 101 operable for centralized science, engineering, and transportation network system. Some embodiments provide the communication apparatus further comprises a PDC 010 being configured with a switch to connect client system and servers together to create a client server network within the system and a social environment for communications. Other embodiments provide the communication apparatus comprising application module 130 in communication with data warehouse 121, folders 120, readout tool 08, search program 38, and document parser 144. The document parser further includes new documents. Disclosed embodiments provide the search program 38 further comprising background tasks. The background tasks further include types of transportation 340, failed components 342, industries 100, corporations 200, industries names 150, government agencies 111, and garages 112. Some embodiments further provide the backup storage software being operable for providing backup file scheduling such as tape backups and server file storage backups. The backup storage further allows the centralized science, engineering, and transportation system access to remotely recover any lost file. Other embodiments provide the communication network bus 67 operable to eliminate single point failure. In the disclosed embodiments, indexer 108 is provided for storing of links pointing to information resources including some or all of the data associated with the information resource, including workbench 113, inventory 114, and term center 115. The query engine 142 further provides objects 110 being stored in graphical hardware 04. The objects are displayable on display devices 003. Certain embodiments provide the communication apparatus comprising a memory consisting of the content store in communication with input devices. Some embodiments provide the content store comprising database containing topics of information for advancing science, engineering, and transportation knowledge. The input device is further operable to receive and transmit query, and in communication with listings and/or combine posting relating to science, engineering, and transportation topics of information. At least a display adaptor is communicatively connected to the posting and/or the listings.

Certain embodiments provide the network environment comprising the communication apparatus 400 further configured with intelligence logic comprising a blogging module 17 configured with the session layer 550 and software 300. Disclosed embodiments provide the communication apparatus 400 further comprising a search module 190 in communication with network interface 170, a media module 22 configured with signal booster chip 573, a communication module 23 in communication with signal booster chip 573 and antenna circuit 106, and a browser module 16 in communication with a readout tool 08. At least a file memory is provided in communication with the software 300. The data warehouse 121 further comprises database server being communicatively connected to the search module 190. The search module 190 is configured with a primary memory interface “PMI” in communication with primary programs 15. Disclosed embodiments further provide a communication apparatus configured with a client identification node “ID NODE” in communication with affinity analyzer 122 and data analyzer 122A. The media module is communicatively connected to the media device 201, and the search module is communicatively connected to HTTP report generator 124 in communication with presentation layer 540. Some embodiments provide a communication apparatus configured with a default gateway 432 in communication with a transport layer 560.

Certain embodiments provide the communication apparatus being operable with means 576 for categorizing science, transportation and engineering files referenced by initial search results. Certain embodiments provide the means 576 for categorizing files further comprising implementing at least a method for receiving at least a query that maps to objects identifier for science, transportation, and engineering topics. Some embodiments further provide the means 576 configured with at least a neural network in communications with at least a cache engine operable for responding to science, transportation and engineering topic request using a server response data that is cached at a network. Disclosed embodiments further provide the network comprising network element operable with at least a programmable architecture configured with the dedicated processing elements. Certain embodiments provide the communication apparatus communicatively connected to the interactive interface apparatus in communication with a link to a profile being configured for providing network services relating to science, transportation and engineering topics of information. At least one science topic of information further comprises sociological studies. At least one other science topics of information further comprise social studies. At least one other science topics of information comprise a social network consisting of an environment for social media.

In the embodiment, the science topics of information further comprises models. A model is a representation of a system that allows for investigation of the properties of the system and/or prediction of the future outcomes. A model comprises of many shapes, sizes, and styles. It is important to emphasize that a model is not just the real world object but also consist of human construct to help the society better understand real world systems. A model should at least have an information input, an information processor, and an output of expected results, and should provide an environment where:
simplifying assumptions must be made;
boundary conditions or initial conditions must be identified
the range of applicability of the model should be understood

This may include conceptual models that consist of qualitative models highlighting important connections in real world systems and processes as a first step in the development of the more complex models. People receive information, process this information, and respond accordingly many times each day. This sort of processing of information is essentially a conceptual model of how things in our surrounding environment actually work.

A model may also be visualized as a visualization model. Visualization models comprise of direct links between data and some graphic or image output that may be linked with other type of models to convert the intended output into a visually useful format.

A model may also consist of abstractions of reality to deliberately emphasize one part of the reality at the expense of other parts. This is necessary due to objective power limitations, and may enable others to focus their attention on an important aspect of the model. Models are also mathematical, logical, business, corporate, or some other structured representation of reality consisting of the specific applications of the models to arrive at some outcome.

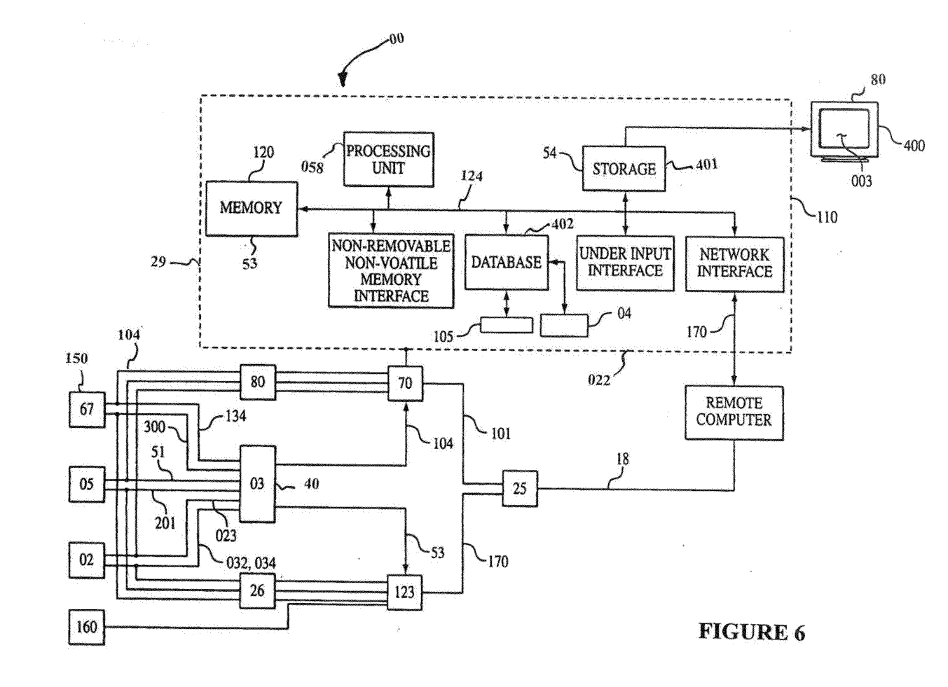

Referring to FIG. 6 is seen further exemplary embodiment of the communication apparatus 400 comprising, storage medium 54, central processor 51, and an analyzer 122 in communication with a memory device 120. Disclosed embodiments further provide a non-removable non-volatile memory interface, a database, input interface and network interface 170. Certain embodiments provide a communication apparatus comprising hardware 105, a graspable hardware/browser 04, and a display device 003. Other embodiments provide the communication apparatus 400 further comprising software 300, central processor 51, a RAM 05, a ROM 02, a network adaptor 160, a router 179 and a media device 201. Disclosed embodiments further provide a communication apparatus 400 comprising at least an output device 70, a remote computer in communication with a connection key 25. The connection key is further in communication with industrial files 18, network files 110, decision engine 123, graphic user interface 101, sensors 104, and system memory 53. Certain embodiments provide a communication apparatus being further configured with system bus architecture 67 in communication with an input device 80. Some embodiments provide the output device 70 further comprises a report generator 124 in communication with an instruction program 26. At least a CPU 03 is provided, in communication with a java class 023, a clickn Vest Servlet class 032, and a Servletrunner application 034. Disclosed embodiments further provide the files, forms, and documents further comprising data relating to science, engineering, and transportation topics of information.

### Fashion Social Media

The fashion industry has been late to join the social media community, and the delay to adopt fashion with social media community is hindering sales promotions, preventing social measurements for business and fashion trend awareness. The launching of THE FASHION WORLD MEDIA as a social network is important for the fashion industries. It brings to light positive public declaration of fashion brands, styles, and trends. The search engine platform for the fashion world media is a centralize communication hub for the fashion world that would further increase communication speed, strengthen brand awareness and impact community awareness through fashion social media network environment. The search engine platform would provide fashion trend relationship with consumers to enable cultural and community awareness.

The communication apparatus 400 is in a network environment 29, comprising at least a server application 150. The server application 150 further includes at least one of: a registration module, a monitoring module, a trainer module, a communication module, a search module, and/or java application software 023. Certain embodiments provide the java application software 023 in communication with a database server. Disclosed embodiments provide the communication apparatus further comprises ports and/or terminals comprising a network terminal 022 in communication with at least an application. Certain embodiments provide the communication apparatus 400 being turned on by at least a start button in communication with at least a control device 40. Other embodiments provide the control device 40 comprising a wireless device communicatively configured for communications with remote terminals. Disclosed embodiments further provide a communication apparatus 400 comprising at least one of: report generator module 124, information module 402, retrainer module 058, web-files module 401, a clickn Vest Servlet class 032, and a Servletrunner application 034, and/or a decision engine. Certain embodiments provide the communication apparatus further comprises hardware means comprising at least one dedicated processing elements configured with an input array, an output array, and a query array. The communication apparatus 400 further comprises interactive interface apparatus is communicatively connected to the computer apparatus.

The computer apparatus further comprises a data bus comprising a platform for writing input into at least a data memory in communication with the query array. The communication apparatus further comprises plurality server 00 each responsible for some portion of the database server workload. The database server comprises of science, engineering, and transportation files, forms, and documents stored in a distributed file system. Certain embodiments provide the distributed system comprising partitions, providing each individual component of the workload elements of science, engineering, and transportation topics of information being allocated to specific servers. Some embodiments provide a mechanism for copying contents of the application to each of the servers operable for independent applications. Other embodiments provide the contents of each individual component of the server for retrieving and for modifying data relating to science, engineering, and transportation topics.

In the embodiment, the science topics of information further comprises fashion models. Some embodiments further provide science topics further comprising fashion. Certain embodiments provide fashion comprising an art, ultimately consisting of individual statement of expression. It is also a religion, a job, a peek into a personality, playfulness, an escape, or a disguise. Fashion further comprises a feast for the eyes. Fashion is not limited/not something that exists in dresses only. Fashion is in the sky, in the streets, and has to do with ideas, the way we live, what is happening around the society. Fashion isn't defined solely by clothing choices, but it is also conveyed through the way we carry ourselves, our personalities and our views of the world. Fashion comprises of a prevailing style, custom, dress, or behavior.

Fashion also comprises fashion trends, consisting of anything which is popular in a culture at any given time. Fashion is inclusive of areas such as; style of dress, cuisine, literature, art, architecture, and structures, fashion trends and many other popular factors. Though fashion trends often change rapidly, fashion is often used to describe the latest version of these trends. Fashion is also used positively as a synonym for style, glamour and beauty. However, fashion can also be expressed to have negative connotations of fads and trends, and materialism. Other embodiments further provide science and engineering topics comprising Dress Code. At least one embodiment provides Dress Code comprising a set of rules governing what garments may be worn together and in what setting to convey a social message. Some embodiments provide clothing to convey a social message, even if none is intended. If a receiver's code of interpretation differs from the sender's code of communication, misinterpretation follows. In every culture, current time fashion governs the manner of consciously constructing, assembling, and wearing clothing to convey a social message. Clothes convey other social messages, including the stating, claiming personal, cultural identity, establishing, maintaining, defying social group norms, and further appreciating comfort and functionality.

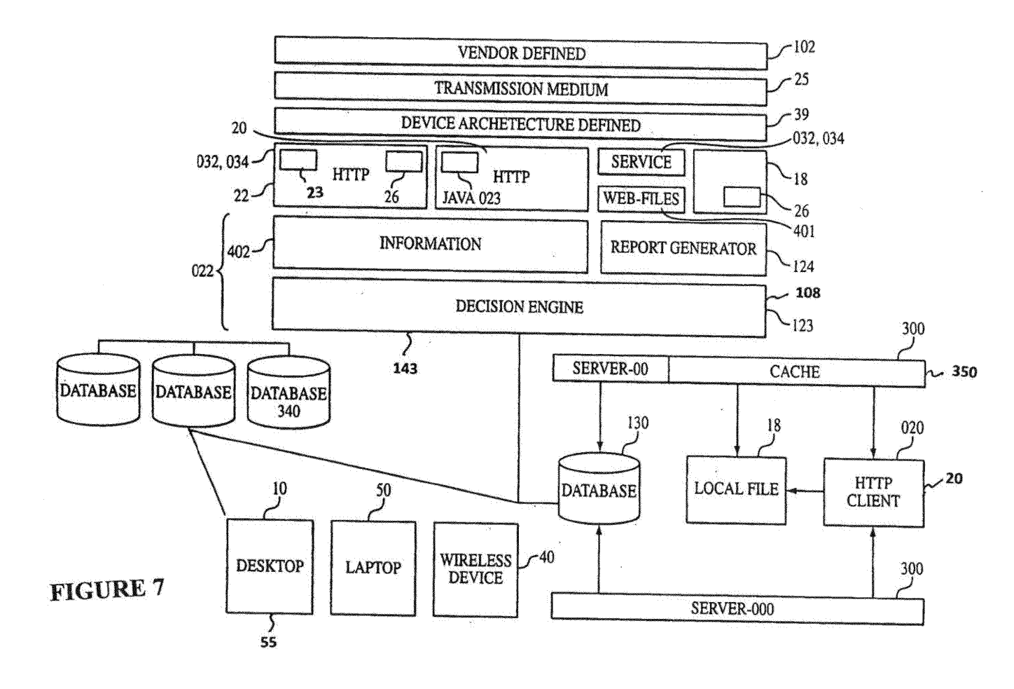

Referring to FIG. 7 is seen an exemplary embodiment of science, engineering, and transportation network environment comprising a communication apparatus 400 is configured with software 300 in communication with a vendor device 102, operable for outputting topics of information relating to science, engineering, and transportation. The communication apparatus further comprise a transmission medium 25, a computer system 10, a lap top device 50, and a wireless device 40. A decision engine 123 is provided for adding more self organizing maps for defining the various science, engineering, and transportation topics. The decision engine 123 is configured with Java classes: the JSTAR class 023 and the ClicknVestServlet class 032. The JSTAR Class 023 is a Java class that is also called a JSTAR Java servlet. The JSTAR class 023 is an object-oriented, Java language based application. The communication apparatus further comprising at least a module for determining that at least a key word maps to an object identifier for science, engineering, and transportation topics of information. Disclosed embodiments further provide a communication apparatus 400 comprising at least one of: report generator module 124, information module 402, device architecture 39, web-files module 401, a clickn Vest Servlet class 032, Servletrunner application 034, and/or a decision engine 123. A network 20 includes network terminal 022 being provided in communication with a query component 23. The query component is configured with an indexer 108 in communication with an index manager 22. Embodiments further provide a network environment comprising a server 00,000 and a cache engine 350 in associations with functions 143 in communication with software 300. The functions 143 further include social network environment being operable to receive and transmit communications to at least database 340, 130 and local file 18.

Certain embodiments provide the communication apparatus comprising a memory consisting of the content store in communication with an input device. Some embodiments provide an instruction program 26 in communication with the content store comprising database containing topics of information for advancing science, engineering, and transportation knowledge. The input device is further operable to receive and transmit query, and in communication with listings and/or combine posting relating to science, engineering, and transportation topics of information. At least a display adaptor is communicatively connected to the posting and/or the listings. Disclosed embodiments further provide the communication apparatus 400 comprising a desktop computer 10, a network computer 20, and a hand held computer 30, wireless devices 40, and a laptop computer 50, a gaming device 55, and a server 00. The communication apparatus is provided for network with HTTP client 020.

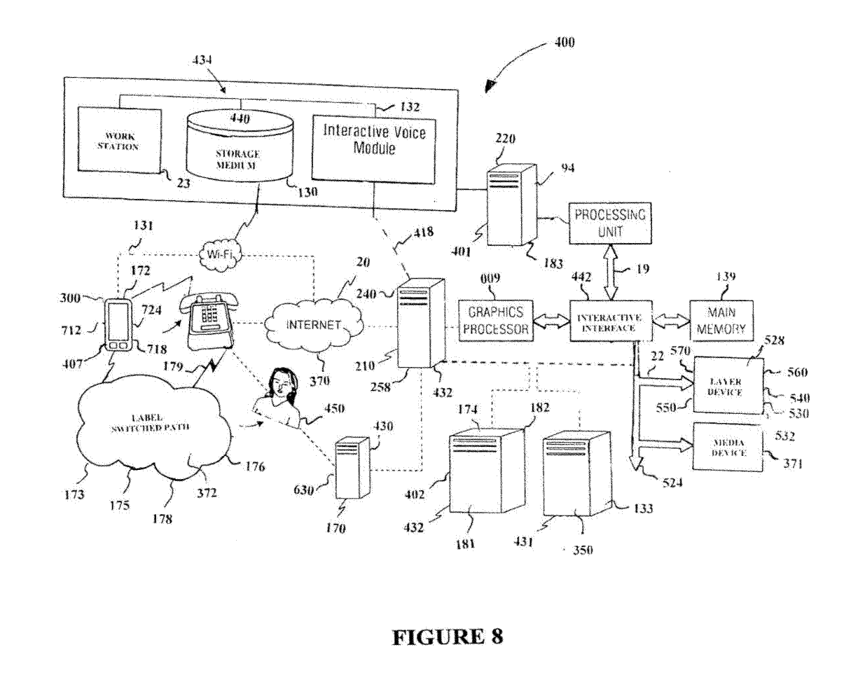

Referring to FIG. 8, the communication apparatus 400 includes a start and clients applications 120 coupled to a network 20. The network 20 comprises science, engineering, and transportation network known for effectuation knowledge and communications through the various devices. The network 20 can be a local area network (LAN), a wide area network (WAN), or a combination thereof. It is contemplated that the network 20 may be configured as a public network, such as the Internet, and/or a private network, and may include various topologies and protocols operatively configured for distribution of science, engineering, and transportation topics of information. In accordance with one embodiment of Disclosed embodiments, the communication apparatus 400 configured with at least one application 130, such as a multi-player online game, over the network 20. Furthermore, the applications 130 is distributed among several servers 00,000 coupled to the network 20. Thus, the same application 130 is provided to the clients 120 by multiple servers 00,000. Embodiments are configured for distributing the applications 130 among servers 00,000 to provide computational workload from possibly millions of clients 120 of science, engineering, and transportation environment to be shared topics of information. Disclosed embodiments provide a communication apparatus 400 operable to adjust the number of servers 00,000 that a distributed applications 130 uses, depending upon the variation in the application's load. Disclosed embodiments may further be employed to control the distribution of science, engineering, and transportation topics workload among the varying set of servers 00,000 over which the applications 130 is distributed. Certain embodiments provide the communication apparatus 400 further configured for communications with wireless devices 40. Disclosed embodiments are configured for utilizing key entry as query to communicate with applications 130 further configured for retrieving the topics of information from the database. At least a client registration module is provided in communication with a client monitoring module.

The document management comprises a tool configured to allow scientist, engineers, and transportation personnel to simultaneously view a window having folders for the topics of information and a window having an open document. The open document is shared with a first network 20 and not shared with at least one member who is not a member of the first network. The member is capable of clicking and dragging at least an open reference document into one of the folders containing desired communications, such that the open referenced document is shared with members of network 21 and is not shared with at least one member who is not a member of the first network 20 or the second network 21. At least one member of the second network 21 is not a member of the first network 20 in the social platform environment. The network 20 and 21 comprises one or more data links that enable the transport science, engineering, and transportation reference documents, including desired electronic data between computer systems and other electronic devices. When information is transferred or provided over the network 20 and, or another communications connection such as hardwired, wireless, or a combination of hardwired or wireless connections to the communication apparatus 400, the communication apparatus 400 properly views the connection as a transmission medium. Transmission media can include the network 20 and/or data links which can be used to carry or transport desired communications code in the form of computer-executable instructions or data structures and which can be accessed by a general purpose or special purpose remote computer system.

The monitoring module responsive to query keys is operable for communication with the communication module. The communication module is configured with the research module operable for routing science, engineering, and transportation topics of information from the database to the clients 120. The trainer module 036 is operable to configure to the pattern in which the query key is enabled. Each individual key corresponds to some element of the application workload for science, engineering, and transportation topics relating to searchable topics of information 402 consisting of the aggregations of all possible science, engineering, and transportation topics. Query keys are grouped into key groups or clusters of potentially varying sizes of the topics being handled by server 00 and 000. Disclosed embodiments further provide a communication apparatus 400 comprising at least one of: report generator module 124, information module 402, retrainer module 058, web-files module 401, a clickn Vest Servlet class 032, and a Servletrunner application 034, and/or a decision engine 123. Certain embodiments provide the communication apparatus further comprises hardware means comprising at least one dedicated processing elements configured with an input array, an output array, and a query array. The communication apparatus further comprises a decision engine 123 in communication with an interactive interface operable for presenting topics of information, product or services for science, engineering and transportation. A decision wizards is provided, comprising a comparative product charts. The decision engine 123 also may provide information about the various product or services. The decision engine 123 may present a series of questions to the clients 120 about various science, engineering, and transportation maintenance rundowns and scheduling. Predictive networks and artificial intelligence may be used in the decision engine 123. The decision engine 123 is configured with a report generator 124 in communication with software 300. Disclosed embodiments further provide the communication apparatus 400 in communication with network terminals 022 and/or remote terminals. The server can perform load shedding in accordance with Disclosed embodiments by simply modifying one or more groups that it currently manages.

The communication apparatus 400 further comprising virtual private networks 21 configured to deliver/broadcasting communications data via Internet Protocol Television edge routers 371 operable on a multi-protocol label switching environment 372. Disclosed embodiments provide the multi-protocol label switching environment 372 operable for sharing multicast state science, transportation and engineering data through a delivery tree comprising at least a server tool 009 in communication with other electronic devices via Internet 370 and/or broadcast channels. The computer apparatus 430 is configured with software program 300 comprising at least computer instructions in communication with at least an application tool comprising a module 130 operatively configured for delivering broadcast channels via Internet Protocol Television edge routers 371, in communication with the multicast virtual private networks 21. Certain embodiments provide the virtual private network 178 operable for sharing and/or permitting at least a client to access a database 132 comprising structured science, transportation and/or engineering topics of information.

Some embodiments provide the communication apparatus comprising computer readable storage medium 440. The computer readable storage medium 440 further comprises computer instruction being further operable for sharing the same multicast state and multicast delivering tree through a centralized transportation engine comprising a search engine 402 being operable for centralizing at least one remote computer apparatus 430 through at least a cable and/or wireless connections. The communication apparatus 400 is further configured for providing at least a physical connection for at least a network infrastructure operable for managing at least one computer device at a remote location. Disclosed embodiments provide at least one interface module 170 operatively configured for network connectivity in communication with network infrastructure 20. At least one network connectivity further comprises communications with at least a remote computer system and the network infrastructure 20 being further operable for disposing at least one of: network management, remote network operation, network client authentication, security, identifications, permissions and/or rights, and for locating at least a physical address of at least one remote computer within the network 20. Disclosed embodiments further provide the communication apparatus 400 comprising at least a layer device 530.

The layer device 528 further comprising at least one of: a model Layer 532 comprising computer instructions operable in multicast virtual private network for providing structured science, transportation and/or engineering network communications, an application layer 530 comprising computer instructions operable in at least a multicast domain tree for providing structured science, transportation and/or engineering application services, a presentation layer 540 comprising private edge router operable for providing coding to structured science, transportation and/or engineering data, a session layer 550 comprising at least one module operatively configured with at least one interface module 170 operable for broadcasting/channeling at least a single communication signal configured for delivering structured science, transportation and/or engineering data to at least an end client, a network layer 570 comprising at least a call signal transmission processing module operable for providing structured science, transportation and/or engineering topics of information via at least an Internet protocol 370, and a transport layer 560 comprising apparatus operable for providing structured science, transportation and/or engineering topics of information for communication between at least a computer apparatus 430 and at least a gateway/default gateway 432. Certain embodiments provide the communication apparatus 400 further comprising apparatus for updating connectivity and/or for providing structured science, transportation and/or engineering technical support.

In one embodiment, the network interface module 170 functions at a low level of abstraction to control or respond to I/O devices of the wireless communication device 30 as directed by the client interface module 172, in communication with the central processing unit 51. The network interface module 170 may receive client input, such as an input signal resulting from a client using communication apparatus 400, browser 040, or keyboards 11. The network interface module 170 is further configured to convert input to an appropriate signal that may be interpreted by the client interface module 172. The network interface module 170 may also receive signals from the client interface module 172 that specify a particular decision to be rendered on the screen 003, and may generate appropriate signals to effectuate the desired science, transportation, and engineering topics decision being displayed.

### The Search Engine

The search engine platform is a very important tool for bringing to light fashion trend relationship with consumers so that casual awareness and community cultural awareness would be easily empowered to impact all generations. The platform is a genuine interactive tool for centralizing fashion communications environment, bringing speed and communication efficiency to better social interactions between designers, and fashion outlets, bringing brands, styles, fashions, and fashion trend to clients and users of the network. The search engine platform would support THE FASHION WORLD MEDIA as a contemporary platform to accelerate connections with people of all demographics. THE FASHION WORLD MEDIA has already been launch to bring the cosmic powers of social media to the community through fashion expression and trend predictions to the fashion world. A visualization of the search engine platform could be seen as an important tool for creating direct links between data expressions and some graphic/image expression of facts that may be linked together to convert the intended expressions into fashionable output for visually processing 0f the outward facts. Additionally, consumers residing in different parts of the world would appeal to accelerated demographic reach to join such a unique market share environment and capture fashion power trend through a prioritized spending on model-related products, including beauty services. Fashion businesses and fashion outlets would be able to accelerate the supply of up-to-date fashion styles and brands to their local and worldwide customers through the powers of the centralized social media network environment and the opportunities that the search engine platform and the fashion world media brings.

In another embodiment, the network interface module 170 may assume a larger role and work concurrently with the client interface module 172 for sharing data relating to science, engineering, and transportation topics of information. In yet another embodiment, the client interface module 172 may be merged with the network interface module 170 through a common network 20, including the Internet 370. Disclosed embodiments further provide a central communication vehicle comprising Internet search engine 402 being provided for communications with personal communicators, wireless communication devices, lap tops, media devices, gaming devices, television set apparatus, desk tops, and mobile deices. Certain embodiments provide the wireless communication device 30 being implemented as part of a personal computer device. Some embodiments provide the application layer 530 being configured with keyboard 11 and/or voice auditory applications. Some embodiments provide servers 00 and 000 further comprising wired and/or wireless communication device and/or a remote server. Disclosed embodiments further provide the client interface module 172 further comprising mobile devices. Certain embodiments provide the network interface module 170 being configured to create, select, arrange, and administer to the screen the topics of information in collaboration with the client interface module 172, comprising sharing of tasks to render results relating to searches for science, engineering, and transportation topics of information. Each search result corresponding to science, engineering, and transportation topics may be translated to electronic documents such as web page, advertisement responsive to the queried relevant to science, engineering, and transportation topics of information.

Disclosed embodiments provide the communication apparatus 400 comprising a browser 040 configured with variety of different algorithms for choosing a candidate key group of science, engineering, and transportation topics. In one embodiment, the server keeps track of the science, engineering, and transportation topics associated with each individual key group that is being managed. Certain embodiments provide counters and/or monitors comprising a display 003 being operable for independently tracking the application activity in each of the key groups. Some embodiments provide the servers 00 and 000 operable for selecting the key group that is contributing the maximum science, engineering, and transportation topics load. The communication apparatus 400 is further configured to provide client interface 170 for a mobile device 30. The communication apparatus 400 further includes a cellular telephone 30 for communicating between the servers 00 and 000 and client 120. The client 120 further comprises a PDA, a personal computer, and a personal communication device. Certain embodiments provide a display screen that can be programmed to display any appropriate information to client 120, in communication with the communication apparatus 400. Some embodiments provide the communication apparatus 400 operable for displaying information related to Internet 370 searching application that consist of science, engineering, and transportation topics of information. Certain embodiments provide a support system 210 comprising a social platform 420. The social platform 420 is configured with a search button for searching science, engineering, and transportation topics. Some embodiments provide the social platform 420 comprising a social network for sharing knowledge and for searching science, engineering, and transportation topics of information. At least a search engine 402 is provided for searching science, engineering, and transportation topics. The search engine 402 may be communicatively connected to at least a cellular tower. The query keys comprise data entry keys used to enter information such as alphanumeric characters, and may take the form of a standard telephone keypad. Disclosed embodiments further provide the communication apparatus 400 configured for alphanumeric information and voice recognition operation.

The communication apparatus 400 further comprises data processing system comprising a central processor 51, servers 00 and 000, and a network 20. The client 120 is connected to the data processing system through the servers 00 and 000 each coupled to the network 20. The client 120 may communicate wirelessly with the network 20, such as over a cellular telephone network. The network 20 further comprises a local area network (LAN) or a wide area network (WAN), including the Internet 370. The servers 00 and 000 may include content servers that store collections of documents such as web pages, advertisement servers, and science, engineering, and transportation services such as, text-only ads, image ads, graphical ads, audio clips, and video ads clips. The services may include e-mail servers that provide email functionality to client devices 120 and embedded information, including machine-executable code or links to other documents. The servers 00 and 000 may store electronic content in electronic documents written in EHTML (Extensible Hypertext Markup Language), HTML (Hypertext Markup Language), WML (Wireless Markup Language), CHTML (compact HTML), or in any other appropriate format. The data processing system may take any applicable form and may receive information requests from client 120. Disclosed embodiments provide the data processing system configured for locating suitable information corresponding to a query request. Certain embodiments provide the data processing system operable for formatting the information received for presentation on the display 003, and may convey the formatted information to the client 120. The data processing system further comprises interactive interface module 172 operable to permit communications in a variety of ways. Some embodiments provide the data processing system in communication with the servers 00 and 000 over the network 20. In the disclosure, embodiments provide the data processing system further operable to access and process electronic content that is stored on the servers 00 and 000. The data processing system is further configured for communications with the client 120 via the network 20, including the cellular phone network or a combination of networks. A report generator 134 may receive and process a request from the client 120, such as a network search request. The network search request may include one or more search query terms entered by a client 120 in search input device 80.

A search engine 402 may then receive the search request from the report generator 134, and may search a searchable indexer 108 for electronic content appropriate for, or corresponding to, the search request. The indexer 108 may include an index database 130 in communication with a cache engine 350 in communication with a cached information database. The index database 130 may contain data representing searchable information available to the CPU 51. The CPU 51 may scan the Internet 370 or various intranets for content science, engineering, and transportation topics, web sites, workgroup discussions, technical books, electronic books, etc. The CPU 51 may extract key words, phrases, or other objects from the content, and may organize the information in the index database 130, or partition the database 130 in a manner that allows ready searching. Disclosed embodiments further provide an environment for sharing science and engineering topics of information to change the way knowledge is derived about an object, a business, a corporation, an institution, an educational institution, a testimony, a Pastor, an art, an event, a project, a play, a book, a culture, a Bishop, a struggle, a success, the society and its environment. Social measurements would lead to generational awareness, brand awareness, leadership awareness, business awareness, corporate awareness, educational awareness, professional awareness, ethical awareness, religious awareness, institutional awareness, social awareness, cultural awareness, sociological awareness, professional awareness, causal awareness, and service efficiency to the society relating to the positivism in fashion media, model media, and dress code media. Individuals, businesses, corporations, religious groups, cultural groups, and community organizations/associations must have the freedom to choose how to improve their product life in the context of fashion media, model media, and dress code media. Just as true prophecy never comes by the will of man, but from God through the Holy Spirit to bring Lamb upon our feet and Light upon our paths, so must the positivism of good products/objects be lightened to bring out the truth by modeling the products/objects to create a clear path for knowledge and economic growth.

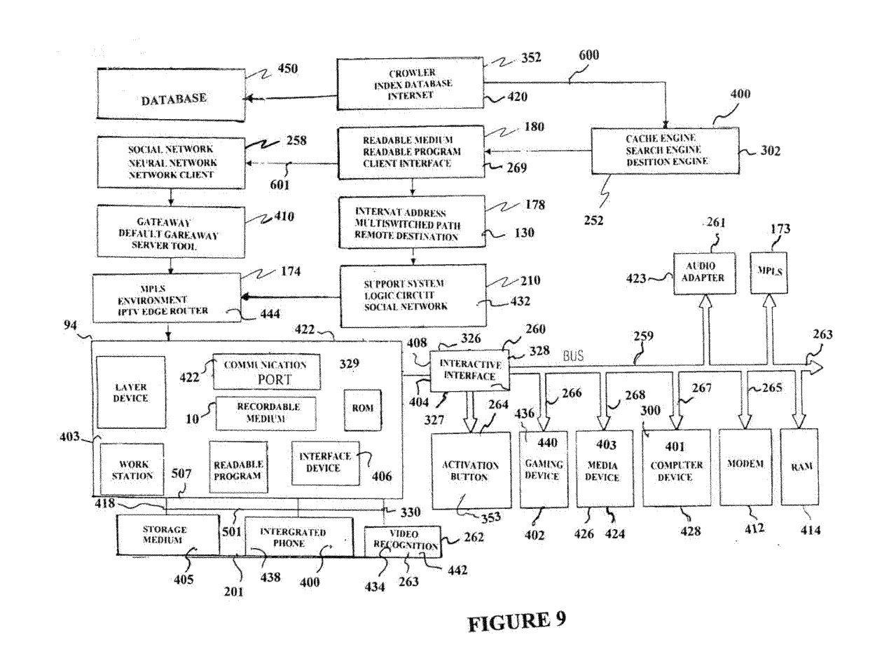

Referring to FIG. 9 is seen an exemplary embodiment of the communication apparatus. The communication apparatus 400 comprises at least an input device 252, including a keyboard 254. The keyboard 254 may consist of a virtual keyboard 255 and/or QWERTY keyboard 256 in further communication with a random number generator 248. At least a social network application 258 is configured with the keyboard and in communication with the processor 420. Disclosed embodiments further provide the keyboard being disposed on an LCD display screen 260 being configured with sensors 327 operable for object recognition. Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265 and camera 263. Disclosed embodiments further provide the communication apparatus further comprising at least one of: a mobile communication device 400, a gaming device 402, a media device 403, and an interface device 404. Disclosed embodiments provide the interface device comprising at least an integrated phone/PDA 400 being configured with integrated connectivity apparatus 406 operable to provide global roaming. At least a communication port 422 is provided with the communication apparatus 400. Certain embodiments of the disclosure provide the communication apparatus comprising a GSM phone 400 being operable on plurality microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video, and phone book.

In one embodiment, the present invention includes a user interface for a media management application comprising: a media management application environment comprising: a first platform in which is displayed user selectable postage, each representing a source from which media files may be accessed, wherein one of the postage represents a media file source comprising science topics of information, an instant messaging platform, and wherein a user selecting the messaging platform postage causes a list of postage representing selected messaging to users that the user desires to communicate with to be displayed on at least a display device; and a second platform in which is displayed, in response to the user selecting one of the messaging user postage associating with a selected messaging to users, information associated with media files found in a media box of the selected messaging to users. In one embodiment, the present invention includes a computer readable medium comprising software code for generating a user interface for a media management application, the code configured to implement on one or more processor functions comprising: generating a media management application environment; displaying in the environment, a first platform comprising a list of user selectable postage, each representing a source from which media files may be accessed, wherein one of the postage represents a media file information source comprising at least one of: science topics of information, engineering topics of information, transportable data comprising transportation topics of information, an instant messaging platform; displaying in the environment, in response to a user selecting the messaging platform postage, a list of postage representing selected messaging to plurality users that the user communicates with; and displaying in the environment, in response to the user selecting one of the messaging user postage associated with a selected messaging to users, a second platform comprising information associated with media files found in a media box of the selected messaging to users.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still, other embodiments provide a communication apparatus comprising of carbon fiber 408 and/or silicon substrate microfiber consisting of resistive touch screen 260 and/or character recognition 269 and/or a communication board 300. Certain embodiments provide housing 301 for the communication apparatus 400 comprising a carbon fiber 408 and/or a silicon microfiber. Disclosed embodiments further provide a communication apparatus being configured with at least a WAP browser 410 and/or an integrated GPS device 412 and/or an MP3 music device 414 and/or a camera apparatus 416 and/or an internal antenna apparatus 418 being configured with a controller 421 in communication with a predictive text messaging applications 423. Certain embodiments provide the communication apparatus 400 being configured with at least one of: infrared sensor 326, calendar 268, FM radio 424, Bluetooth technology 426, and GPRS Internet services 428. Disclosed embodiments further provide the communication apparatus 400 comprising a video poker machine 430 and/or a slot machine 432, and/or a handheld device 434 and/or a gaming device 436 and/or a play station 438 in communication with communication port 422.

Some embodiments provide the cache engine 350 further comprising at least a data structure pointer generator circuit 352 operable for generating information that correspond to at least a matching trigger pattern being communicable for providing at least communication patterns for science, transportation and/or engineering topics, comprising at least a structured science, transportation and/or engineering expressions. At least one science, transportation, and/or engineering expression is configured with computable functions. At least one communication patterns further comprises at least one of; a context free grammar, at least a text expression comprising at least a make and/or at least a model of a transportation vehicle, at least a text expression comprising of at least a desired science, transportation and/or engineering topics, and at least a text expression comprising at least a science, transportation and/or engineering topics of information. The communication apparatus 400 is further configured for verifying if additional science, transportation and/or engineering topics of information matches a predetermined number of pattern, wherein the predetermined number of pattern is greater than at least 1, and wherein the additional topics is rejected if it does not match the predetermined number of pattern by at least once. Disclosed embodiments further provide the communication apparatus 400 comprising at least one coordinated set of programs each functionally structured for communications with the computer readable medium 440 operable for delivering science, transportation and engineering topics through at least a broadcast channel comprising Internet Protocol Television edge routers 370 being further operable for providing continuous distribution of science, transportation and/or engineering knowledge and/or for providing national security applications.

Certain embodiments provide the communication apparatus further comprising at least one cache memory 354 being operatively configured with at least one computer readable program 434. Some embodiments provide the cache memory 354 comprising a computer code consisting of science, transportation and/or engineering topics of information. Some embodiments provide the communication apparatus 400 comprising a communication engine 402 configured with each cache memory 354 and responsive to queries. The queries comprise of at least one of: science and engineering topics, a transportation and/or engineering vendor: a transportation and/or engineering provider, a person, a transportation and/or engineering company, a transportation make, a transportation model, a motor carrier contents, at least an educational institution program and/or curriculum, at least an engineering network, at least a support system comprising a social platform for communicating science, engineering, and transportation topics, and at least a network client location. In one embodiment, the present invention includes a computer readable medium comprising software code for generating a user interface for a media management application, the code configured to implement on one or more processor functions comprising: generating a media management application environment; displaying in the environment, a first platform comprising a list of user selectable postage, each representing a source from which media files may be accessed, wherein one of the postage represents a media file information source comprising at least one of: science topics of information, engineering topics of information, transportable data comprising transportation topics of information, an instant messaging platform; displaying in the environment, in response to a user selecting the messaging platform postage, a list of postage representing selected messaging to plurality users that the user communicates with; and displaying in the environment, in response to the user selecting one of the messaging user postage associated with a selected messaging to users, a second platform comprising information associated with media files found in a media box of the selected messaging to users.

At least one coordinated set of programs further comprise an electronic commence “e-commence.” The e-commence is required as the revenue platform for the network operation. The electronic commerce is the sales aspect of FMDC e-business and further consists of the environment for the exchange of data to facilitate financing and payment aspects of business transactions. The e-commence features include the following:

The ability to buy and sell advertised products or services in FMDC network over electronic systems, such as the internet. The ability to use payment systems that includes domestic and international payment methods, including electronic funds transfer, supply chain management, Internet marketing, online transaction processing, electronic data interchange (EDI), inventory management systems, and automated data collection systems. The electronic data interchange (EDI) further comprises at least one of: business-to-business exchange of data; business-to-business buying and selling; group buying, means for providing security for business transactions; means for exchanging data among parties that know each other well; means for arranging data among parties; means for one-to-one (or point-to-point) connection; means to facilitate business transaction and fund transfer electronically.

Business transactions further include advertiser's e-tailing or virtual storefront connection, connecting the advertisers VPN on FMDC network to the web sites of advertising company. E-tailing further comprises a virtual storefront on FMDC Web sites operable as a virtual mall; online catalogs; news groups; teleconferencing; and shopping card, providing an environment for a person to checkout and share with friends within FMDC network. E-tailing further comprises a place for direct retail shopping that may be accessed 24-hour availability for global reach, including business-to-consumer online shopping and business-to-business online shopping environment, an enterprise content management, online shopping and order tracking, further providing an environment for users to interact and provide custom and ordering information through multimedia prospects.

Enterprise content management further comprises means for simplifying storage capabilities, security, version control, process routing, and retention so that better business value could be delivered. Group buying further comprises a collective buying process that offers products and services at significantly reduced prices on the condition that a minimum number of buyers would make the purchase with the deal kicking in once a set number of people agree to buy the product or service. Embodiments further provide instant messaging includes the ability to use behavioral targeting to select and add other users.

Newsgroup is a special messaging system posted from users within FMDC network. Newsgroups are technically distinct from, but functionally similar to discussion forum on the world-wide-web. Teleconferencing further comprises means for allowing users to rank programs or models in the fashion/media environment by voting for it. The more votes a fashion/model gets, the higher the fashion/model moves up the page. Teleconferencing further comprises a fashion poll, a model poll, a dress-code poll, an event poll, a show poll. Teleconferencing further comprises means for providing virtual educations. Disclosed embodiments further comprising media for e-learning environment to implement learning processes, out of classroom learning, course management, technology enhanced learning, web-based learning, and corporate learning environment. These e-learning are enabled in the form of text, image, animation, video streaming, and audio.

Disclosed embodiments further provide a communication apparatus configured for categorizing science, transportation and/or engineering files referenced by initial search results. The communication apparatus further comprising at least a data modeling tool 100 responsive to categorization. Certain embodiments provide the data modeling tool 100 configured for manipulating icons within at least a graphic interface module 170 being executable on at least a structured science, transportation and/or engineering network infrastructure. Some embodiments provide a neural network 220 configured with the data modeling tool 100 and operable for deleting and/or updating at least a structured science, transportation and/or engineering database. At least one data modeling tool is communicatively connected to at least one array operable for Web browsing. At least one neural network 220 further configured with a decision engine 123 responsive to science, transportation and/or engineering topics of information. Disclosed embodiments provide the neural network 220 further configured with at least one cache engine 350, further responsive to at least a downloadable science, transportation and/or engineering context. Certain embodiments provide the computer readable program 434 in communication with the neutral networks 220. The at least one computer readable program 434 further comprising at least a software 300 operable with computer instructions programmed for at least one of: delivering broadcast channel through Internet Protocol Television edge routers, using multicast virtual private networks for at least a broadcast channels, applying at least a multicast label switching protocol to at least one virtual private networks, sharing the same multicast state and providing at least one broadcast channels in communication with each virtual private networks, training each neural network 220 for adjusting at least a correlation of science, engineering, and transportation topics as a function of at least an activity consisting of at least a topic and/or a product of science, transportation and/or engineering content.

### Centralized Social Media Network

The search engine platform may also be visualized as a centralized social media network environment and marketing environment configured for sharing fashion topics of information. The search engine platform would also complement THE FASHION WORLD MEDIA as part of the social media network that allows companies in the fashion industry to capture large audience through the presentation of different brands, trends, styles and the abstraction of reality from all fashion presentations. Specifically, the search engine platform would adopt the fashion Industries to a social media community as a sustainable centralized fashion marketing platform to reach their customers worldwide to accelerate online brand passion, increase fashion passion, and also increase the level and quality of online brand postings and customer loyalty. The search engine platform is a network tool for providing substance of things hoped for, and for revealing the evidence of things not commonly seen to bring fashion cultural change.

The communication apparatus 400 further comprises a computer apparatus 430 comprising a search engine 402 communicatively connected to at least one remote communication apparatus operatively configured with at least one support system 210. At least one neural network 220 in communication with the search engine 402 and operable for providing services relating to science, transportation and/or engineering in a social network platform 102. The social network platform is operable on at least a social platform 420 comprising at least a button configured for providing a social network environment for at least one of: educational institutions, transportation companies and/or agencies, and science/engineering institutions and/or companies in association with each other. At least one support system 210 comprises at least one social platform 573 being provided for connecting science and engineering students and/or engineering professionals via a centralized network environment such as the Internet. Disclosed embodiments further provide the support system 210 operatively configured for project postings responsive to university courses for science and engineering students and/or responsive to jobs and/or project postings from at least an engineering company and/or science/engineering professional environment. The science and engineering professional environment further comprises an environment for students and/or engineering professionals to socially/educationally be engaged in research projects in association with at least one of plurality universities and/or remote location, whereby at least a centralized communication is provided through the support system 210. The support system 210 is operatively configured for science, engineering, and transportation social network, and further comprises at least a chat function 104 responsive to at least the social communication environment 106.

Disclosed embodiments provide centralized transportation vehicle in communication with computer devices operable to receive specific science, engineering, and transportation topics, services and/or functions. Certain embodiments are directed towards a distributed server-based application model comprising varying set of server applications configured for individual client application for communications with client devices being communicatively connected to the communication apparatus to receive and/or share science, engineering, and transportation data over a conventional communications infrastructure such as the web. Embodiments provide the communication apparatus comprising servers communicatively configured to provide one or more computer-related services relating to science, engineering, and transportation topics of information. The increasing use of the Internet has become popular for distributing computational data, and the processes involved has made the Internet a commonplace for data distribution since it allows computational burden to be shared across multiple servers and prevents catastrophic single-point failures. Disclosed embodiments provide a mechanism for distributing science, engineering, and transportation topics and knowledge using protocol to negotiate with database servers containing the science, engineering, and transportation topics of information.

The communication apparatus 400 further comprises applications being characterized by rapidly varying changing components of a database server 121 comprising topics of information warehouse. Disclosed embodiments further provide the database server 121 comprising components of the science, engineering, and transportation content being stored, and logically configured for predictions of the client query or loads. The interactive device further comprising at least a data bus 200 comprising a platform for writing input into at least a data memory for at least one array to enable enhancement of continued proliferation of powerful and suitable science, engineering, and transportation topics operation. Certain embodiments provide the interactive device configured for allowing computational devices to talk to each other through the use of networks connections. The computational devices include computers and other portable devices such as wireless telephones, mega telecommunication, personal digital assistants, and automobile-based computers, electronic devices, and portable devices. The networks connecting computational devices for the instant invention include wireless and wired networks which are formed using land lines such as copper wire or fiber optic cable, and wireless networks which employ earth and/or satellite-based wireless transmission links and a combination of wired and wireless network portions. These networks are organized using a client/server architecture 110 in which server computational devices manage science, engineering, and transportation operational resources such as preventive maintenance files, solutions to failed transportation component, fuel consumption per vehicle in a fleet, computational transportation devices processing power which could be requested by client computational devices such as clients of the network. In this regard, other computational devices not operated directly by an end client such as at least proxy servers, which act on behalf of other machines, could represent either clients or servers. Disclosed embodiments provide a computer apparatus 430 comprising techniques for extracting science, engineering, and transportation topics of information through search patterns from a database such as the Web.

Certain embodiments provide the techniques comprising one or more topics of information that act as the initial seed for the search. Some embodiments provide the database or databases comprising a searchable medium for occurrences of the topics of information. Other embodiments provide the technique comprising of patterns being identified in the array in which they are stored. These patterns are used to extract more topics from the database and the process can be repeated for new topics. Information can be extracted from a database efficiently and accurately with little or no human interaction. Disclosed embodiments further provide a computer implemented method of extracting information from a database. Certain embodiments provide the database being searched for occurrences of at least one topic of information. Some embodiments provide the occurrence of topics of information comprises the information that was found, is being analyzed to identify a pattern in which similar topic of information was stored. Other embodiments provide the topics of information being extracted from the database utilizing the pattern. In some embodiments, the process is repeated until a predetermined number of topics are found or until no new patterns are identified.

Disclosed embodiments provide a computer implemented method of extracting science, engineering, and transportation topics of information from a database. The database is searched for occurrences of topics of information. Occurrences of the topics of information that were found are analyzed to identify a pattern in which the topics of information were stored. Certain embodiments provide the pattern comprising prefix text, a middle text and suffix text, where the prefix text precedes desired information in the science, engineering, and transportation topics of information and the middle text is between desired information in the topics of information and the suffix text follows desired information in the topics of information. Additional topics of information are extracted from the database utilizing the pattern and the process is repeated for additional topics of information. The terminal 022 connected between clients 120 and distributed for communications with servers 00 and 000 through a location-based distributed system. Servers 00 and 000 are configured with key to encode a particular location in a hierarchical grid comprising science, engineering, and transportation topics. The topics are distributed among the constituent database servers on the basis of the location regions that each server manages.

The database servers are partitioned for science, engineering, and transportation topics for communications among the constituent servers. Each server is configured to mange different science, engineering, and transportation topics partitions for distribution efficiency. At least larger clusters are broken down into smaller clusters comprising smaller key groups of science, engineering, and transportation topics of information for logical representation of splitting process through binary tree. Disclosed embodiments further provide the servers 00 and 000 configured for receiving a topic request specifying a particular key group combination that determines if a query should be processed. Certain embodiments provide logical steps needed to respond to the query in case the server 00 and 000 determines that the key group combination is incorrect, or that the query should be communicated to an alternate server. The communication apparatus 400 is disposed for detailing the steps a client is seeking to determine the appropriate server for a particular key group.

The communication apparatus 400 is further configured for adaptive load distribution technique based on the representation of science, engineering, and transportation topics with distributed hash table. The document management tool further comprising information processing apparatus communicatively connected to the memory device 59 for storing digital broadcast content of the reference document for which a number of copies can be made, and include a writing device for writing the content on external recording medium, in communication with an IC medium reader/writer for reading an IC medium and recording the number of copies that can be made of the content on the IC medium in association with the document identifier. The communication apparatus 400 is further configured for determining whether an identifier of the content is recorded on the IC medium when the content is copied to the external recording medium and, when it is determined that the identifier is recorded, the hash table controls the writing device to write the content on external recording medium and to update the number of copies that can be made of the content and a hash value is recorded in the memory. In the disclosed embodiments, key groups of science, engineering, and transportation topics are associated with a variable depth of topics of information based on virtual network. The network is provided for directing identifiers containing queried science, engineering, and transportation topics to a particular key group server comprising target servers 00 and 000. The servers 00 and 000 are distributive operable to exchange local signaling messages to determine the particular topics of information that is being queried in relation to science, engineering, and transportation topics.

Disclosed embodiments provide servers 00 and 000 comprising a child server configured for exchanging load information from a communication apparatus 400 operable for managing an active key group of science, engineering, and transportation topics. Certain embodiments provide a parent server 00 and 000 comprising a communication apparatus 400 operable to split larger key groups of science, engineering, and transportation topics into smaller clusters. Some embodiments provide the parent server 00 and 000 comprising a communication apparatus configured for instructing the child servers for communications with clients 120 and the parent server. It is contemplated that the mapping of science, engineering, and transportation topics include partitions responsive to query keys in accordance with disclosed embodiments. Science, engineering, and transportation topics partitioning are represented by the allocation of variable-sized key groups to individual servers 00 and 000. The affinity analyzer 122 could represent an encoding of one or more application-specific science, engineering, and transportation attributes, on the basis of which the science, engineering, and transportation topics is partitioned. It is further contemplated that affinity analyzer 122 could represent an arbitrary mapping that has a relation to any semantically relevant science, engineering, and transportation attributes. Disclosed embodiments may be applied to any form of encoding relating to science, engineering, and transportation topics for communications with the affinity analyzer 122. Disclosed embodiments further provide optional data analyzer 122A configured for operation with computer language consisting of binary keys. Certain embodiments provide the binary keys comprising the smallest unit of application of science, engineering, and transportation topics to be presented for distributions.

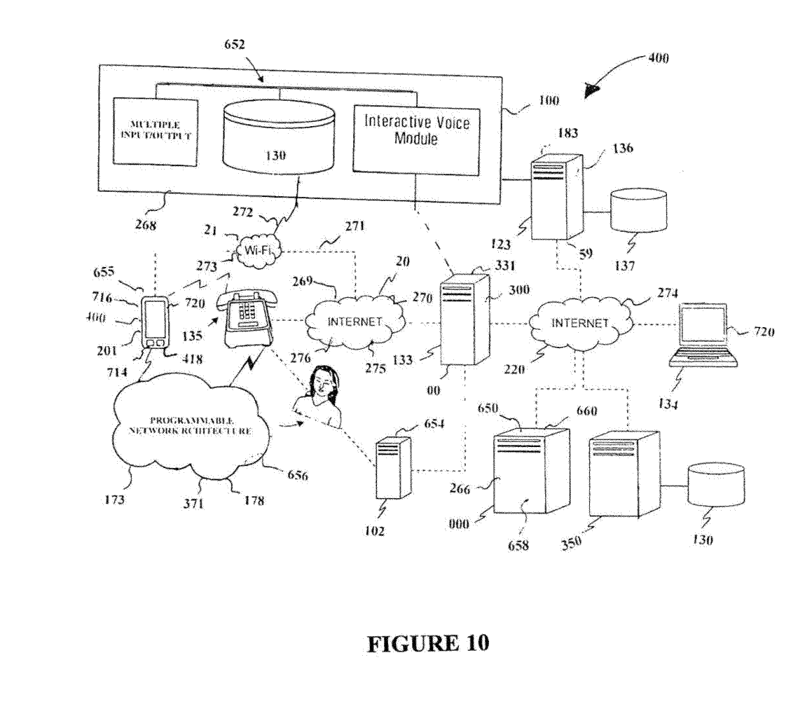

Referring to FIG. 10, is seen the communication apparatus 400 further configured for optimizing and for sharing science, engineering, and transportation topics of information. Certain embodiments provide the communication apparatus 400 comprising at least a cache engine 350 operatively configured with at least one array 182, 184, and 186. The cache engine 350 further comprises at least a markup language configured with at least one array 182, 184, and 186 for entering searchable science, engineering, and transportation topics of information. Some embodiments provide the computer apparatus 430 further comprising a spider 173, a crawler 174, each configured for disseminating science, engineering, and transportation topics of information. Disclosed embodiments further provide a web configured for disseminating science, transportation and/or engineering topics of information. Certain embodiments provide the centralized transportation search vehicle further comprising a structured science, transportation and engineering network environment communicatively connected to at least one support system 210. The support system 210 is further configured with at least the indexer 108 and/or a catalog 201 comprising science, transportation and/or engineering data. Some embodiments provide the data further includes at least one of; parts purchasing, science and engineering assignments, science and engineering research environment, standard maintenance solution, preventive maintenance scheduling, preventive maintenance forms, fuel consumption log, mileage log, solutions to failed components, equipment sales, parts graphics, marketing, name search, sounds, text, video, engineering and/or science topics of information, engineering materials and/or tools, and at least an advertisement.

Disclosed embodiments further provide a centralized transportation vehicle comprising a search engine system 402 that includes entity extractor 112, a categorizer 114, and a query generator 116 for managing and sharing science, engineering, and transportation activities such that when a topic on science, engineering, and transportation information is queried, responses are retrieved to enrich knowledge, transportation preventive maintenance scheduling, generating solution to queried transportation component failure, extracting names of terrorist desiring a rental car, and analyzing failed transportation component through a centralized database server 121. The search engine system 402 further comprises a communication apparatus comprising at least a hardware device 04. Some embodiments provide the hardware device 04 comprising at least one dedicated processing elements 118 configured with at least an input array 182, at least an output array 184, and/or at least a query array 186. Certain embodiments provide the entity extractor 112 configured to identify a set of entities as described in the engineering. Science and transportation topic of information through selected files, forms, or document content for enabling searching the information related thereto using an information retrieval system 185. Disclosed embodiments further provide the categorizer 114 operable to define an organized classification of the science, engineering, and transportation files, forms, or document content with each class in the organization of component content having associated therewith a classification label 187. In the disclosure, the classification label 187 corresponds to a category of topics of science, engineering, and transportation information in the information retrieval system 185.

The categorizer 114 is further configured to assign the selected science, engineering, and transportation files, forms, or document content a classification label 187 from the organized classification of science, engineering, and transportation component content. Certain embodiments provide the query generator 116 being operatively configured to automatically formulate a query that restricts a search for science, engineering, and transportation topics of information. The search could be restricted at the information retrieval system for the particular information concerning the set of entities to the category of science, engineering, and transportation topics of information in the information retrieval system 185 being identified by the assigned classification label 187. The classification label 187 is configured to enable speedy responses to information from the centralized transportation vehicle. The centralized transportation vehicle is in communication with a computer apparatus 430 comprising at least a database 340 consisting of at least information for science, engineering, and transportation topics.

Disclosed embodiments further relates to science and engineering topics management and sharing of science, engineering, and transportation topics of information through networks of computational devices, and more particularly to database system 340 operable for generating request of science, engineering and transportation information, providing at least one topic of information as an example of information associated with at least a terrorist name in a local existing system 432 desiring a rental car, engineering topics, and transportation topics, and retrieving responses in association with the name, the engineering topics, and the transportation topics of information such that enhancement of identification of relevant topics of information relating to the terrorist person 434 is made accessible using such the network 20. The network 20 is further utilized for repeating the searching and analyzing and extracting data for additional topics of information that is desired in association with the terrorist person 434. The desired topics of information is further provided for tracking the last rental company and/or transportation information by the named terrorist person 434 within the centralized communication system 400. Certain embodiments provide the centralized transportation communication vehicle 400 further comprising Standard Transportation Engineering Social Network “STESN.”

Disclosed embodiments further provide the centralized transportation vehicle comprising interactive interface device 170 communicatively connected to at least the computer apparatus 430. The interactive interface device 170 further comprises at least a data bus 200 comprising a platform for writing input into at least a data memory 440 for at least an array 182, 184, and 186 to enable enhancement of continued proliferation of powerful and suitable science, engineering, and transportation topics operation. Certain embodiments provide the interactive device 170 configured for allowing computational devices to talk to each other through the use of networks connections 131. Some embodiments provide the communication apparatus 400 comprising computational devices, including computers and other portable devices such as wireless telephones, mega telecommunication, personal digital assistants, and automobile-based computers, electronic devices, and portable devices. The networks connecting computational devices for disclosed embodiments include wireless and wired networks which are formed using land lines such as copper wire or fiber optic cable, and wireless networks which employ earth and/or satellite-based wireless transmission links and a combination of wired and wireless network portions 20 and 21. These networks are organized using a client/server architecture in which server computational devices manage science, engineering, and transportation operational resources such as science topics, engineering topics, preventive maintenance files, solutions to failed transportation component, fuel consumption per vehicle in a fleet, computational transportation devices processing power which could be requested by client computational devices such as clients of the network. That is, other computational devices not operated directly by an end client such as at least proxy servers, which act on behalf of other machines, could represent either clients or servers.

The centralized transportation communication vehicle comprising a platform for advancing science, transportation and engineering knowledge, includes social network for enabling, scientist, engineers, and transportation industries, garages, transportation maintenance fleet, government agencies, police department, fire department, Homeland security department to talk to each other seamlessly in real time through the centralized system. Certain embodiments provide the search engine 402 configured for extracting science, engineering, and transportation topics of information from a centralized transportation database having information relating to science topics, engineering topics, and different makes and models of transport vehicles. Some embodiments provide the search engine comprising a computer apparatus 430 configured for enabling communication with different systems and responsive to different platforms. Other embodiments provide the communication apparatus 400 operable for enabling Internet and web-based searches for topics of information relating specifically to science engineering topics and any make and model of transportation equipment, including identifying preventive maintenance and repair patterns of a particular equipment in which the topics were stored so that additional topics can be extracted from the database 340 for social network, knowledge sharing, and for aiding file sharing within various science/engineering companies, transportation companies, and for mining terrorist data within the centralized transportation database 340. The disclosure further provide neural network 220 that integrates seamlessly with all existing science and engineering industries, and transportation industries, including car rental companies and all garages in the nation and around the world through their local existing systems 432 and enabling these local existing systems to talk to each other and communicate better in real time interaction, real responsive, real resourceful and real responsible to transportation system analysis, preventive maintenance scheduling and reprogramming, and monitoring of a terrorist person's activities through at least a name search

STESN further comprised of science and engineering social network and web-service application consisting of virtual science, engineering, and transportation business analytical tool 08. The tool includes portfolio for science, engineering, and transportation company's preventive maintenance programs and further comprises of online market place for transportation parts and research distributions. Engineering professionals will utilize this network to assign research projects, assist on projects, and post jobs. Skillful use of STESN would bring in businesses equal to million times the cost. Commercial motor carriers need the service of STESN. STESN website comprises of virtual science, engineering, and transportation businesses. The web plan includes search engine comprising of computers, devices, communication apparatus, and browsers. The system is configured with a support system 210 for engineering social network, making it easier for people to meet for personal science and engineering topics benefits. Disclosed embodiments provide the support system 210 communicatively connected to computer devices. The computer devices are operatively configured with communication apparatus, which include Internet 370 and gateway 433. The communication apparatus is communicatively connected to an interface comprising network I/O 252. Software 300, comprising an operating system is configured with the communication apparatus. The computer devices further comprises database comprising science, engineering, and transportation topics of information. The browser 040 is communicatively connected to the operating system, which is communicatively connected to the network I/O 252 which connects to the gateway 433.

Certain embodiments provide a cache engine 350 communicatively connected to the communication apparatus 400. Some embodiments provide the cache engine comprising a query engine 142 in association with a makeup language for searching science and engineering topics of information. The query engine further comprises apparatus for searching and/or entering science, engineering, and transportation topics of information. The spider 173 and a crawler 174 are further provided for disseminating the topics of information. The support system 210 is configured for social network and further comprises structured functions, including chat functions 104. The computer device further comprises server 00 and 000 configured with the software 300 for enabling a server tool to communicate with other electronic devices through the Internet 370. Certain embodiments provide application tool 130 operable for permitting a client to access the database 340. Some embodiments provide a model layer 532 operable for enabling network communications, and a presentation layer 540 for coding data. Science, engineering, and transportation files are requested from server computers 00 and 000 or “web servers 24”.

The transmission of the files over the web comprises additional Internet protocol 371 called hypertext transfer protocol (HTTP). Disclosed embodiments provide the communication apparatus comprising the Internet 370 substantially free of central organization. Certain embodiments provide the server 00 and 000 further configured for hosting web page 25 for the centralized transportation system comprising of science, engineering, and transportation topics. Some embodiments provide the web page 25 being connected to the Internet 370 and the science, engineering, and transportation topics of information being routed by the search engine 402 to the database server 121 for retrieval of information specific to the queried topics of information from the database 340. The centralized transportation system is also configured to enable decentralization of science, engineering, and transportation topics of information and also to allow extremely wide access and an ever-increasing variety science and engineering topics and availability of information relating to various transportation vehicles by identifying and locating specific pieces of information on a specific topic such as vehicle component failure on a particular brand of vehicle that can be extremely difficult to diagnose. Generally, a database system 340 is developed for communication with search engines 402 and other directories operable for routing science, engineering, and transportation topics of information to and from the server 121 containing the database 340 developed to aid clients 120 in finding specific types of information unique to science, engineering, and transportation vehicles. The database system typically contains entry for web page in association with science, engineering, and transportation files, forms, or document. The database 340 is searchable relatively quickly without any intervention or the need to retrieve actual web pages in order to perform a search.

The communication apparatus 400 is further configured with an entry 26 for retrieval of information from the database 340. The entry 26 further includes a network address 27 of the end client page consisting of one or more keywords associated with the page content. The network address 27 may further include a brief summary of the topic of information to be searched. The search engine 402 is further configured to describe any database system to distinguish itself from directory. The search engine would route science, engineering and transportation topics of information from the internet 370 to the database server 121, collecting science, engineering, and transportation topics of information automatically and using programs such as spiders 173, crawler 174, and/or robots 175. The robots 175, spiders 173, and/or crawler 174 are configured to visit web pages 25 and collect the needed data by downloading files 110 in relation to the queried topics of information and also process the file. The centralized transportation vehicle is a process-driven search engine for routing science, engineering, and transportation topics and for managing data relating to science codes, engineering code, and transportation codes and modules. The science, engineering, and transportation management system includes a server repository platform 28 operable for storing science information, engineering information, and also vehicle information. At least one of the information is a plane having components each describing a respective science codes, engineering codes, and mechanical failure codes.

In the disclosure, embodiments provide the communication apparatus comprising easier means for employees of science, engineering, and transportation industries to share files and data resources through a centralized science, engineering, and transportation network system 20 and 21. The shared network will enable communication with every transportation industries, every garage, and all commercial transportation companies, engineering companies, and science companies seamlessly through a resourceful time sharing via shared Internet access. The centralized transportation system further includes server-based network to enable reliability of solutions to local and distanced science, engineering, and transportation industries. The server network 20 and 21 is operable to connect industrial employees through a local social network environment to include topics of information resourceful to their business operations, maintenance programs and preventive maintenance, providing step by step repair procedures for a failed vehicle component. The database 340 is access able through desktop computers, notebooks, wireless devices, and megatel devices from any state in the U.S. and any part of the world. The decision engine 123 is further configured to format a response to a request in a manner usable and readable by client 120. Disclosed embodiments provide the decision engine 123 further operable for converting science, engineering, and transportation topics of information to at least one of: Wireless Application Protocol (WAP) format, HTML document, XML document, Voice XML result, HTML, EHTML, Java, and Java script, including any other format that the client device may be capable of interpreting. Internal communications within the central processing unit “CPU” 51 are disposed with high speed and high bandwidth networks. The CPU 51 is configured for communications with other appropriate protocol operable for permitting the communication apparatus 400 to respond to large number of distinct requests simultaneously, or near simultaneously. Certain embodiments provide the communication apparatus 400 further configured with the CPU 51 and operable for allowing scalability. Some embodiments provide the CPU 51 comprising a split system for allowing scalability. Other embodiments provide the CPU 51 communicatively connected to the communication apparatus 400 for providing operations for network 20 and 21.

Disclosed embodiments provide the wireless communication device 30 further operable for generating requests and for receiving and using information being generated in response to the requests. The wireless communication device 30 is configured to receive and transmit information wirelessly using transmitters 70. The transmitter 70 further comprises output device in communication with a read out tool 08. The read out tool 08 further comprises digital signal processor (DSP) circuitry. Normal voice communication is routed to or from the media device 201 in communication with a speaker/microphone 63. Certain embodiments provide the media device 201 in communication with network interface module 170. Network interface module 170 is further configured to handle all communication with the client, including voice, visual, and data entry communications. Visual presentation of science, engineering, and transportation topics of information may be provided via a display screen 003. General data entry is provided through the keyboard 11 and or voice recognition or by voice data 12. The communication apparatus 400 is further configured with appropriate control keys 13 for performing necessary control functions configured for invoking science, engineering, and transportation topics. Disclosed embodiments provide the control keys 13 comprising push-buttons, joysticks, and touch-sensitive panels. Certain embodiments provide multiple interface modules 172. The wireless communication device 30 is configured with computer network applications, including browsers 040, input devices 80 and output devices 70, such as games, applications to assist in dialing numbers, and applications to permit web browsing, including the entry of data as part of the web browsing. The applications may be stored in ROM 02, RAM 05, EPROM 03, Flash memory 04, MRAM, EEPROM 06, or otherwise, as appropriate, and may also be accessed by the wireless communication device 30. Some embodiments provide a dialing module 108 configured for providing standard dialing functionality and for receiving entered dialing digits or voice dialing instructions in communication with interface module 170. The interface module 170 further comprises a network interface module being further operable for providing audio/visual signals. The network interface module 170 is further configured for communications with output devices 70. The application layer 530 is configured to receive data other than dialing instructions. Disclosed embodiments provide the dialing instructions comprising search data 126 being entered into the search column 21 of the communication apparatus 400 or a wireless communication device 30. The application layer 530 is further configured to provide the entered data to the servers 00 and 000.

The Web context is configured based on queries, such that, when a client submits a query containing science, engineering, and transportation topics of information, the search engine 402 would respond with a list of links pointing to information resource for the web page hosting being derived from matching entries on science, engineering, and transportation topics of information in the database 340. Disclosed embodiments provide the term “link” comprising any representation or symbol representing at least an address that points to the location of an information resource, such as the web page 25. Typically, a link on a Web is a pointer found in one file which references another file. The link on the Web commonly refers to a Uniform Resource Locator (URL) comprising the global address for science engineering, and transportation files, forms, or documents and other resources commonly accessible on the Web. The centralized science, engineering, and transportation network system comprises direct attached storage medium coupled to the server hard drive configured with a network attached storage to consolidate files stored for sharing. The server software 300 is further configured to periodically dump files into a backup server for future use.

Disclosed embodiments provide the server repository platform 28 comprising sets of tools for performing innovative renovation of science, engineering, and transportation component, including analytical breakdown of possible solutions for the topics information. Certain embodiments provide science, engineering, and transformation social network system comprising a process-based interface with science, engineering, and transportation topics of information on the web. The web is access able by end clients and includes a social platform 420 configured for advancing science, engineering and/or transportation knowledge. Some embodiments provide the interface module configured with the support system 210 operable for mapping desired communications using Protocols, Processes, and Plans. Disclosed embodiments further provide the Protocols comprising constructs of stored scripts for invoking a respective scripted tool to execute a particular function. Some embodiments provide Protocols comprising a software module being operable as input parameters for retrieving relevant science, engineering, and transportation information. Other embodiments provide the Protocol comprising apparatus for generating an output parameter of the function invocation specified as variables being supplied at the execution time of the topics. In other disclosure, embodiments provide the search engines 402 in communication with computer applications, including spiders 173 and/or robots 175 configured for indexing the different elements of web sites on the Internet 370 and for gathering content information for database 340. The search engine robot is configured to index significant number of information resources in the Internet 370. The robot is further configured for updating links to the database 340 in a queried dependency manner so that science, engineering, and transportation topics of information are shared effectively.

In a typical searching sequence, communication is established over the network between at least a client and communication apparatus 400. Some embodiments provide the establishment comprising communication environment that includes a web browser program on the client machine. Other embodiments provide a search criteria being entered by a client of the client machine, and being transmitted to the search engine server 402. The search engine server is operable for searching the information available on the network consisting of science, engineering, and transportation topics of information. The client may, for example, access particular web pages that are included in the results directly over network environment as desired by the client. Disclosed embodiments provide processes comprising constructs that store science, engineering, and transportation topics definitions comprising descriptions of particular tasks to be performed. The task to be performed is described using one or more protocols and/or one or more other processes. In the preferred embodiment, the Protocols, Processes, and Plans are each stored as vehicle/engine in the science, engineering, and transportation management system repository for updating connectivity to the database, for updating the range of the assignments when a connection is disabled or enabled, and for processing signal connectivity to updating execution of prescribed functions corresponding to updating functions in response to the operational set mode signals for generating matching solutions to defined science topics, engineering topics, and transportation failed components. This vehicle, which comprises science, engineering, and Centralized transportation System Components, are stored in a manner that is similar to the way in which the Asset components describing the software modules are stored. Furthermore, the associations between Protocols, Processes, and Plans are stored as relationships between the respective centralized transportation vehicles in a manner that is similar to the way relationships between the software modules are represented science, engineering and transportation topics.

In another preferred embodiment, the definition of the Centralized Transportation Vehicle further comprises a centrally driven engine for routing science, engineering, and transportation topics of information to end clients, providing a centralized network system for science and engineering schools-universities-professional environment, and transportation industries. Each of the engines for the Centralized Transportation Vehicle comprises a System Components, as well as the relationships that may exist between the components, being created using a pre-defined element type of the topics information or relationship type definition that is also stored within the repository. In one disclosure, embodiments provide a computer implemented method of extracting and sharing science, engineering, and transportation topics of information from a database. The database is made searchable for occurrences of at least one topic of information. An occurrence of a topic of information that was found is analyzed to identify a pattern in which the topic of information was stored. Additional topics of information are extracted from the database utilizing the pattern. In some embodiments, the process is repeated until a predetermined number of topics are found or until no new patterns are identified. The model definition simplifies the system design and makes operation more robust because the various tools in the system is configured to be synchronized with the element and relationship type definitions instead of having to be aware of special-case and particularized element descriptions. Additionally, modifications to the components can be more readily accomplished because a whole class of element definitions can be modified by making a single change to an element type definition. The type definitions further allows the automated Plan development tool to efficiently query the client for process and other Asset element selections. The collection of search result includes a web file module 401 and a solution address 131 of science, engineering, and transportation topics of information. The web file module 401 includes a web browser that serves as a label for the search results. In this example, the web browser is configured with the web file module 401. Science, engineering, and transportation topics are entered in the web browser and presented to indicate the required query word being search to ensure that results matches the search term that was originally entered by the client when specifying network search parameters. The search engine 402 would search the indexer 108 for instances of science, engineering, and transportation topics identified from the appropriate index entries. The indexer 108 would then provide the client interface module 172 with the relevant information pertaining to the identified entries.

### Fashion Cultural Change

Change would be embraced through trust in fashion media, model media, and dress code media with the hope for sustainable community cultural independence and economic vision. Trust is a very crucial component of fashion marketing and the search engine platform would further provide an environment where fashion industries, fashion outlets, brands, and trends are easily accessible, providing an ideal support system for building and sharing consumers trust and loyalty. The search engine platform would further provide an ideal environment to distinguish between brands and styles in support of social media by offering promotions, perks, and discounts for various fashion models and professional dress codes to impact corporate awareness. The application of the search engine on a social media platform would be an effective support system for brand success and business awareness, sharing community social measurements to bring generational awareness and to improve community cultural interest to impact economic values.

The search engine platform is a support system for revealing CHANGE in the fashion industries to the fashion world so that fashion brands could be embraced for sustainable community cultural and economic independence. In order to maintain customer base, THE FASHION WORLD MEDIA is immersed in the search engine platform as a social media support system for sharing knowledge relating to fashion media, model media, and dress code media.

The fashion world media is providing this platform for the fashion social media community as a sustainable centralized fashion tool to reach worldwide audience to accelerate online brand passion, increase fashion passion, increase the level of online brand postings, and improve customer loyalty. The platform is a network environment that allows individuals and companies in the fashion industries to capture large audience through the presentation of fashion brands, fashion trends, fashion styles and brand awareness through the abstraction of reality to envision future fashion models. Let your positive public declarations bring out social measurements that may lead to generational awareness, brand awareness, leadership awareness, business awareness, corporate awareness, educational awareness, professional awareness, ethical awareness, religious awareness, institutional awareness, social awareness, cultural awareness, sociological awareness, casual awareness, and service efficiency to the society. Fashion isn't defined solely by clothing choices, but it is also conveyed through the way we carry ourselves, our personalities and our views of the world. Fashion comprises of a prevailing styles, customs, dresses, or behaviors, and these may be fashioned and shared to change the way knowledge is derived about an objects.

Further comprising FMDC network consisting of a dynamic database driven social network platform for interactive web content creation, collaboration, and exchange. In this manner, a user is allowed to login, create an account, and upload information. Once the user's information is uploaded, a web page would be created for that user. The user would then be able to distribute or connect with others with whom he/she had exchanged cryptographic public keys with. The connection and/or distribution are allowed within FMDC network environment. The web page creation is the user's virtual private network “VPN” within FMDC network. The user may use the public network such as the Internet or wireless device to connect with other users at remote sites through FMDC network and share or discuss FMDC topics of information. The VPN is to connect users in the network with other users in the network, while providing better features such as:
Security
Reliability
Scalability
Network Management
Policy Management

The architecture of the Social VPN is configured for communication with FMDC centralized infrastructure where users would authenticate, once the account is confirmed, they would then be allowed access to the system and be discovered by their friends whom they have exchanged their cryptographic public keys with. The FMDC network further includes a peer-to-peer overlay used to route messages and to deliver videos between VPN endpoints.

Some embodiments provide user profile; user social links; web based services for users interactions over the internet, including e-mail, instant messaging, online community services, means to connect with friends, and means to connect with present and/or former school mate; career oriented peer-to-peer interactions; user recommendation system linked to trust; a link that allows sharing of information and ideas; be able to share visible profiles with a list of “friends” who are also users of the FMDC; means to generate a profile from answers to questions such as age, location, interests, etc; be able to allow users to upload pictures, add multimedia content or modify/enhance the look and feel of the profile; be able to allow users to post blog entries, search for others with similar interests and compile and share lists of contacts; user profiles dedicated to comments from friends and other users; be able to upload or stream live videos; ability to create groups that share common interest or affiliations; be able to hold discussions in forums; a control that allow users to choose who can view their profile, contact them, add them to their list of contacts; a mobile community for mobile phone users to create their own profiles; an interactive community environment to connect individuals based on shared business needs or experiences, make friends, and participate in the FMDC environment; services that allow customers to build their own mobile community and brand it; a real-time that allows users to contribute content for live world broadcast, means for Interpersonal communication, E-COMMENCE MARKET PLACE.

Searching the indexer 108 may employ matching algorithms to search on the identified search term, and may further include identifying terms related to the search term or terms likely to be selected by the client in the future. Selected future topics are similarly searched in the indexer 108 on the terms relating to science, engineering, and transportation topics of information. The web file module 401 is further configured for communications with the decision engine 123 being operable with the search program 39 configured for web browsing. A client may reference the web browser 040 and the decision engine 123 to make a determination responsive to science, engineering, and transportation topics of information. The decision engine 123 may represent a portion of a web page, stored files, e-mails, telephone numbers, electronic books, science and engineering text, etc. relevant to the topics of information. The solution address 131 is configured to specify the location of the associated content relating to the topics being queried. Disclosed embodiments provide the solution address 131 being operable with an address designator 020 comprising URL. Certain embodiments provide the address designator 020 being operable for identifying servers 00 and 000 that houses the content identified by the search engine 402. In this manner, display 003 comprises an area being conserved for search result to be presented.

Disclosed embodiments provide cached database comprising copies or partial copies of content that the CPU 51 has identified. In one embodiment, the cached database may contain web pages or portions of web pages comprising textual content, non-video content, audio content, visual content, and video content. The cached database is further configured to connect client 120 to the communication apparatus 400 to request copies of the content rather than remote copies, which may otherwise require making direct contact with the content provider. The communication apparatus 400 provides information for various Internet applications 370, including system parameters, and information about registered clients. Disclosed embodiments provide the support system 210 further comprises a media control device. A communication search program 39 is configured to manage the operation of the CPU 51, and includes the search engine 402 and media control device 201 and the client interface module 172. The search engine 402 and media control device 201 include a crawler 174 communicatively configured with network 20 for requesting electronic documents from the servers 00 and 000. Content from crawler 174 is stored in the index database 132 or cache database 133 for further searches or retrieval. Contents from crawler 174, is classified according to the electronic format being provided for various applications such as mobile device applications, desktop applications, or wireless device applications. The search engine 402 and media control device 201 are logically configured for communications with the indexer 108. The client interface module 172 is further configured to prepare electronic content for presentation on the display device 003 responsive to client input. In one embodiment, the client interface module 172 may prepare search result elements for presentation to a client in response to a client's tendered search query request. The client interface module 172 may determine the appropriate science, engineering, and transportation topics format, layout, arrangement, selection, quantity, graphic type, and grouping of the topics for presentation via display device 003 of the client 120. The client interface module 172 is further configured for determining whether to include additional science, engineering, and transportation topics of information relating to the client search result. The client interface module 172 is further operable for routing client input data or for routing any selections from the client 120. Selections may be retrieved with the mobile device 30. Alternatively, the client interface module 172 could reside on the client 120, rather than within the central processing unit 51. The software 300 is further configured to allow the server tools to communicate with each other for effecting permits users to perform search task.

The tools are in communication with the ROM to provide security and reliability on the industrial files and folders. The file or folders are in association with the database being coupled with a primary domain controller “PDC”, or another set of file/folder server for keeping records. The PDC centralizes network computer apparatus, enabling a centralized communication vehicle for allowing scientist, engineers, and transportation industries, garages, transportation maintenance fleet STESN, government agencies, police department, fire department, and homeland security agencies to talk to each other seamlessly through a centralized system and for extracting transportation topics of information from a centralized transportation database. Detected data referencing at least a terrorist desiring at least a transportation topic of information is made available to the government and/or homeland security agencies, enabling these agencies to thwart transportation and other activities involving terrorist. The database further provides data which are monitored by at least a cache engine. The cache engine enables finding other patterns in which the terrorist carries other activities. The network adapters provide the physical connection to the network 20 and 21, locating the physical addresses of industrial computers or other devices. The PDC is configured to receive the industry's names and passwords at the initial logon screen. Disclosed embodiments provide the PDC being further operable to create security identification that will set the permission and rights for clients of the network and industrial services. Connectivity to the network is allowed through protocol communication, permitting data to be sent through the network adapters into cables or other wireless means. The network interface 170 is further configured to pull out or put into network adapters the queried data through the cables without any internal protocol. The communication process from one network computer to the server 00 and 000 operable for retrieving data passes through model layers that are assigned specific task to the layers. The application layer supports files, application services, print services, message services, and database services before they are sent to the presentation layer 540. The transport layer 560 is operable for delivering the queried data to the end user. The network layer 570 is in communications with routers configured for moving data through the Internet 370. The Internet protocol layer is configured to encapsulate the search packages into data-gram that will run through its algorithms into the database problem and solution addresses.

Server 000 and 00 are operatively configured with a cache engine 350 and communicatively connected to a query engine. The cache engine provides easier and faster means of delivering the desired science, engineering, and transportation contents of the topics of information. The cache engine identifies science, engineering, and transportation topics from the user selections within the network 20 and 21. The cache engine further downloads content that matches user defined preferences and enables communication with the servers 000 and 00 for data transmission. The servers are embodied in the system through which at least a background task is enabled to allow a posting for allowable task to be performed by at least a registered user. Server 000 and 00 are further configured with registration module, a monitoring module, a search module, and a communication module communicatively connected to database 340. The network 20 and 21 further includes the Internet being connected to at least a web-enabled device having at least a browser operatively configured with the cache engine in communication with a client.

Server 000 and 00 and the query engine are further configured with filters which are connected to nodes which are coupled to the Affinity Analyzer to determine which components are involved in the processing performed to accomplish a particular function or task associated with science, engineering, and transportation topics of information. The Affinity Analyzer further provides graphic display representing the various components and element relationships for code and data components provided by the database platform. The graphical displays are capable of illustrating complex element of science, engineering, and transportation components drawings through networks 20 and 21. Certain embodiments provide the graphical display being used for advanced impact analysis of the science, engineering, and transportation topics of information, providing solutions for queried data. The system allows code modification and before a particular code module is modified, the relationships existing between the associated elements that models that code module and other components may be used to determine which other code or data components need to be modified to maintain system's compatibility and efficiency so that all other end users would communicate through the centralized transportation system seamlessly and in real time. These relationships may be graphically depicted using the Affinity Analyzer 122, which allows software analysts to interrogate and visually mine single or disparate sets of components without having to understand the details of the components or relationships involve.

Referring back to FIG. 7, the centralized transportation comprises the Element Locator 125. This tool uses Natural Language Understanding (NLU) technology to locate science and engineering topics and also to provide potential solutions for the failed components. This makes the transportation topics of information stored in the memory more accessible to other user environments because the details of the stored information or the structure of the information has to be known outside the centralized system. The Element Locator 125 is operatively configured with the component inventory 102 and communicatively connected to the Affinity Analyzer 122 to enable performing a very efficient concept such as search, using application domain mappings stored in the system's database shelves 70. The Process Manager 126 is rules-based tool that allows a user to define the centralized science, engineering, and transportation vehicle or protocols and enable various processes that are in the database shelves 70. In the preferred embodiment, the server 00 and 000 is a web-based system having a “web-like” interface, although other types of interfaces, graphical or non-graphical, could be utilized. Disclosed embodiments provide a communication vehicle for users to invoke scripted tools by specifying a desired outcome instead of by specifying particular tool sequences. Thus the complexity associated with locating, transforming, processing, and managing the code and data modules of various transportation fleet departments files are largely hidden from the user. However, any resulting program(s), having computer-readable program code, may be embodied within the communication apparatus 400. The memory devices for the centralized transportation system include, but are not limited to, fixed hard disk drives, floppy disks, or zip diskettes, optical disks, magnetic tape, semiconductor memories such as RAM, ROM, Proms, etc. Transmitting devices for the centralized transportation system include, but are not limited to, the Internet, intranets, electronic bulletin board and message/note exchanges, telephone/modern based network communication, hard-wired/cabled communication network, cellular communication, radio wave communication, satellite communication, and other stationary or mobile network system communication links. A machine embodying the centralized transportation system may involve one or more processing system including, but not limited to, CPU, memory and storage devices, communication links, communication and transmitting devices, servers, I/O devices, and/or any subcomponents or individual parts of one or more processing system, further including software, firmware, hardware, or any combination and/or a sub-combination thereof, which embody the centralized transportation system and the centralized transportation vehicle for routing science, engineering, and transportation topics of information.

Moreover, because protocol and processes are defined and managed as part of the transportation vehicle, the impact-analysis operations that are performed when tools, code modules, or data modules are modified or deleted are largely simplified to make complex task more simplified. Included in the Workbench are functions that allow the user to manage, view, and report all the components and element relationships existing within the transportation industries. These tools include Transportation Discovery Functions 143. Transportation discovery refers to the process of initially creating components and their relationships among other components in the transportation fleet management system. Generally, a Transportation Discovery Function will analyze a target group of transportation software and data constructs and the interrelationships between these constructs. The Transportation Discovery Function is configured to automatically create components associated with the code and data constructs. If the servers are model driven, the Transportation Discovery Function 143 will utilize the various element type definitions stored within the model, such as a program or database to create the components. Each of these components may include meta-data 114 that describes the location and function of the associated code or data element. This meta-data further describes the relationships that an element of the transportation vehicle has with other components, wherein each element relationship models the relationship between the associated code or data construct and other code or data constructs represented by the related components. The Transportation Discovery Function 143 is further configured to sort or create a group of components that may be stored within the Server Database shelves, and which may become available as part of the system knowledge base to manage the associated code and data components. More specifically, the embodiments provide the communication apparatus is described in reference to utilizing topics of information to identify patterns in which the topics are stored so that additional topics can be found. However, embodiments are not limited to any particular science, engineering, or transportation applications or specific implementation. Therefore, all descriptions of disclosed embodiments are for purposes of illustrations and not limitations.

Embodiments provide the vehicle of choice for solving science, engineering, and transportation problems over the web and for advancing online destination services where other science, engineering, and transportation businesses will take advantage of the growing variety of the centralized services, which are important to knowledge distributions, industrial efficiency, profitability, resourcefulness, and science, engineering, and transportation success, including homeland security distributions of knowledge. Embodiments further provide process integration with Internet Technologies to enable transportation problem solving easier, by providing a centralized digital workplace configured to offer the next level of transportation solutions to queried topics. Search results are produced through the social interaction between plurality tools.

Some embodiments provide transportation files, forms, or document s or files described in the initial results may be retrieved by the client from network servers 00 and 000 through transmission medium 27. The search engine 402 may include one or more of the following: a Network interface 170, a transportation decision engine 123 operatively configured with the affinity/data analyzer 122, databases 130 and 340, a report generator 124, and a payment module 104. The Network interface 170 connects the search engine servers 00 and 000 to the network 20 and 21, preferably a computer network, such as the Internet. The Network interface 170 is further configured to connect with networks such as wireless networks, television networks, telephone networks, satellite networks, local area networks, and other networks.

The decision engine may comprise neural network-based algorithms that are effective in several applications including: diagnosis or pattern recognition such as speech and image processing, because the neural network algorithm is further configured for adjusting to patterns in data transmissions. The neural network is further configured to deduce relationships between the different data variables, e.g. estimation or prediction applications even when difficulties exist in completely specifying the rules for science and engineering topics, including vehicle makes and models. The neural network is further configured to assess interrelationships between science and engineering factors and predict outcomes with significant accuracy. The neural network is further configured for processing large amounts of data in real-time. Once the training set for the neural network is developed, the learning algorithm trains the neural network by creating a network of associations between possible aspects of input relating to science, engineering, and transportation topics of information to enable responses thereon. The neural network is more flexible than traditional programming methods used in prior art devices because the neural network is scalable and can be reused for solving other science, engineering, and transportation problem domains. Disclosed embodiments provide decision engine 123, further comprising components of: 1. a Java storage and retrieval (JSTAR) Class 023; 2. a ClicknVestServlet class 032; 3. a servletrunner application 034; 4. a Trainer Module 036; and 5. a Retrainer Module 038.

The network 20 and 21 comprise any distributed computer network such as a local area network (LAN), a wide area network (WAN), or other connection services and network variations such as the Internet, the World Wide Web, computer network terminal devices, such as personal computers, workstations, servers, secondary-computers, primary-frame computers, laptop computers, mobile computers, palm top computers, hand held computers, set top boxes for a TV, or a combination thereof, a touch screen, a keyboard, and a mouse, output devices, a value-added network, and the like.

Embodiments provide communication apparatus 400 for the network communications by providing specific transportation science, engineering, and transportation topics of information sought by a user. Typically a user seeks to access specific science, engineering, and/or transportation data stored in one or several content servers. However, often the situation arises where the user does not know which content server or even where within a specific content server the data resides. To identify the location of the desired data, the user will usually request a search engine server to identify a set of links that are relevant to the user's desired information. To accomplish this, the user utilizes a network terminal to establish a communication session with the search engine server via the network 20 and/or 21. Having established this communication session, the user then inputs a query into a browser 040 for communication with network terminal, which transmits the query to the search engine server 00 and 000. The search engine server processes the query according to any one of a number of well-known algorithms and transmits to the user a list of links pointing to information resources such as science and/or engineering topics, and/or transportation files, forms, or documents on the database 340 and 130 that may be relevant to the user's query. The links are usually retrieved from a database stored in, or at least accessible through the search engine server. From the list provided by the search engine server, the user then selects at least one link that appears pertinent to the desired science, engineering, and/or transportation topics of information.

When the user selects the link, the network terminal makes a request to the content server associated with the selected link to transmit the science, engineering, and/or transportation files, forms, or documents from the database. A controller is provided and configured to coordinate the functionality of the link to the database, the indexer, the robot, and the queue. The controller may comprise any commercially available processor, such as a Pentium Pro. At least a memory is communicatively connected to the processor, and may be in the form of a cache memory for rapid access to the cached or stored information, or other type of memory, such as a dedicated hard disk, or a combination of both. The robot is a software module that is configured for accessing science, engineering, and transportation files, forms, or document s stored in the content servers 00 and 000, and identified by the links stored either in the database or the queue. The Robot gathers the data stored in the n files, forms, or documents and forwards it to the indexer. Software modules such as robot are well known in the relevant technology, but not for the services of the disclosed embodiments. Robot is also known in the relevant technology by the names spider, crawler, wanderer, or gatherer. However, in one embodiment of the instant invention, the queue contains a list of links such as a subset of the links stored in the link database which the robot uses for updating purposes. The queue may be at least a file which is preferably stored in the memory of the search engine server 402. The indexer is configured to receive data such as web pages retrieved by the robot, and extracts some portion of that data that is used to associate a given link with the information on the file to which the link refers. That is, usually the indexer identifies individual words from the text of a file or, in the case of a web page; the indexer retrieves the text stored in the keywords or the description fields of the web page. The indexer, for each transportation files, forms, or document, associates the link with the extracted data and stores them in the link database 130. Indexing programs that perform the functions of the indexer are well known in the pertinent technology such as the Ultra seek Server.™. indexer produced by Infoseek Corporation.

In one embodiment, the robot uses the links stored either in the link database or in the queue to access the files, forms, or documents stored in the content servers and optimize the freshness of the links being displayed in response to a user query. The robot then forwards some or all of the data associated with the files, forms, or documents to the indexer. From this data, the indexer would extract any data it needs for association with the respective link that identifies the files, forms, or document. The indexer is further configured to store the associated data and link in the link database 130. In one embodiment, the indexer may compare the data already stored in the link database 130 against the new data gathered by the robot. If there are any discrepancies in the data, the indexer would store the appropriate updates in the link database 130. Certain embodiments provide the indexer configured for communications with the webmaster to prevent data modification in association with the files, forms, or document. The indexer does not modify the contents of the link database. In another embodiment, however, the indexer may simply inspect that the link is still valid. That is, the indexer only verifies that the robot was able to access any data by using the respective link pointing to given files, forms, or documents. Thus, in this manner the robot, the queue, and the indexer collaborate to refresh the contents of the link database. The decision engine operation may be executed on a Microsoft Windows 95.®.-based personal computer or other Java compatible platform, including a Microsoft NT.®. server, a Sun Station.®., an IBM RS/6000.®., or other platform. The decision engine may be incorporated into a kiosk system. The decision engine recognizes patterns and relationships within a set of input data or responses of topics of information and estimates and/or predicts outcomes. The transportation decision engine may also process a large number of variables such as queries and responses and be able to deduce the interactions between the different variables. The relationships between numerous variables are enhanced to formally define automobiles, trucks, planes, marine vehicles etc. in linear relationships. The decision engine may be trained to handle the numerous variables and can self-adapt and sort through data to produce an understanding of the factors affecting these data.

The transportation decision engine 123 may incorporate a scalable, robust, customizable, quick, simplicity, flexibility, and efficient architecture for large scale memory, retrieval, and classification problems. The transportation decision engine 123 is scalable by adding more self organizing maps defining the various science, engineering, and transportation variables and the associate variables to the training set and re-training the science, engineering, and transportation neural network. Unlike traditional programming techniques, the transportation decision engine's programming code need not be changed. With re-training, the decision engine 123 provides greater flexible without reprogramming. The science, engineering, and transportation decision engine 123 can infer new behavior and deduce patterns and relationships in the database. The decision engine 123 includes two Java classes: the JSTAR class 023 and the ClicknVestServlet class 032. The JSTAR Class 023 is a Java class that is also called a JSTAR Java servlet. The JSTAR class 023 is an object-oriented, Java language based application.

Browser program 040 on client may be, for example, a web browser which allows a user to retrieve and view files on the WWW, or a program which performs a similar function on some other network. In some embodiments, client functions involved in implementation of the methods described herein are included in browser 040. For example, browser 040 preferably provides a framework for communication between server-side search program 39 and client-side search program 38, typically by calling an appropriate additional program. Browser 040 or a program called by the browser may include user-settable options as to whether additional client-side searching is done real-time or at a later time, or whether it is done at all. Other options could include whether the additional searching is done automatically by the program or at least in part manually by the user. Such functions, and/or other functions of the client computing device, may also be implemented in separate program instructions such as program instructions 26 or client-side search program 38. Disclosed embodiments provide the communication apparatus 400 comprising files 18 comprising various files stored on the client computational device, including files downloaded from information content servers 00. Files 18 may also include other files suitable for use in communicating across the network or in identifying stored information accessible using the network. For example, a file including initial search results sent from server 000 may be included in files 18, as may a file containing data associated with additional search results be produced using client-side search program 38. Client is typically associated with an output device 70 and input device 80, particularly in embodiments for which the client computational device is operated by a user of system 10, 20, 30, 40, and 50. Output device 70 may include, for example, a display screen 003 and/or a printer. Input device 80 may include, for example, a keyboard 009 and/or a pointing device such as a mouse 11.

The trainer module 036 trains the neural network. Training of the neural network is described below. The optional trainer module 036 may be an integral component of the science, engineering, and transportation decision engine 123 or it may be a separate component. The decision engine 123 may also be trained without a training module 036.

The optional re-trainer module 038 may use the queries, responses, confidence values and/or other factors to fine tune the decision engine 123. The re-trainer module 038 may be an integral component of the decision engine 123 or it may be a separate component.

### Fashion Brand Names

Brand names would gracefully embrace change made through creative minds as a path to economic growth, not as a means of inquiry, but rather as a dimension of social sustainability to gracefully improve corporate and community cultural interest through economic vision provided by the search engine platform for THE FASHION WORLD MEDIA. The search engine platform further provides a communication environment for individuals and groups such as colleges, universities, churches, stores, organizations, cultural entities, businesses, entertainment/sport entities, events, corporations and more, to present the positivism of their product brands for representation in a social media environment that is defined by fashion media, model media, and dress code media. The platform further allows these groups to post the uniqueness of their product offerings and the positive aspect of these products through the centralized system to bring out social measurements that would lead to generational awareness, brand awareness, leadership awareness, business awareness, corporate awareness, educational awareness, professional awareness, ethical awareness, religious awareness, institutional awareness, social awareness, cultural awareness, sociological awareness, casual awareness, and service efficiency to the society. Let the world capture fashion power trends by prioritizing model-related products and beauty services. The Fashion World Media brings to light a platform for capturing power trends, a support system for positive public declaration of fashion styles, brands, and trends through a centralized communication hub to strengthen brand awareness, generational awareness, corporate awareness, and community awareness through a social networking environment. The social networking environment comprises of fashion media, model media, and dress code media, to be presented by individuals, designers, professional models, fashion outlets, businesses, corporations, and other groups for public observation. The fashion world media is launched to provide the cosmic powers of social media through fashion expressions and trend predictions to empower the world and impact casual awareness and community cultural interest.

The databases 130 may include vendor data, market data, and buyer data. The databases 130 may be partitioned into one or more databases, such as a vendor database 136, a user database 137, a market database 138, and transportation model and make database 139. The vendor database 136 may include information about the vendor, the products that the vendor carries, vendor specific pricing and options, and the vendor's Internet site address. The vendor database 136 may also include detailed information about the products and services offered, including price, features, brand names, delivery methods and including on-line, store front, or via distributors, availability dates, and other information.

The user database 137 may include information collected about the users. For example, the user database 137 may include information about the user such as company, business type, years in business, age, income level, gender, address (home and/or office), and planned purchase timeframe. After the user has used the Centralized transportation search engine server 000 to compare products or services, the user database 137 may include the user's preferences entered in the selection process and the user's down-selected list. The preferences of multiple users may be used to develop trend information that is stored in database 139. For example, the trend information may show that 80% of users want on-line centralized transportation parts shopping or ware house, 50% of users want interest bearing checking accounts purchase orders. After the user has purchased a product or service via the Centralized transportation search engine server 000, the user database 137 may include information about the user's prior purchases. The user database 137 may also contain other user information such as the user's purchasing preferences obtained from other sources.

The market database 138 may include information about trends in the market place. For example, the market database 138 may include information about a trend among centralized transportation parts shopping or ware house features. The databases may include market intelligence database syndication, distribution and licensing of buyer data, vendor data, product data, and market data. Data mining techniques may be used on the databases to develop market trend data, competitive analysis, vendor profiles, and Centralized profiles.

The optional report generator 134 provides reports including vendor reports that indicate activities between users and vendors, user reports that indicate user activities with the Centralized transportation search engine server 000 and/or the vendors, preference reports that indicate trends in Centralized preferences, ad hoc reports, and others. The optional data analyzer 122a may provide customizable data analysis tools. For example, the affinity analyzer 122 may provide customized or ad hoc data analysis that the server 00 or the server 123 can use to fine tune the marketing of the product or services.

The payment module calculates the fees charged to the vendors. Such fees may include periodic fees, banner fees, performance-based fees, and results-based fees. The results-based fees include fees based on the activities between users and vendors, when the users are referred to the vendor by the Centralized transportation search engine server 000. A user is referred to a vendor when the Centralized transportation search engine server 000 provides the user information about a vendor or a product or service offered by the vendor. User activities may include accessing the vendor's network site, opening a new account with the vendor, purchasing a product, or other activity. The fees may include fees charged to vendors other than the user's preferred vendors when the user opens an account with the non-preferred vendor. The non-preferred vendor fee may be less than the preferred vendor fee. The amount of the fee may be based on various factors, for example, the number of activities the user performed prior to at least a purchase, the user's profile, or the type of activity.

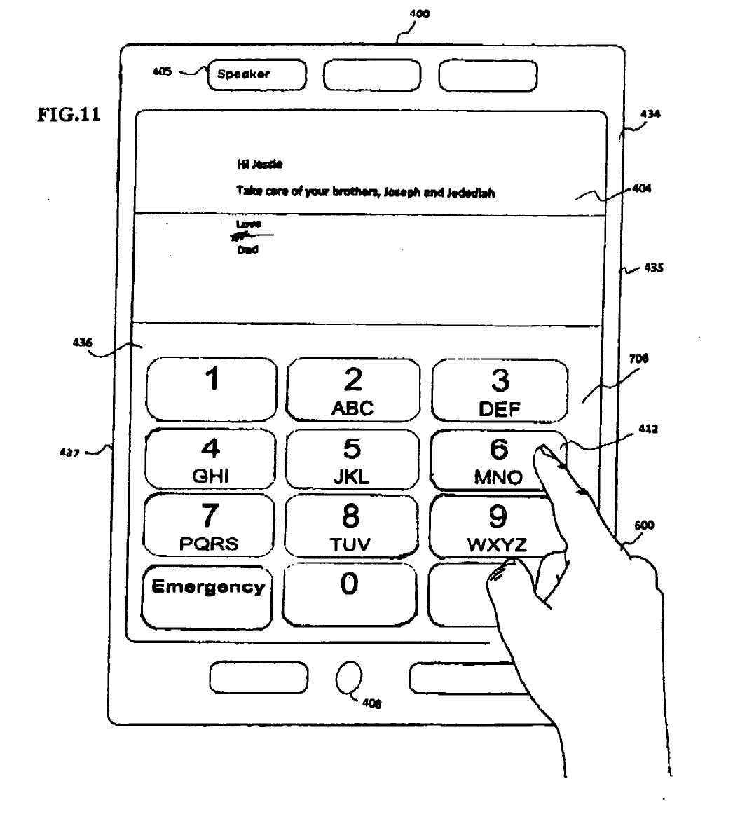

The network 21 provides communication between multiple computer systems. In a wide area network such as the Internet, some of the computer system are servers or hosts and provide access to resources such as information or services to client computer system communicatively connected with the network 21. With respect to the Web, there are thousands of server computer systems that store the web pages that make up the Web. The web pages typically include links in the form of uniform resource locators (URLs) that are a link to another web page, whether it is on the same server or a different one. As described above, the Web is a distributed network of web pages. Networks of hyperlinked transportation files, forms, or document s can also be present in local area networks such as the intranets. The operation of these intranets is very similar to the Internet except that it is not uncommon for all or a majority of the hyperlinked transportation files, forms, or document s of an intranet to be stored on a single server computer system.
Referring to FIG. 11 is seen exemplary embodiments of communication apparatus 400 comprising a mobile phone with a touch screen panel operable for communications; interactive gaming; music applications; a virtual slider operable for accessing multimedia buttons. Disclosed embodiments provide communication apparatus 400 comprising at least one of: at least a variable gain modules 434, a mobile device, 435, internal peripheral devices 436, external peripheral devices 437. Certain embodiments provide communication apparatus 400 comprising at least one of: cell phones, smart phones, laptops, handheld communication devices, handheld computing devices, satellite radios, global positioning systems, and PDA. Some embodiments provide internal peripheral devices being disposed in the mobile device. Other embodiments provide communication apparatus 400 further comprising a Bluetooth radio, wireless local area network (WLAN) radio, a wireless wide area network (WWAN) radio. The external peripheral device further comprises camera, printer, card reader, scanner, radio connection, wireless device connection. Embodiments further provide communication apparatus 400 configured with speakers 405, microphones 408. Certain embodiments provide the communication apparatus further comprises a display/input device 404 being operated by at least a human hand 600. The display/input device 404 further comprises a touch screen 412 being further operable on a detection platform 706. The platform is configured for individuals, corporations and these groups to provide the substance of things hoped for and to reveal the evidence of things not commonly seen by bringing fashion cultural change to their community to impact the world with the hope for sustainable cultural independence, and to better corporate and community vision. The fashion social media support system for sharing knowledge relating to fashion, model, and dress code. The platform is an effective support system for empowering brand success, for bringing business awareness, and for sharing community social measurements to impact generational awareness and improve community cultural and economic values. Users of the network are encouraged to embrace creative minds as a path to fashion media, model media, or dress code media, providing their creativity in fashion model for community cultural growth, not as a means of inquiry, but rather as a dimension for social sustainability to gracefully improve corporate and community cultural interest through economic vision.

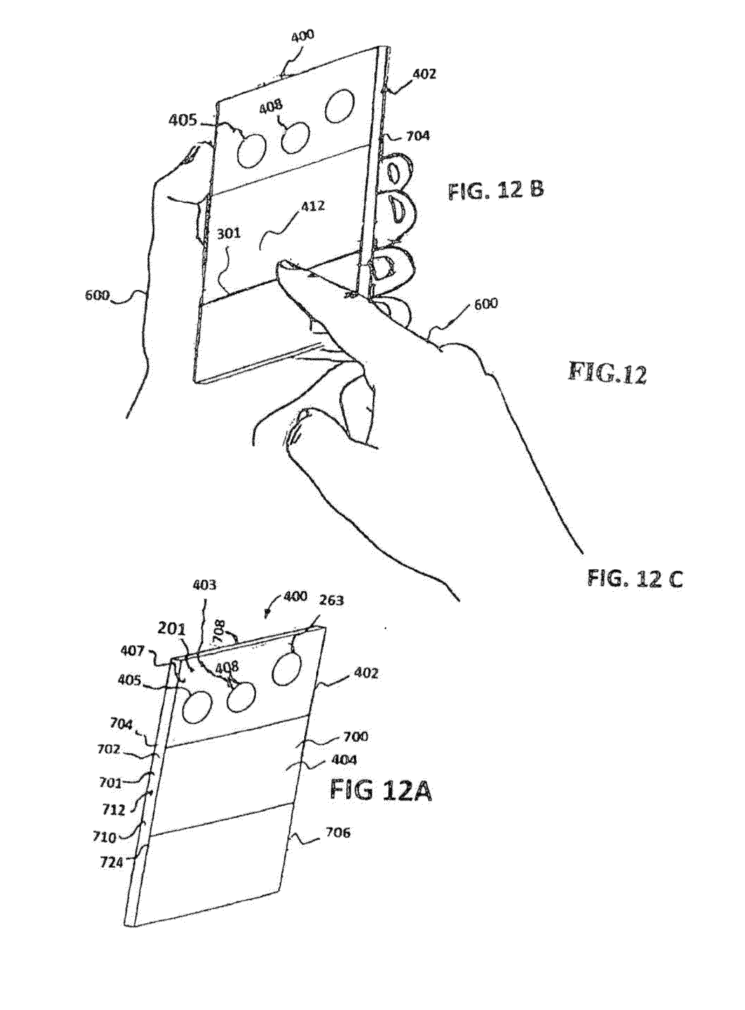

Referring to FIG. 12 is seen exemplary embodiment of a communication apparatus 400 comprising a mobile phone with numeric keypads operable to provide voice over texting applications; a slide out keyboard; and resistive touch screen character recognition in accordance with one embodiment of the invention. Referring to FIG. 12A, the communication apparatus 400 comprises a housing 402 comprising of a sensory platform 700 consisting of nanotechnology application. Some embodiments provide the housing 402 comprising of at least a cell phone housing and/or belt clip. The sensory platform further includes strain gauges 701 embedded in load cells 702. Disclosed embodiment further provide nano technology applications comprising nano sensors 704 being embedded in silicon substrate 712 and fused/etched in microfiber material 710, providing a silicon microfiber 724. The sensory platform 700 being operable to provide a detection platform 706 being further operable for communications and/or for converting at least a form of energy into electrical energy. Disclosed embodiments further provide the sensory platform 700 further comprising a display/input device 404 being disposed with the housing 402. Certain embodiments provide the housing 402 further consisting of speakers 405, microphones 408, embedded antenna apparatus 201, in communication with at least a signal booster comprising a chip 403, in communication with a logic circuit 407.

The communication apparatus 400 further comprises the detection platform 706 comprising sensors 708 being operable for detecting objects proximity to at least the display/input 404. The communication apparatus 400 may comprise at least one of: cellular telephone, telephonic, media device, PDA device, cellular telephone, GPS device, entertainment device and/or an information device being operable for road and traffic communications, including road side advertisement. Embodiments further provide communication apparatus 400 configured with speakers 405, microphones 408. Certain embodiments provide the communication apparatus 400 further comprises a display/input device 404. The display/input device 404 further comprises a touch screen 412 being further operable on a detection platform 706. Disclosed embodiments provide a device being configured for input/output on a substrate comprising at least one piezoelectric sensor formed on the substrate. The device further comprises a display/input formed on the substrate. The piezoelectric sensor is formed on the substrate in communication with at least a processor being further operable to calculate applied force and activate a force response based on the calculated value. Disclosed embodiments provide communication apparatus comprising a device configured for monitoring resistance associated with one or more piezoelectric sensors to detect changes in a force applied to a display/input device. The display/input device is further configured for detecting change in resistance associated with the one or more piezoelectric sensors being further configured with electrical crystals operable for measuring force applied to the display/input device based on the detected change in resistance.

Referring to FIG. 12B is seen an exemplary embodiment of a human hand 600, holding communication apparatus 400. The communication apparatus is disposed in a housing 402 configured with nano sensors 704, a display/input device 404, a speaker 405, and a microphone 408. The display/input device 404 further comprises a touch screen 412 being further configured with an interface device 301. The communication apparatus 400 further comprises a media device further consists of input and output devices. Disclosed embodiments provide the communication apparatus 400 including at least a housing 402.

The communication apparatus 400 further comprises a cellular telephone, a game device, and a media player and a PDA. The communication apparatus 400 is portable and may fit within the hand of normal adult and grown children. In one embodiment, the display/input device 404 may include at least one of multi-point interactive touch screen input device 412, an LCD display. Disclosed embodiment provide a display/input device 404 comprising liquid crystal display (LCD), a touch screen display or another type of display operable for providing information to a use. Certain embodiments provide a display/input device being further operable for providing information regarding incoming or outgoing telephone calls and/or incoming or outgoing electronic mail (email), instant messages, short message services, multi-media message services, calendar application, text message application, the current time display, video games applications, downloaded content display, media applications. In one embodiment, the multi-point interactive touch screen is a capacitive sensing medium configured to detect multiple touches, including blobs on the display from a user's face or multiple fingers touching or nearly touching the display.

Referring to FIG. 12C is seen an exemplary embodiment of the disclosure comprising human hand interaction 600. Certain embodiments provide the communication apparatus 400 comprising a hand held device, further comprises a display/input device 404 as seen in further 12B, being operated by at least a human hand 600 as seen in FIG. 12C.

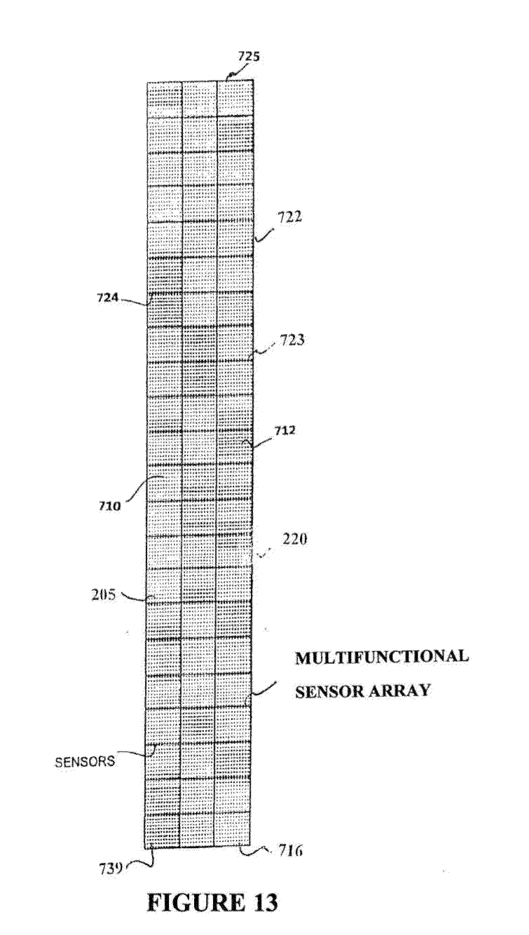

Referring to FIG. 13 is seen exemplary embodiments of nanotechnology application of CMOS multiple antenna on a chip to realize at least a 60 GHz frequency. The CMOS multiple antennas 724 comprise miniaturized alloyed material comprising meta-material structured surface cavity 722 embedded/coupled in silicon-substrate-microfiber platform 723. Disclosed embodiments provide the platform 722 comprising CMOS multiple antenna apparatus 724 configured for communication apparatus 400. The platform 722 further comprises methods and systems for generating electrical energy. The communication apparatus comprises microfiber material 710 further configured with sensors on silicon substrate 712. The sensor comprises electrode and/or temperature sensor 716. Certain embodiments provide the substrate-microfiber 724 comprise miniaturized non ferrous materials 734 being embedded in the silicon substrate 712. Some embodiments provide the substrate-microfiber 724 comprise energy transport platform 725. Certain embodiments provide the CMOS multiple antenna apparatus 724 coupled to the silicon substrate 712, further comprises at least glass 739 comprising a gallium nitride high electron mobility transistor (GaN-HEMT) to improve communication signal amplification, faster data transport speed, and reduce energy consumption for the communication apparatus 400. Some embodiments provide the communication apparatus being configured with a silicon to silicon bonding and/or silicon to ceramic wafer bonding to further provide a detection platform and for generating electrical energy. The silicon is further provided with ceramic wafer bonding responsive to solar energy. The silicon to ceramic wafer bonding may include at least silicon to glass bonding, forming single crystal silicon to improve the micro-acoustics and micro optics in the nanotechnology applications to further reduce energy consumption and produce electrical energy. Disclosed embodiments provide optical properties of thin films being operable for the advancement of the integrated circuit for converting solar energy into electrical energy. Certain embodiments provide optical properties of thin films being operable for the advancement of the integrated circuit for converting solar energy into electrical energy. Some embodiments provide energy platform consisting of at least surface acoustic wave line, paste, MEMS, thin film deposition, and multifunctional sensor array 205 embedded in the silicon substrate 712 and etched/fused in a micro-fibered material 220. The application of ceramic materials further provides many features, including high hardness, physical stability, extreme heat resistance and chemical inertness. Certain embodiments provide highly resistant material to aggressive chemicals, melting, bending, stretching, and corrosion.

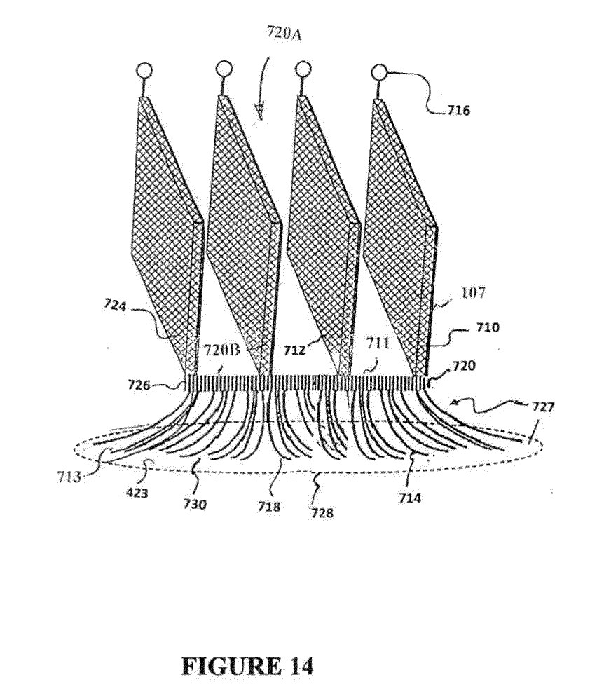

Referring to FIG. 14 is seen exemplary embodiments of the energy transport medium. Disclosed embodiments further provide communication apparatus comprising methods and systems for generating and storing electrical energy. Certain embodiments comprise nano-materials 710 comprising microfiber material. Disclosed embodiments further provide the microfiber material 710 comprising materials with excellent electrical properties being disposed with substrate 712 being alloyed with meta-material structure and etched/fused in a microfiber material to enable energy cell platform and remove radiation pattern back lobe. The microfiber material 710 includes material components with nanometer dimensions in which at least one dimension is less than 100 nanometers. Some embodiments provide the microfiber materials being further configured with nano-wires/tubes 714. The nano-wires/tubes 714 being further embedded in the silicon substrate 712. Certain embodiments provide a communication apparatus comprising the substrate 712, being configured with electrodes 716 at the opened end of the CMOS multiple antennas network in communication with the nano-wires/tubes 714. Some embodiments provide nano-sensors on silicon microfiber comprising nano-fibers formed on the microfiber. Other embodiments provide the electrode 716 further comprising at least a temperature sensor. Disclosed embodiments provide a microfiber membrane configured to provide structural communication and data transmission integrity.

Certain embodiments provide the nano-fibers being formed using electro-spray deposition. Other embodiments provide the nano-wires/tubes 714 comprising at least one component of: carbon char, carbon black, metal sulfides, metal oxides and other organic materials being alloyed with the microfiber material 712. Disclosed embodiments further provide communication apparatus being disposed with alloyed material comprising apparatus 718 being configured for exhibiting unique electrical and electrochemical properties to provide efficient transportation of energy properties. The apparatus 18, in some embodiments, comprises multiple CMOS antenna on a chip operable for intra-chip wireless communication network 727. Embodiment provide a combination of the silicon substrate and metal oxide and/or thin film or miniaturized metallic material in communication with signal booster chip, providing an energy platform comprising a battery cell for the communication apparatus. Disclosed embodiment further provide a communication apparatus consisting of a detection platform comprising touch screen display device configured with a processor means comprising a pattern recognition technique for producing “Sensing,” a controlled data/communication signal and communicating sensed detection to a wireless modem or control module being operable to provide wireless communication. Certain embodiments provide the carbon char being configured with silicon substrate and microfiber material to further provide an energy platform. Embodiments described herein include multiple antenna apparatus fabricated on relatively low resistivity CMOS-grade silicon substrate microfiber with reasonable radiation efficiency. The communication apparatus is reconfigured with integrated sensor elements on at least a circuit board operable for energy harvesting. Disclosed embodiments provide the sensor elements comprising at least a sensing mode configured with nano sensors operable to measure environmental characteristic by generating electromagnetic charge and outputs a time-encoded signal indicative of the measurement, at least a platform comprising of energy harvesting mode to harvest energy from solar energy, wave energy, electromagnetic energy, and ambient energy source. Certain embodiments provide a switchable circuit board configured to switch from the sensing mode to the energy harvesting mode responsive to at least a predetermined threshold.

Disclosed embodiments further provide communication apparatus comprising methods and systems for producing energy properties from the presence of high surface areas and charge transport mechanism. Certain embodiments provide the charge transport mechanism being further derived from the flow of pressured fluid 423. Certain embodiments of the pressure fluid 423 comprise sound waves, solar energy, vibration, and wind. Disclosed embodiments further provide apparatus for thermal expansion of fluid in communication with the nano-wires/tubes 714. Embodiments provide silicon-microfibers and nano-wires/tubes 714 being further provided with methods for converting thermal energy into electrical energy. Certain embodiments of the thermal expansion of the fluid comprise sound waves, solar energy, vibration, and wind and/or material pyrolysis. Some embodiments provide energy medium, including apparatus 720 comprising means through which electron transfer occurs at the electrode 716, through the release of chemical energy to create a voltage through oxidation/reduction reactions 722. Certain embodiments further provide the apparatus 720 comprising at least energy cell platform. Some embodiments provide the apparatus 720 further comprising CMOS multiple antennas configured with meta-material surface cavity. Disclosed embodiments provide the apparatus 720 comprises CMOS multiple antennas platform comprising opened ends 720A and shorted ends 720B. The oxidation and reduction reactions 722 is being separated through the electron 716. The electrode 716 is being configured with CMOS substrate-microfiber 724 embedded with multiple antennas comprising intra-chip network re-enforcements to external electric circuit communication and data transmission efficiency. Certain embodiments provide at least a storage medium, comprising internal transport voltages at electrodes configured for providing useful energy transport stream to batteries 724 and/or capacitors 726. Disclosed embodiments provide silicon microfiber further comprising of Si-substrate consisting of a patterned isolation layer.

Certain embodiments provide the Si-substrate being etched/fused through openings of the patterned isolation layer to form a plurality of electric-conducting platform. At least the electric conducting platform further comprises electric-conducting wires and/or at least heat-conducting wires in communication with an opto-electronic device. The opto-electronic device further comprises opto-isolation apparatus being configured with at least a LED. Disclosed embodiment provide silicon microfiber, further comprising a remote sensor assembly comprising multiple antennas being configured with a plurality of micro electromechanical system (MEMS) embedded on the silicon substrate. The silicon substrate further comprises a wireless communication circuit being configured with a processing device operable to obtain data, such as measurement values from at least one of plurality of MEMS sensors. Certain embodiments provide the silicon substrate further configured to perform at least a filtering operation on at least one of: communication signals; data transmissions; measurement values. Disclosed embodiments further provide silicon microfiber further comprising apparatus for coupling light between input and output waveguides comprising structures having higher portions or lower portions being arranged at a fine pitch equal to or shorter than a wavelength of visible light on base surface responsive to plurality of arc track rows.

Disclosed embodiments provide the CMOS multiple antennas 724 further comprises at least a chip configured with integrated circuit comprising nano wires 714 embedded in silicon substrate microfiber 712, being alloyed with meta material structure comprising of surface cavity. The CMOS multiple antennas further comprises radio frequency applications operable to provide intra-chip antenna network, enabling GHz frequencies for Bluetooth, Wi-Fi wireless network, and mobile phones. In the disclosure, the chip is further configured with power amplifiers operable to provide communications and data transmissions over short range to longer ranges. At least a metal oxide semiconductor is configured with silicon substrate microfiber to provide better power efficiency, achieve better communication clarity, and achieve extended power life. The CMOS multiple antennas on chip with embedded amplifiers are operable to realize high operating frequencies to enable high data rate communications and to prevent atmospheric absorption. Nano wires 714 are operatively configured with the CMOS antennas 724, in some embodiments, to provide multicast protocol label switching network for wireless communication. The CMOS antennas 724 are operable to realize a wireless network region better than at least 60 GHz, for wireless communications, military application, high speed data transmission applications, and homeland security intelligence applications. Certain embodiments provide the nano wires 714 configured to provide a platform to protect against oxygen absorptions, avoid interference from other networks, and protect against human health concerns. Some embodiments provide a communication apparatus configured to provide desirable high definition television “HDTV” signals with high data rate communications being operable at the realized transmission frequencies.

Disclosed embodiments provide the realized transmission frequencies comprises providing better communications for wireless personal area network “WPAN,” local area network “WLAN,” and allowing communications for wireless Gigabit Ethernet, mobile devices synchronizations, wireless fire wire, and USB display. Embodiments further provide the high rate WPAN further includes point to point transport for bulk data transfer, multimedia streaming, and streaming HD multimedia contents. Some embodiments provide the CMOS multiple antennas operable on a chip comprising silicon substrate microfiber being alloyed with meta-material for integrated circuit. Other embodiments provide the integrated circuit being configured for low power consumption. Disclosed embodiments further provide the integrated circuit further comprising digital signal processing “DSP” for higher frequencies. Certain embodiments provide the chip comprising at least a single chip circuit or a module operable for converting digital signal into at least a 60 GHz modulated radio wave. Other embodiments provide the module further operable for converting radio wave signals into at least 60 GHz digital signals. Further embodiments provide the silicon substrate microfiber providing additional output power gain and long term data transmission reliability. Disclosed embodiments provide the meta-material further comprising die-electric materials operable to provide at least a metal gate electrode 716. Disclosed embodiments provide the antennas 724 further comprising a chip configured with at least a software program. The chip is further disposed on a logic circuit further configured with at least transistorized switches to provide at least on chip multiple antennas arrays that are programmable for boosting signal reception and/or for changing signal transmission directions. The CMOS multiple antennas 724 is opened at one end 716, and shorted at the other end 720. The shorted end 720 is integrated with power supply circuitry 726, 728, and 730 to further reduce/eliminate critical signal looses. Disclosed embodiments further provide the nano wires operatively configured for restraining internal noise and for providing stable communication operations.

Disclosed embodiments further provide the antenna apparatus 201, 418 comprising at least a field programmable gate array “FPGA.” Certain embodiments provide the FPGA disposed with meta material coupled to semiconductor substrate in communications with nano wires 714. The nano wires comprise signal interconnect lines in communication with the shorted end of the FPGA meta material structured surface 712. The first antenna portion 201 is connected to the second antenna portion 418 at the shorted end 720. The shorted end further contains thin conductor layers portion characterized as having a plurality of thin, fine-pitch nano wires conductors 720. The nano wires are further configured to convert electromagnetic wave energy into electrical energy to provide further additional operating power platform for the communication apparatus 400. The opened end contains conductive material configured to absorb electromagnetic wave energy in communication with the shorted end 720, consisting of the FPGA meta material structured surface. Plurality portions of three dimensional antennas are joined at the shorted end comprising a MEMS wafer leveled surfaces within flatness at the top and nano wires protruding at the bottom of the flat surface. The nano wire portions are fused and/or etched.

Disclosed embodiments provide a CMOS multiple antennas 201 and 418 disposed on a semiconductor chip 403. Certain embodiments provide the chip consisting of integrated transceiver. In the disclosed embodiments, the antennas 201 and 418 are further configured to transmit, and to receive, comprising of a transmitter and a receiver. The transceiver is formed on a semiconductor substrate comprising silicon substrate alloyed with meta material 712. At least one semiconductor substrate is configured with microfiber material 710 to provide electrical connection between the transceiver 724 and the semiconductor substrate 712. The antenna is further formed with a dielectric layer 711 being connected to the transceiver 724. At least the meta material structured surface 712 further comprises a reflective plate 713 connected to the substrate. The separation between the reflective plate 713 and the antennas 201 and 418 are about a quarter wavelengths of millimeter waves, which enhances radiation efficiency of the antennas. Some embodiments provide an array of silicon substrate microfiber 712 being formed and filled with the dielectric material 711 to reduce the effective dielectric constant of the material between the antennas 201 and 418 and the reflector plate 713, thereby reducing the wavelength of the millimeter wave and enhance the radiation efficiency. Other embodiments provide the antenna apparatus 201, 418 being fabricated on a low resistivity CMOS-grade silicon substrate microfiber. The antennas are configured to resonate at least at 6 GHz.

Embodiments relate generally to wireless communication systems that employ micro machined antennas 201 and 418 fabrication on at least a field programmable gate array, comprising a removal of silicon substrate underneath the antenna structure to increasing the overall radiation efficiency. Disclosed embodiments provide CMOS multiple embedded antennas that include a feeding portion, a radiating portion, a grounding portion, and a short portion. The feeding portion is operable to feed electromagnetic signals through an opened end 716. The radiating portion 724 is connected to the feeding portion 716, to radiate the electromagnetic signals. The radiating portion includes a first radiator 201 and a second radiator 418. The first radiator is “L” shape, with a first end electrically connected to the feeding portion. The second radiator is formed by a plurality of radiating sections connected one by one. The second end of the first radiator and the second end of the second radiator are connected to the radiator shorted end 720. The first end of the shorted portion 720 is connected to a common node 726 of the first radiator 201 and the second radiator 418, and a second end of the shorted portion 720 is connected to the grounding portion consisting of nano wires 714.

Disclosed embodiments provide CMOS multiple antennas in a chip and could include employing an antenna that resonates at least at 5.8 GHz. Another disclosed embodiment includes a differential feed operationally coupled to CMOS multiple antennas. In one disclosed embodiment, the antennas are fabricated on relatively low resistivity CMOS-grade silicon substrates. In one such exemplary non-limiting embodiment, CMOS multiple antennas and a photo-resist form an antenna approximately 400 um in thickness and is 12 mm long×2.8 mm wide. In another embodiment, at least one CMOS antenna is provided, the CMOS multiple antennas portion is separated from the CMOS antenna, and a photo-resist material connects the first and second CMOS portions. The antenna 201 includes at least one CMOS antenna 418 and the CMOS multiple antennas portion 724. A photo resist material 711 is coupled or connected to the CMOS portions 418 and 724. The antennas 201 and 418 can be fabricated on a silicon substrate microfiber with a thickness of at least 10 um and/or between 10 um and 700 um. Disclosed embodiments provide the communication apparatus 400 further comprising the COMS multiple antennas 201 and 418 being disposed on the chip 403 operable for digital signal processing “DSP.” The chip 403 is further coupled to an application specific integrated circuit 107. Certain embodiments provide the antennas further comprising meta material structured surface cavity for enabling high data transmission. Some embodiments provide the meta material structured surface comprising at least a reflective element operable for wireless interconnections and for transmitting data wirelessly at a much faster speed.

Other embodiments further provide a silicon wafer comprising folded dipole antennas configured with meta material structured surface on at least a dielectric micro-fibered material to provide better conductor gain at a resistivity of at least 5 cm, and with a thickness of at least 10 um, and impedance of at least 100 being fed through at least the nano wires consisting of lengths of at least 1.5 mm. Disclosed embodiments are not limited to the dimensions herein. Certain embodiments further provide exemplary embodiments of the antenna being constructed of conducting nano wires 714 being coupled with a size of at least a 2.50 mm×4.3 mm at a height of at least 525 um. In the embodiments, the antenna further comprises at least silicon substrate microfiber disposed with the meta material structured surface configured for low resistivity and better conductor gain to enable a broader bandwidth. The CMOS multiple antennas is further disposed on flat surfaces consisting of at least a vertical slot being narrowed with at least a wavelength of at least a quarter deep. The antenna 201 and 418 are further configured for surface wave propagation to at least the shorted end 720B. In some disclosed embodiments, impedance is higher at the opened end 720A. In other disclosed embodiments, at least a corrugated meta slap is coupled to at least a vertical wall to modify radiation pattern to increase antenna gain. Disclosed embodiments provide the radiation pattern further includes a radiation pattern back lobe comprising nano wires being etched/fused at the shorted end 720B with the meta material surface configured to provide higher gains.

The antenna 201 can be derived from a dipole antenna in one exemplary generalized non-limiting antenna embodiment. The antenna can be a differential-fed antenna and can be easily integrated into active circuits. Disclosed embodiments provide a complementary metal-oxide-semiconductor (CMOS) consisting of integrated multiple antennas circuits 724 being disposed in at least a chip, comprising at least one of: microprocessors, digital logic circuits, static RAM, and microcontrollers. Certain embodiments provide the multiple antennas 201 and 418 comprises CMOS configured with silicon substrate microfiber being alloyed with meta material structured surface 712 to provide wide variety of analog circuits such as image sensors, and data converters. Some embodiments provide highly integrated transceivers 724 configured for variety of communications, including military applications. Disclosed embodiments provide the CMOS further comprising complementary and symmetrical pairs of p-type and n-type metal-oxide-semiconductor field-effect transistors (MOSFETs) operable for logic functions. Certain embodiments provide the CMOS further comprising a structured material with relatively low resistivity and relatively inexpensive. Certain embodiments provide a CMOS multiple antennas apparatus comprising means for radiating or for receiving electromagnetic energy and operable to accepts power from a source and radiates the power into the shorted end. The received energy is radiated to the source, or dissipated it to a resistive load. The ratio of the power radiated into the ground nano wires to the power received from the source is the radiation. Radiation efficiency is defined as “the ratio of the total power radiated at the shorted end by the multiple antennas to the net power accepted by the antennas from the opened end” (Pradiated/Pinput=ηefficiency).

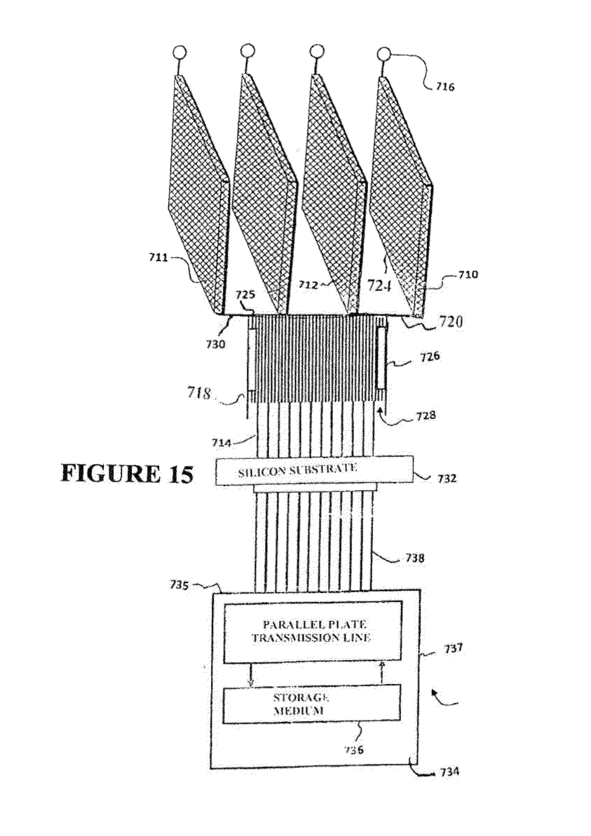

Referring to FIG. 15 is seen further exemplary embodiments of the CMOS multiple antennas 724 on a chip comprising substrate microfiber embedded with meta-material for communications and for an energy medium. The CMOS multiple antennas 724 is opened on one end configured with electrode and temperature sensor 716, and shorted on the other end 720, being configured with nano wires for antenna network communications, in communication with the energy storage medium further comprising energy storage apparatus coupled to the shorted end 720. Disclosed embodiments provide methods and systems for realizing frequencies of at least 60 GHz and for generating electrical energy. Certain embodiments provide apparatus for generating electric energy from the energy released by at least a reaction, such as pressure, thermal transport, heat, force, motion, and vibration. Certain embodiments provide microfiber material 710 being configured silicon substrate for converting pressure, vibration, heat, thermal transport, wind, force into electrical energy. Some embodiments of the energy being generated comprise electrical energy 730. Other embodiments of the energy being converted comprise thermal energy 732. The thermal energy, in other embodiments, is being transported through the nano-wires/tubes 714 in communication with the silicon-microfiber material and/or the electrode. Certain embodiments provide the nano wires/tubes further configured to provide a platform for each shorted CMOS antenna to engage in antenna network to achieve at least a 60 GHz frequency. The microfiber material 710 further comprises plurality meta-material comprising textile fibers 711, being alloyed with zinc oxide (ZnO) nano-wires 734 to form at least a meta-material structured surface cavity. Disclosed embodiments provide the zinc oxide nano-wire 734 further configured with piezoelectric crystals for generating electrical energy 728 and at least a coil for communicating and/or transporting the electrical energy being generated to at least a capacitor. Disclosed embodiments further provide the piezoelectric further comprising an electromagnetic composite meta-material including an electromagnetic medium.

Certain embodiments of the piezoelectric comprising plurality of spaced electromechanical resonators disposed in the electromagnetic medium configured to control electromagnetic wave propagation properties in the electromagnetic composite meta-material. Certain embodiments provide a communication apparatus being configured with signal booster chip in communication with an antenna apparatus being operable to allow current flow 730 from plurality fiber pairs 736. Other embodiments provide the fiber pairs being configured for converting at least one of: vibration, pressure, blood flow, sound, waves, force, thermal energy, and other electrical properties into electrical energy 730. Some embodiments provide a device for generating pressure, thermal energy, and force and producing electrical energy 730. Certain embodiments of the device for producing electrical energy 730 further comprise radiation apparatus. Other embodiments of the radiation apparatus comprise a radiator device being configured with silicon substrate microfiber and at least an electrode.

Disclosed embodiments provide the radiator device comprising a device that emits radiant energy. Disclosed embodiments provide nanotechnology application comprising nano sensors and MEMS, being embedded on a silicon substrate and etched/fused in a micro fiber material, preferably fabricating together a unified process with supporting integrated circuit (IC) on the same semiconductor substrate comprising integrated silicon platform comprising a chip configured with CMOS multiple antennas 724. Certain embodiments provide the integrated silicon platform in at least a single chip to greatly reduce the size, weight and power consumption of the communication apparatus 400 and enhance the performance of all applications for the communication apparatus. Disclosed embodiments provide the energy platform comprising a cell platform 720 being further configured for medical devices applications. Other embodiments of the cell platform comprise CMOS multiple antennas configured for intra-chip antenna network for effective communication applications. Disclosed embodiments further provide the cell platform comprising at least a nickel-cadmium (NiCd) configured with nickel oxide hydroxide and metallic cadmium for energy capture. Disclosed embodiments provide the nickel oxide and metallic cadmium further consisting electrodes 716 being configured for deep discharge applications. Other embodiments provide methods and systems for storing electrical energy, comprising the cell platform 720. The cell platform includes battery cells and/or capacitor configured for withstanding higher number of charge/discharge cycles and faster charge and discharge rates. Certain embodiments of the cell platform further comprise an electrode device comprising at least electrically conductive nano wires/tubes 714 being coated with at least one electrically isolating layer. The nano wire/tubes further comprises silicon nano wire operable to display biological analysis results such as electrical responses to either pH changes or receptor-ligand interactions of at least one of: protein disease, viruses, and DNA hybridization in real-time.

Embodiments further provide communication apparatus comprising apparatus for generating pressure, thermal energy, and force, and for converting the pressure, thermal energy and force into electrical energy. Disclosed embodiments further provide methods and systems for converting wind force into electrical energy. Some embodiments provide microfiber material 710 comprising zinc oxide (ZnO) being configured for converting pressure and force into electrical energy 730. Some embodiments of the microfiber material 710 further comprise meta-material structured surface cavity comprising nanotechnology applications. Disclosed embodiments provide a method of selectively etching a solid sacrificial sensory layer, comprising wet etching and/or dry etching. Other embodiments provide methods and systems of generating renewable electrical energy through nanotechnology applications. The nanotechnology applications comprise at least a single layer microfiber 736. Other embodiments of the microfiber 710 further comprise miniaturized meta-material arrays comprising nano-wire 734 being configured for applications in hybrid communication applications to increase data transmission speed, including HDTV applications, further comprising generator assembly 738 in communication with the energy platform. Certain embodiments provide the generator assembly 738 comprising at least semiconductor properties consisting of non ferrous material arrays. The non ferrous material array comprises vertically-aligned zinc oxide (ZnO) nano-wires 734. The zinc oxide nano-wire 734 is being configured to exhibit flexible electrode 716. Certain embodiments provide the flexible electrode 716 comprising complementary metal oxide semiconductor. Some embodiments provide the flexible electrode further comprising conductive platinum tips 735 comprising of CMOS-MEMS. The CMOS MEMS further comprises probes switches operable to actuate down onto a specific programmable addressable location and deliver a current Phase change (PC). The CMOS MEMS is embedded within a reconfigurable circuitry to provide a low or high resistance state. When the reconfiguration is complete, the heaters in the probe are turned off and electrical and/or mechanical contacts are broken. The application provides the reconfiguration of radio-frequency circuits further configured for repeatable contact resistance.

Other embodiments provide the microfiber material 710 further comprising plurality fibers being operable for characterizing excellent electrical properties. The microfiber material is coupled with meta-material structured surface cavity and/or coated with polymer and/or with zinc oxide layer 734 to realize at least 60 GHz frequency and to provide energy transport platform 725. Certain embodiments provide the nano-wires 734 configured to provide antenna network platform 718. Some embodiments further provide the nano-wires 734 being coated with gold 737, and fused or etched on the energy transport platform 725. Other embodiments provide the nano-wires 714 further configured for harnessing energy from at least a medium, comprising at least one of: vibration, pressure, blood flow, sound, waves, thermal source, wind, motion and Force. Further embodiments provide the CMOS multiple antenna apparatus 724 further comprising zinc oxide (ZnO) 734 being embedded in a silicon substrate configured with at least polymer. Disclosed embodiment further provide a single crystal silicon to improve the fabrication of micro-acoustics and micro optics and to provide an energy platform for converting solar energy, sound wave, vibration, pressure force, and wind force into electrical energy.

The micro-acoustics and micro-optics are further fabricated in a micro-electro-mechanical system and thin film technique to enable the integration of microelectronics circuit and multifunctional sensor into the detection platform for the communication apparatus. Wafer bonding in single crystal silicon is applicable to significantly lower acoustic losses and improve optical properties and energy production. Disclosed embodiments further provide silicon on insulator bonding method having a silicon layer formed on a silicon microfiber oxide film as an insulator film comprising parasitic capacitance being configured for high radiation-proof ability. At least a layer in the substrate surface layer portion comprise a region electrically isolated from the inside of the substrate via oxide film layer to eliminate effects such as a high speed/low power consumption operation and/or prevention of low signal transmission. The substrate further includes single-crystal silicon substrates comprising at least a single-crystal silicon substrate that becomes an SOI layer and/or a bond wafer. Certain embodiments provide the silicon substrate comprising a single-crystal silicon substrate that becomes a support substrate being configured with an oxide film on the surface of at least one silicon substrate microfiber. The single-crystal silicon substrates may be bonded to each other via the oxide film there-between and heat treated to increase bonding strength. Then, a film thickness of the bond wafer is reduced to obtain an SOI substrate

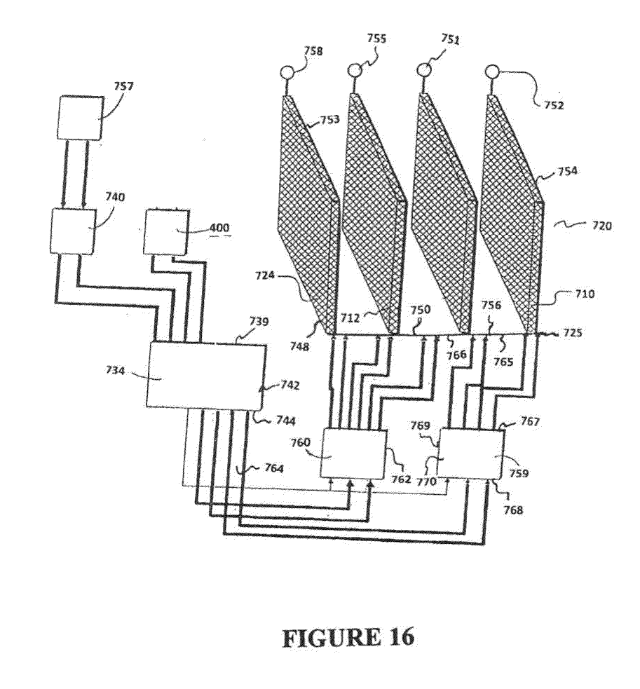

Referring to FIG. 16 is seen further exemplary embodiments of communication device including energy medium comprising energy platform. Embodiments further provide silicon-substrate-microfiber comprising energy transmission/storage apparatus 720. Certain embodiments provide data being converted into electrical energy. The data may be derived from at least one of: vibration, pressure force, wind flow, sound waves, force, and electrical properties. The pressure may include pressure force from at least an object. The object may also include human hand being used to operate the communication apparatus 400. The operation of the communication apparatus include keyboards, touch screen, gaming, texting, programming, display/input, output, and normally utilized operations. Disclosed embodiments further provide the silicon-substrate-microfiber comprising charge couple apparatus 740 being configured with miniaturized conduit particles 734. Certain embodiments of the conduit particles 734 comprise of at least glass 739. Other embodiments of the conduit particle comprise of at least Zinc Oxide (ZnO) and/or gold. Some embodiments of the disclosed particles comprise of at least non-ferrous material being alloyed with at least a substrate-microfiber 724.

Disclosed embodiments further provide materials consisting of conduit properties comprising of at least glass fiber 739 being responsive to light data transmission. Further embodiments of the charge particle apparatus 740 comprise electron-silicon substrate-oxide 742 configured with materials being characterized with good optical properties for exhibiting effective sensitivity to electron range. Disclosed embodiments further provide the electron-silicon substrate-oxide 742 comprising coatings to prevent glass-glass interface 744. Certain embodiments comprise the silicon substrate 712, being at least the constituent of glass 739. Other embodiments provide the silicon substrate 712 being layered with fibers 710 to exhibit durability and better charged properties. Certain embodiments provide an energy platform comprising AlN thin film. Disclosed embodiments provide communication apparatus consisting of solar cell methods of generating electrical energy and silicon wafers process of producing a simpler and cheaper alternative green energy communication apparatus. Disclosed embodiments further provide a communication apparatus comprising of direct band-gap semiconductors cadmium telluride (CdTe), copper indium diselenide alloy (CuInSe2) and copper indium gallium diselenide alloy Cu(InGa)Se2, comprising materials with high optical absorption coefficients being applicable for the photo absorption layer in thin film photovoltaic (TFPV) cells for the energy platform.

The electrodes 716 further comprise of battery cells 748. Other embodiments provide the battery cells 748 further include electrolyte 750 comprising of cathodes 751 and anodes 752. The cathodes 751 comprising the oxidized form of the electrode metal and the oxidizations and reductions are controlled by the electrochemical potential being responsive to the thermal expansion, pressure, composition and concentration of the electrolyte 750. The electrical potential differential being produced is the sum of the electrochemical potential at the electrode 716. Disclosed embodiments further comprise of Zinc batteries and/or zinc fuel cells 754 being configured for electrochemical power applications through the oxidation of zinc with oxygen from the air. Embodiments provide a device for exhibiting high energy density. Certain embodiments comprise nano-materials 734 being embedded in the substrate 712 and etched/fused in the microfiber material 710 to provide advanced cell platform 756. Some embodiments of the cell platform 756 are being communicatively connected to the electrodes 716. Other embodiments of the cell platform 756 comprise a battery cell 753. Yet, other embodiments of the cell platform 756 comprise fuel cell 754. Still, other embodiment of the cell platform comprise energy storage medium. Disclosed embodiments further comprise a capacitor and/or a battery cell apparatus for electronic devices.

Yet, some embodiments provide CMOS multiple antenna platforms configured with at least an opened end 755, and at least a shorted end 766 in communication with conductive nano wires 764 forming at least antenna network environment.

Disclosed embodiments provide the cell platform 756 further configured for medical devices applications 757. Other embodiments of the cell platform 756 comprise communication applications 758. Disclosed embodiments further provide the cell platform 756 comprising nickel-cadmium batteries (NiCd) 758 configured with nickel oxide hydroxide and metallic cadmium 760. Disclosed embodiments provide the nickel oxide and metallic cadmium 760 further consisting electrodes 716 being configured for deep discharge applications. Other embodiments provide methods and systems for storing electrical energy, comprising the cell platform 756. The cell platform 756 includes battery and/or capacitor configurations for withstanding higher number of charge/discharge cycles and faster charge and discharge rates. Certain embodiments of the cell platform 756 further comprise an electrode device 762 comprising at least electrically conductive nano wires/tubes 764 being coated with at least one electrically isolating layer 765. Disclosed embodiments further provide nano-wires/tubes 714 764 comprising at least a substrate 712 being coated with at least one metallic layer 760 having a nano-metric pattern thereon, and being at least partially exposed at a tip of electrically conductive core 760. The cell platform 754 further comprises at least plurality nano-wires/tubes 714 764 being configured with flexible electrode devices 762 disposed in a guided re-enforced silicon substrate 712. Other embodiments further provide each electrode device 764 being configured with plurality of micro-wires 734 being connected to at least one nano-wires/tube. The nano-wires/tubes 714 762 further comprise flexible electrode devices 762 being configured to provide electrical communications, video recording, mobile broadband applications, camera/webcam, and television applications.

Disclosed embodiments further provide the cell platform 756 comprising particles of zinc mixed with an electrolyte consisting of at least potassium hydroxide solution. Certain embodiments provide a communication apparatus configured for converting sound waves, solar energy, vibration, and wind into electrical energy. Some embodiments provide oxygen from the air to enable reaction at the cathode 751. The reactions can form hydroxyls, which is being migrated into zinc paste and form zinc oxide hydroxide 734 configured for releasing electrons to the cathode 751. Disclosed embodiments further provide the reactions comprising zinc decaying into zinc oxide 734, the communication apparatus generating electrical energy from sound waves, solar energy, vibration, and wind, in communication with the cell platform 756. The cell platform 756 is being configured so that the sound waves, solar energy, vibration, and wind and hydroxyls from the anode 752 are being recycled for energy production at the cathode 751. The recycling would enable the sound waves, solar energy, heat, vibration, and wind to serve only as a catalyst to effectively produce maximum voltage. Embodiments provide a substrate 712 and microfiber material 710 for the design configuration of the cell platform 756. The cell platform further comprises electro-active material to enable better charge transport. The cell platform 756 further comprise of plurality nano-components consisting of nano-particles 767 forming conductive carbon-based nano-clusters 768 bound together by a conductive carbon-based cluster binder having high densities of mobile charge carriers such as electrons, electronic acceptors, and ionic species. The cell platform 756 further comprises at least a terminal 769, being electrically coupled to the nano-particles 768 for enabling a charge transport being operable for supplying electrons and electron acceptor sites. Other embodiments of the cell platform 756 further comprise charge transport 740, occurring by means of the electron traveling through the highly conductive and short path of the binders 770. Disclosed embodiments provide the binders in close proximity with the nano-clusters 768 for enhancing the energy and power densities. Disclosed embodiments further comprise battery cell and/or capacitor.

Disclosed embodiments provide a radiator apparatus comprising a renewable energy source. Certain embodiments provide communication apparatus comprising solar panels made of crystalline silicon wafers for converting solar energy into electrical energy. Some embodiments provide thinner wafers using laser processing to ablate the circuit board, providing more electrically efficient communication environment for signal amplification. Disclosed embodiments provide the radiator apparatus being further configured with substrate-microfiber and metallic materials to prevent any radioactive or chemical impact within the environment. Disclosed embodiments further provide the radiation apparatus being further configured for extracting energy from the opposing outside wind to be stored within the cell platform. Disclosed embodiments provide methods and systems that don't produce noise and pollution. More electricity could be generated at any time without physically plugging the communication apparatus into a wall socket for recharge, thereby extending the life of the battery.

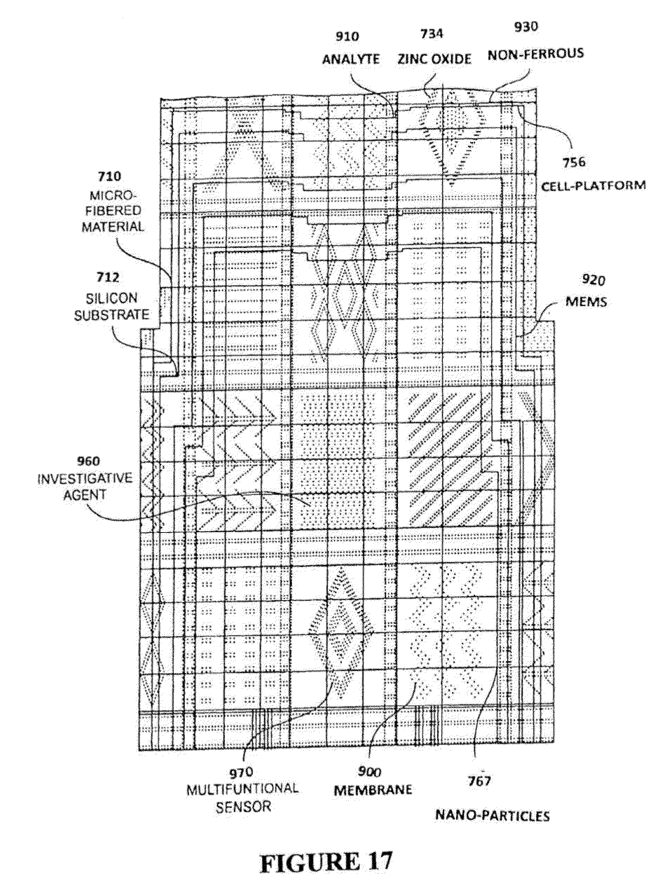

Referring to FIG. 17 is seen exemplary embodiments of a charge transport comprising microfiber material 710 being configured with silicon substrate 712. The silicon microfiber comprises cell platform 756. The cell platform 756 comprises nonferrous material 930 embedded in the silicon substrate 712. Multifunctional sensors 970, nano-sensors 360, 327 and MEMS 920 are embedded in the silicon substrate for detection of charge characteristics. The cell platform 756 further comprises nano particles 767 being configured with membranes 900. Disclosed embodiments provide methods and systems for generating electrical energy and for transporting the energy into a storage medium. Some embodiments provide zinc oxide 734. Certain embodiments comprise an analyte 910. Other embodiments provide an investigative agent. Embodiments provide a MEMS 2-D scanning micro-mirror with miniature optics and flexible electronics for unrestricted probe movement. Embodiments provide communication apparatus being configured with flexible electronics for unrestricted freedom of movement due to pressure, vibration, and sound waves to generate energy through voltage-transformation circuitry in communication with the battery cells. The platform provides safety into MEMS system to protect consumers from dissipative radiant energy. Certain embodiments provide communication apparatus being operable on low power consumption. Certain embodiments provide highly efficient fiber amplifiers using ultrafast laser technique.

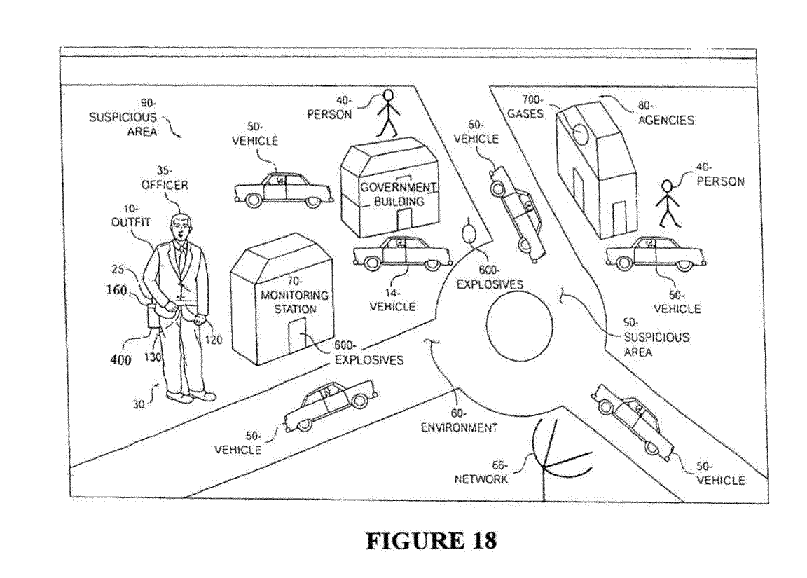

Referring to FIG. 18, is seen communication environment 60, comprising a monitoring station 70, agencies 80 and a government building. Vehicles 14 and 50 and at least a person 40 are being watched by an Officer 35 monitoring a suspicious area 90. The Officer 35 is outfitted with certain embodiments of the disclosure, comprising outfit 10 on the officer 35, a communication apparatus 400, communication apparatus 400 being disposed in an outfit 160 operable for housing the communication apparatus, wearable outfit 30, waist belt 120, outfit 160 is firmly secured on the officer's waist by the waist belt 120, and connector 25 being disposed within the waist area 130. Officer 35 is seen to have identified a suspicious person 40 patrolling at least agencies 80. The outfits 10, 30, and 120 are seen to provide exemplary embodiments of detected explosives 600 and gases 700. The communication apparatus 110 is further configured to analyze detections and is in communication with a network 66.

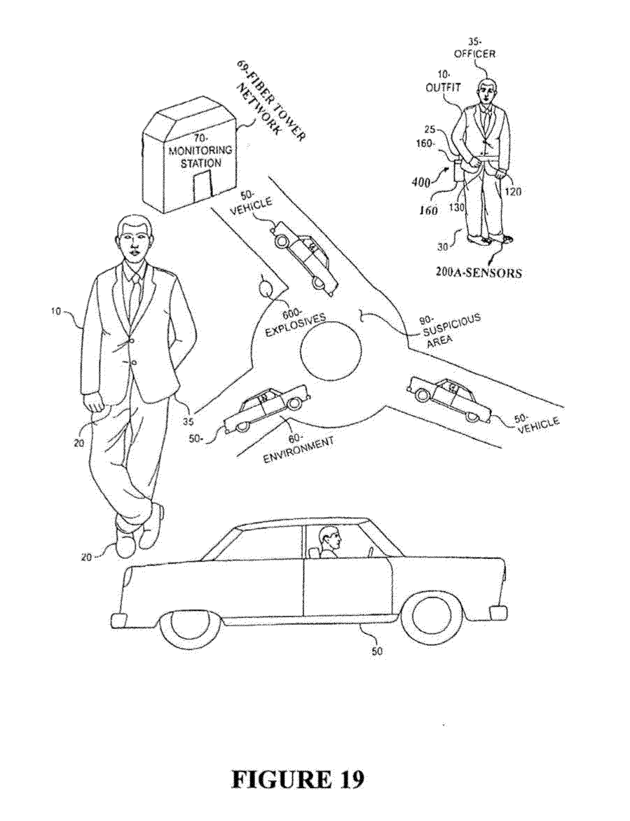

Referring to FIG. 19 is seen further embodiment of a monitoring station 70 comprising a fiber tower network for sharing science, engineering, and transportation topics of information. Disclosed embodiments further provide a network for sharing knowledge. A person 35 is seen wearing a detection outfit comprising of sensors embedded in silicon substrate and fused/etched in a microfiber material, a communication apparatus 400 is disposed in an outfit 160 comprising a housing being secured on the waist area 130 via a waist belt 120 by the person 35. The housing further comprises silicon substrate micro fiber being embedded with sensors operatively configured for generating electrical energy. The communication apparatus 400 is communicatively configured with signal booster operable to prevent cancerous disease and is responsive to network communications with the monitoring station 70 and/or fiber optic tower 69. The communication apparatus is further configured with battery cells responsive to energy being created and responsible for supplemental empowering of the detection platform for the display device. Further embodiment of a person 35 is being disposed with communications apparatus 400. Disclosed embodiments provide the respective person 35 wearing outfits 10, 20, 30, 120, 160 and 130, operable for detecting weapons of mass destructions. The person 35 is communicating with communication apparatus 400 disposed in a vehicle 50 being positioned within an environment 60. The communication apparatus 400 may be configured to detect suspicious area 90 containing explosive 600. A suspicious vehicle 50 is seen to have been detected with weapons of mass destructions.

An exemplary embodiment of the knowledge being shared comprises the science of positivism. For example: A model of the “Joseph A. Tabe” the inventor: Fearfully and wonderfully created by a Father who is a mighty warrior, great in battles, fearful in praises, and just to forgive, the Alpha and the Omega, who seeded me in a human body through spiritual encounter in human interaction, trusted unto them as parents who knew Him not. “Fashion of the Inventor:” Publicly declaring His name, His works, His wills, His gift, His passion, His everlasting Love for me in Christ Jesus, who is the word of God and who has put every spirit of darkness to shame in the grave. “Dress code of the Inventor:” The Holly Spirit.

A Church Model: 1. A model for Christian growth and Church growth. 2. A visible structure consisting of people of faith united by their participation in God's spirit through Christ Jesus, transmitting his visible signs and invisible grace by faith, exhibiting personal proclamation over interpersonal relations and mystical communion as part of a total human family acting in union with the flow of God's Kingdom life.

A Church Leadership Fashion/Model: 1. A good shepherd lay down his life for his sheep. 2. One who leads by modeling godliness and righteousness in his own life and encouraging others to follow his example in Christ Jesus.

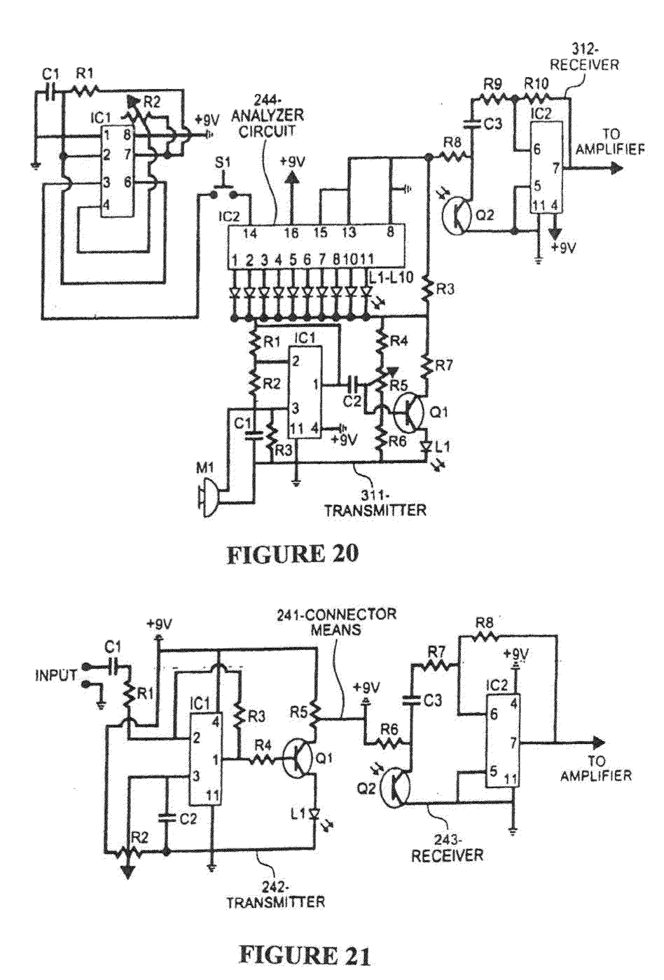

Referring to FIG. 20, the transmitter 242 is configured with energy apparatus comprising a battery cell which may be charged wirelessly. An amplifier is configured with the communication apparatus for amplifying signal communications. Transmitter 311 and receiver 312 are communicatively connected. Transmitter 311 and receiver 312 are communicatively connected to analyzer circuit 244. The CMOS circuitry is operable to dissipate less power. Certain embodiments of the disclosure further provide a static logic configuration being operable on p-type and n-type metal-oxide-semiconductor field-effect-transistors “MOSFET's.” being configured for implementing logic gates.

Referring to FIG. 21 is seen an exemplary embodiment of a transmitter 242 and 311, and a receiver 243 and 312. The amplifier is seen responsive to signal communications. Transmitter 242 is operatively configured with receiver 243 and communicatively connected to connector beam 244 responsive to communication network connections. The amplifier comprises a chip communicatively connected to receiver 243 and operatively configured with transmitter 242. The transmitter 242 and 311, and the receiver 243 and 312 comprise CMOS comprising of solar cells on n-type CZ silicon substrates, including Polycrystalline thin-film cells, lightly boron-doped CZ, or gallium-, indium-, and aluminum-doped CZ for converting solar energy, pressure force, sound wave, vibration, wind force into electrical energy. Disclosed embodiments further provide a thin-film comprising of thin layer of transparent conducting oxide, including tin oxide. Certain embodiments provide the oxides being highly transparent and configured to conduct electricity efficiently. Some embodiments provide antireflection coatings.

Other embodiments provide Polycrystalline thin-film cells comprising tiny crystalline grains of semiconductor materials operable for converting solar energy into electrical energy. At least a CPU-1C1 is provided in communication with RFID chip reader-1C2. L1 and L2 are LED. S1 is an automatic momentary single pole double throw switch operative for transmitting and for receiving signals. C1 is an electrolytic capacitor being disposed on an energy platform comprising C2 and C3, which are IMF capacitors. Q1 and Q2 are infrared LED emitter and M1 is a speaker microphone. R1 through R10 are resistors responsive to signals. Disclosed embodiments provide a digital signal processing system which allows reconfiguration of signal transmission to the environment and signal conditions. At least the antenna is developed for electrical operation, which can be reconfigured in terms of frequency and may also increase or decrease its directivity. The increase and/or decrease of signal directivity are a measure of the gain of the antenna in a particular direction. Disclosed embodiments provide the communication apparatus being configured with the antenna to operatively pick up faint signal by increasing its gain or overcome interference by creating a null point. Certain embodiments provide a smart communication apparatus being configured for any given network or environment. Some embodiments provide a miniaturized adaptive micro antenna in communication with at least a chip being configured for signal amplification and to minimize interference and maximize intended signal reception. Disclosed embodiments provide signal booster chip comprising of at least a MEMS, in communication with a logic circuit. The MEMS further comprises MEMS based phase shifters being configured on at least a single silicon substrate microfiber comprising communication control circuitry. The sensors are being coated with silicon substrate polymer and/or with zinc oxide layer to provide energy transport platform. Certain embodiments provide communication apparatus comprising silicon substrate microfiber configured with optical properties of thin films being operable for the advancement of the integrated circuit for converting solar energy into electrical energy. Disclosed embodiments further provide smaller feature sizes, faster switching speeds, and lower power consumption apparatus. Some embodiments provide basic wiring such as dielectric and photolithographic layers, providing a circuit for electrical energy production. This integrated circuit could employ copper/low-k interconnects, silicon-germanium and silicon on insulator-based transistor structures. Infrared spectroscopy is provided and offers metrology approach to sensing through the display/input device/outfit, complementary to UV-VIS techniques that provide excellent sensitivity to layer composition, including chemical bond densities and free carriers with the enhanced immunity to roughness induced scattering.

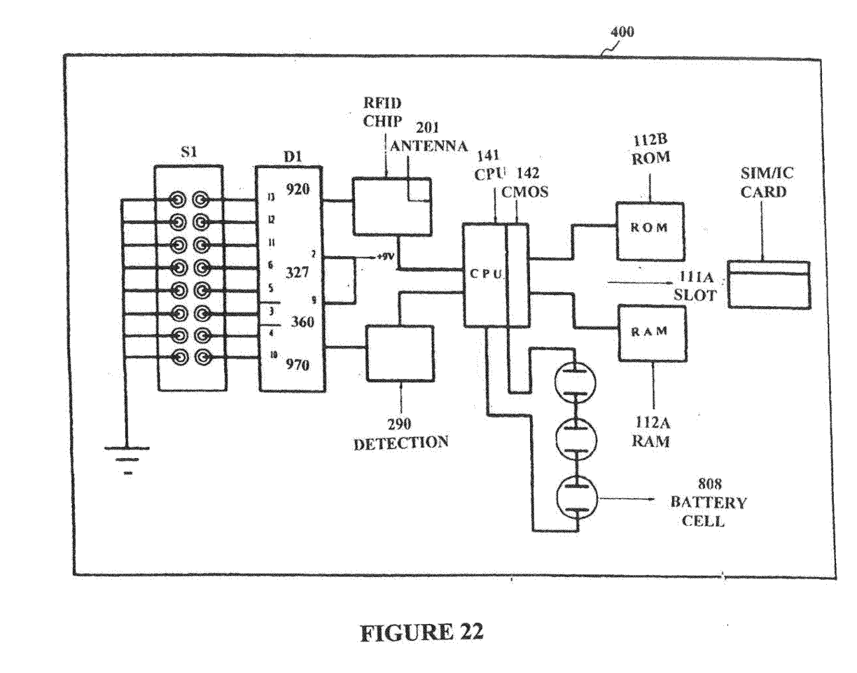

Referring to FIG. 22 is seen an embodiment of the circuit diagram of the communication apparatus comprising a privacy indicator. Switch (S1) is communicatively connected to RFID CHIP for signal amplification. Certain embodiments provide a common node display (D1) comprising touch screen operatively configured with multifunctional sensors 970. The display device is further operable for generating energy. RFID CHIP is operatively configured with antenna 201. A CPU 141 is operatively configured with detection device 290 communicatively connected to at least a CMOS 142. The detection device is responsive to detection signal communications and operatively connected to a battery cell 808. The communication apparatus 400 further comprises an IC and/or SIM card slot 111A comprising SD card slot and/or HDMI/USB ports. Embodiments further provide user identification card 112. The communication apparatus 400 comprises operating system consisting of software operatively configured with ROM 112B to read the ID card 112. The ROM 112B is communicatively configured to provide communications to the RAM 112A. The RAM 112A is responsive to communication database 113 where information may be stored or retrieved. A screen read-out 113A is provided configured with the communication apparatus. An 8-pin privacy indicator switch (S1) is operatively configured with the communication apparatus 400 and responsible for providing private communications. Switch (S1) comprises of display selections corresponding to cathode A, cathode G, and cathode D of at least a 7-segment common anode display settings (D1). Chip 200a comprises a detection tool responsible for providing communications to at least a network. The IC and/or SIM card 112 is further operable with the communication apparatus 400, comprising wireless communication applications in communication with a software program.

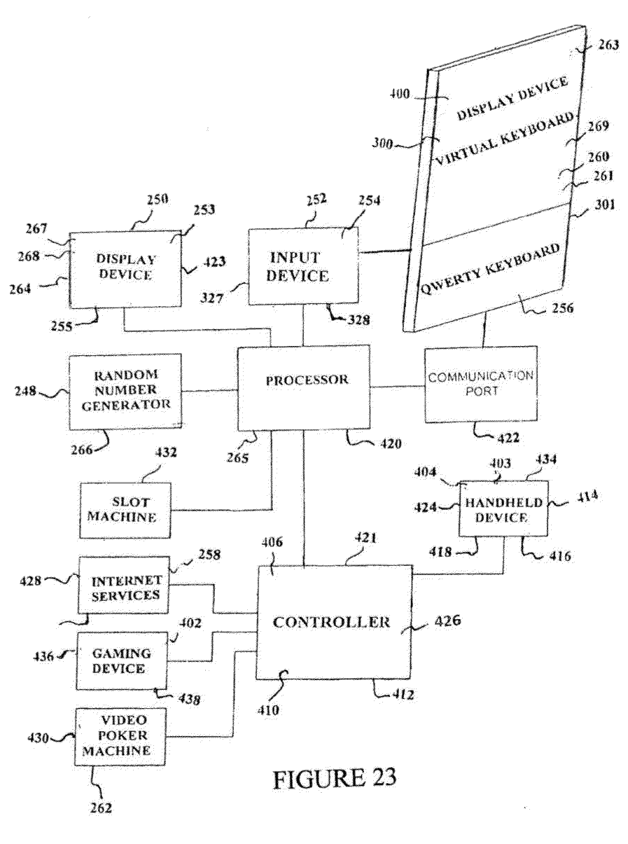

Referring to FIG. 23 is seen an exemplary embodiment of the communication apparatus. The communication apparatus 400 comprises at least an input device 252, including a keyboard 254. The keyboard 254 may consist of a virtual keyboard 255 and/or QWERTY keyboard 256 in further communication with a random number generator 248. At least a social network application 258 is configured with the keyboard and in communication with the processor 420. Disclosed embodiments further provide the keyboard being disposed on an LCD display screen 260 being configured with sensors 327 operable for object recognition. Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265, and camera 263. Disclosed embodiments further provide the communication apparatus further comprising at least one of: a mobile communication device 400, a gaming device 402, a media device 403, and an interface device 404. Disclosed embodiments provide the interface device comprising at least an integrated phone/PDA 400 being configured with integrated connectivity apparatus 406 operable to provide global roaming. At least a communication port 422 is provided with the communication apparatus 400. Certain embodiments of the disclosure provide the communication apparatus comprising a GSM phone 400 being operable on plurality microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video, and phone book.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still, other embodiments provide a communication apparatus comprising of carbon fiber 408 and/or silicon substrate microfiber consisting of resistive touch screen 260 and/or character recognition 269 and/or a communication board 300. Certain embodiments provide housing 301 for the communication apparatus 400 comprising a carbon fiber 408 and/or a silicon microfiber.

Disclosed embodiments further provide a communication apparatus being configured with at least a WAP browser 410 and/or an integrated GPS device 412 and/or an MP3 music device 414 and/or a camera apparatus 416 and/or an internal antenna apparatus 418 being configured with a controller 421 in communication with a predictive text messaging applications 423. The network further comprises a terrestrial radio frequency receiver 243 configured to receive media segments and associated communication apparatus 400 via radio waves from the terrestrial radio transmitter 242. The terrestrial radio frequency receiver comprises an antenna 201 and a CMOS 142. The antenna 243 is configured to receive radio waves of frequencies set by the CMOS 142 and the terrestrial radio frequency receiver 243 processes the radio waves into electric signals and sends the electric signals to the processing unit 122. Communication apparatus 400 associated with the media segments can include information such as a title of the media segment and a performer performing the media segment. The terrestrial waves include FM radio waves and AM radio waves. In one embodiment, the terrestrial radio frequency receiver 243 includes CMOS multiple antennas on chip, such that media segments can be received from multiple radio frequencies simultaneously.

Disclosed embodiment further provide a satellite radio comprising a radio frequency receiver 424 configured to receive satellite radio waves from the satellite radio transmitter 242, decrypt information received by the satellite radio waves, and to convert the information received by the satellite radio waves to signals that can be processed by the processing unit 122. Information received by the satellite radio waves includes media segments and associated communication apparatus 400. In one embodiment, the satellite radio frequency receiver 424 sends encrypted radio signals such as, when receiving media segments from subscription services to the processing unit 122, and the processing unit 122 decrypts the radio signals.

In alternate embodiments, media segments and communication apparatus 400 can be received via other types of wireless communications. Exemplary types of wireless communications include TV band communications such as: UHF and VHF band communications, wireless peer-to-peer communications accessing the Internet through at least one of: Wi-Fi and/or Wi-Max communications network, and cellular communications. The network interface 170 further comprises data network interface being provided to facilitate transmission and receipt of wireless communication via radio frequencies between the processing unit 122 and data networks such as an external network computer apparatus 24, the GPS device 412, and/or the messaging/personal scheduling device 423. In one embodiment, the wireless data network interface 170 accesses the network computer apparatus 24, the GPS device 412 and the personal scheduling device 423 utilizing wireless peer-to-peer communications such as Wi-Fi and Wi-Max communications. Some embodiments provide the network computer apparatus further comprising a computer network 24. Certain embodiments provide the communication apparatus 400 being configured with at least one of: infrared sensor 326, calendar 268, FM radio 424, Bluetooth technology 426, and GPRS Internet services 428. Disclosed embodiments further provide the communication apparatus 400 comprising a video poker machine 430 and/or a slot machine 432, and/or a handheld device 434 and/or a gaming device 436 and/or a play station 438 in communication with communication port 422.

The social network application 258 further comprises at least one science topics of information, including fashion world media consisting of a social platform for publicly declaring the will of positivism, sharing human knowledge for organized studies, dealings with the body of facts and truths to explain the phenomena of social media in the environment of natural fashion media, model media, and dress code media “FMDC,” exhibiting a dimension of social sustainability to gracefully improve corporate and community well being through social, cultural, environmental, and economic vision by the goodness of change. Change can be embraced with the hope for sustainable cultural independence.

FMDC is about public declaration, a social media consisting of a network that comprises of dynamic database driven platform that enables interactive web content creation, collaboration, and exchange. The network is a social platform for publicly declaring the will of positivism, comprising the gathering of human knowledge that are reliably organized for shared studies, dealings with the body of facts and truths governing a support system that acquires knowledge for human observations to explain the phenomena of social media in the environment of natural fashion media, model media, and dress code media “FMDC.” The FMDC network further comprises of a social platform for providing substance of things hoped for, revealing the evidence of things not commonly seen. This evidence of things not commonly seen is CHANGE, which can be embraced with the hope for sustainable cultural independence, for by CHANGE the society receives good reports that things which are seen were not spiritually made of things which do appear, but are made through creative minds and innovative discoveries that may lead to economic growth, not as a means of inquiry, but rather as a dimension of social sustainability to gracefully improve corporate and community well being through social, cultural, environmental, and economic vision by the goodness of change.

In reality, a socially sustainable community should have the capacity to deal with change and to adapt to changing situations and attributes that may be essential for globalization. FMDC network is a network of change, providing a communication environment that has the capability of moving data between storage areas sufficiently scheduled for media communications for reasons of performance and convenience, establishing private communication environment for individuals and groups such as colleges, universities, churches, stores, organizations, cultural entities, businesses, corporations to explain the phenomena of social media in model media, fashion media, and dress code media, communicating to one another through a centralized system.

The human knowledge is organized bodies of knowledge that are shared by people so as to produce useful feeds that comprise of reliable knowledge about at least an FMDC topics of information to aid and educate the society through the environment of social enterprise. Social enterprise consist of social measurements relating to the way society operates through a systematic examination of truth, existence, reality, causality, exhibiting the freedom of shared knowledge relating to at least one FMDC topics of information. Social measurements comprise of asserting the influence of FMDC for the betterment of the society by contributing to product offerings through a blend spirit of positivism and methodological evolution of information backed by the organizing principles underlying the science of Fashion, Models, and Dress Code.

The methodological evolution of FMDC information is embodied for societal change that comes with time, and time blends with technologies and innovations. That is why FMDC sharing is embodied to change the way knowledge is derived about an object, a business, a corporation, an institution, an educational institution, a testimony, a Pastor, an art, an event, a project, a play, a book, a culture, a Bishop, a struggle, a success, the society and its environment. Social measurements further leads to generational awareness, brand awareness, leadership awareness, business awareness, corporate awareness, educational awareness, professional awareness, ethical awareness, religious awareness, institutional awareness, social awareness, cultural awareness, sociological awareness, professional awareness, causal awareness, and service efficiency to the society relating to the positivism in fashion media, model media, and dress code media. Individuals, businesses, corporations, religious groups, cultural groups, and community organizations/associations must have the freedom to choose how to improve their product life in the context of fashion media, model media, and dress code media for their product line. Just as true prophecy never come by the will of man, but from God through the Holy Spirit to bring Lamb upon our feet and Light upon our paths, so must the positivism of good products/objects be lightened to bring out the truth by modeling the products/objects to create a clear path for knowledge and economic growth.

Social enterprise further includes bringing the actualization of potentials in Fashions, Models, and Dress Codes “FMDC” through an objective reality of social bodies being shared in a shared environment by observers that are governed in the support system. The support system is communicable through electronic network environment by means of observation to sharing a common reality that is not commonly absolute by all observers. The shared environment further comprises the Internet comprising electronic communication environment for sharing productive/objective topics of information on the FMDC network. The support system further comprises a dynamic website that includes dynamic database driven web-pages by means of server site programming. Certain embodiments of the dynamic website provide a support system that comprises of a platform for client site programming operable for communicating with the dynamic web-pages. The support system is further configured with interactive interface. The interactive interface is configured with a software based system that provide peer-to-peer communication environment to enable knowledge based sharing system that is properly configured for efficient communications and that supports decision making. A multicast approach may be employed to deliver these communications between clients within the network and to update the network with additional tools for further interactions and/or interactive communications. The multicast approach includes technologies to deploy the multicast service in existing multiprotocol label switching virtual private network “MPLS/VPN” for transmitting multicast data between FMDC clients within the FMDC network through their private networks by encapsulating the original multicast packets.

The organized bodies of knowledge through the support system would allow the mind and spirit of observers to generate its own reality, in that, what is true in one observer's mind may not be true for other observers. The reality here comprises of the knowledge of positivism, which is the knowledge based on actual positive sense in near real physical, visual and/or virtual experience based on social and/or sociological facts that may lead to economic knowledge in social values. For example, just as a human brain may be pronounced dead by a doctor, the heart in that same body may bring to life another separate body of faith in need of a heart transplant. This is the spirit of positivism.

The dynamic website is provided and configured for generating dynamic database driven web-pages using server site programming tools. The dynamic website comprises a platform for client site programming in which a client would have to log into the website to create a user account to enable an access point. Once the access point is enabled, client would be allowed access to do at least one of: Model themselves, Model their product, Model their jobs, Model their hobbies, model their favorite shows and participants of the shows, model their company, Model their favorite sport and/or the best player for that sport, Model their state, country, government, president, governor, model their educational institutions, model their professions, model their professors, model their favorite stars, minister, CEO, curses, books, authors, schools, etc.

Client would be allowed access to Fashion their Models and to describe and/or prescribe a Dress Code for their models. Upon completion and clicking the complete button, a web-page and/or a virtual private network “VPN” would be established for the client account and the client would be able to share or connect with others, friends, and people in the centralized FMDC organizational network of Models, Fashions, and Dress Codes. The presentation of models, fashions, and dress code contents must be created by clients, and FMDC network would moderate the contents. Clients would display FMDC account on their blog or on user profiles that they own on other social networking accounts. Thus, in turn, gives you more back-links and more attention. Community members would be able to create or be part of a subculture within the FMDC network. Let the voice of the community create an existing model based on the community cultural interest. Let the voice of a religion affiliation create a model based on their culture. The VPN is a private network within FMDC network that uses a public network such as the Internet to connect clients at remote sites together in FMDC network. Instead of using a dedicated, real-world connection, such as leased line, the VPN uses virtual connections routed through the Internet from remote sites of clients to the FMDC network. VPN permits secure, encrypted connections between FMDC network and clients' private network at remote sites. FMDC may act as a third-party service provider between clients and their observers. The VPN is to connect clients in the network with other clients in the same network, forming intranet/extranet VPN or network gateway, while providing better features such as:
Security
Reliability
Scalability
Network Management
Policy Management

Additionally, data in each account would constitute a packet. Each packet would be assigned a label so that data from one client to another client would be directed on short path labels to enable high performance network communication environment through multiprotocol label switching “MPLS.” The labels may be configured to identify virtual links comprising paths between distant notes or switches. The multiprotocol label switching network approach would allow data packets forwarding decision to be made solely on the contents of the label without examining the packet itself. With this design approach, circuits would be controlled across any type of transport medium using any protocol. Usernames and passwords are stored on the VPN termination device server, or on an external server, which would provide authentication to numerous other databases such as Windows NT, Novell, and LDAP. The MPLS would be able to route packets through the network by utilizing “label switching” which comprises tagging or labeling high priority traffic and routing those packets through FMDC high capacity circuits and routing non-critical data through low cost, low capacity circuits consisting of a single integrated IP network that is highly optimized.

What MPLS brings is the ability to create reliable VPN without the use of VPN clients reducing the level of management and deployment complexity considerably. The advantage of MPLS in FMDC network is that it eliminates multiple routers, firewalls and IT management headaches from all of the remote locations by putting control and management of the entire network into one center such as the main FMDC network. The backing of the MPLS VPN Solution would allow FMDC network to provision among other things, and manage intranet and extranet VPNs within the network. Other configuration may provide the FMDC network designed as a multipoint technology to making specific VPN tunneling unnecessary, so that when data is moved from one client site to another, it would look up the client site in the routing table, adds a tag for that site, and sends the packet to the next router. With this embodiment, latency is reduced for client inter-site data transfers. Embodiment also provides flattened wide area network designs, thereby simplifying engineering approach to delivering data between clients in the network. This approach requires clients' remote sites to be connected to FMDC network through MPLS network.

When a request to establish a tunnel “the process of encapsulating an entire packet within another packet and sending it over a network” comes in from a client, the VPN software would prompt for a username and password. This must be authenticated or sent to the external server, which would check for:
Who the client is (Authentication)
What the client is allowed to do (Authorization)
What the client actually does (Accounting)

The accounting information is especially useful for tracking client activities for security auditing, billing or reporting purposes

The VPN comprises a social VPN created automatically for individual client within the FMDC network. The creation is based on relationships established by clients through the FMDC network. The VPN is desired for providing peer-to-peer network connectivity between a client and his or her friends, in an easy to set up manner that hides from the client the complexity in setting up and maintaining authenticated/encrypted end-to-end VPN tunnels.

The architecture of the Social VPN further comprises a centralized infrastructure where clients/users authenticate, once the account is confirmed, clients would then be allowed access to display their models, fashions, and dress code and be discovered by their friends whom they have exchanged cryptographic public keys with. This is enabled by a peer-to-peer overlay which is used to route messages and deliver videos between VPN endpoints.

The VPN is configured for communication with a virtual network interface that includes tap/tun devices in Windows and Unix systems to capture and inject the IP packets from the FMDC network. Once captured, packets are encrypted, encapsulated, and routed over an overlay network. The VPN is further configured for FMDC online social network communications with the capability to distribute public keys and advertise node address to friends. The acquired public keys are necessitated to establish encrypted communications between two endpoints. In this manner, symmetric keys are exchanged during the process of establishing end-to-end links by FMDC peers in the network. Routing in the FMDC Social VPN is a peer-to-peer that is structured for communications within the system for sending IP packets that are encapsulated in overlay messages from a source to destination.

Within the FMDC Social VPN, a dynamic IP address is assigned and translated to avoid collision with existing (private) address spaces of the network, allowing the system to scale to the number of clients/users of the network to successfully maximize the FMDC online social network service serviceable for millions of clients. Clients would be able to connect directly to a subset of the total number of clients with access to their topics of information within the FMDC network. The subset is determined by clients established relationships. Each client would be assigned VPN names derived from the FMDC social network services to serve as the assigned host names to endpoints. These names are translated to virtual private IP addresses in the overlay by a loop-back DNS virtual server.

A model is a representation of a system that allows for investigation of the properties of the system and/or prediction of the future outcomes. A model comprises of many shapes, sizes, and styles. It is important to emphasize that a model is not just the real world object but also consist of human construct to help the society better understand real world systems. A model should at least have an information input, an information processor, and an output of expected results, and should provide an environment where:
simplifying assumptions must be made;
boundary conditions or initial conditions must be identified
the range of applicability of the model should be understood

This may include conceptual models that consist of qualitative models highlighting important connections in real world systems and processes as a first step in the development of the more complex models. People receive information, process this information, and respond accordingly many times each day. This sort of processing of information is essentially a conceptual model of how things in our surrounding environment actually work.

An exemplary embodiment of “The Sun model:” 1.) The intensity of scattered light from the atmosphere increases with decreasing wavelength. 2.) The intensity of scattered light is inversely proportional to the 4th power of wavelength.

An exemplary embodiment of “A model of the Inventor:” Fearfully and wonderfully created by a Father who is a mighty warrior, great in battles, fearful in praises, and just to forgive, the Alpha and the Omega, who seeded me in a human body through spiritual encounter in human interaction, trusted unto them as parents who knew Him not. “Fashion of the Author:” Publicly declaring His name, His works, His wills, His gift, His passion, His everlasting Love for me in Christ Jesus, who is the word of God and who has put every spirit of darkness to shame in the grave. “Dress code of the Author:” The Holly Spirit.

An exemplary embodiment of “A Church Model:” 1.) A model for Christian growth and Church growth. 2.) A visible structure consisting of people of faith united by their participation in God's spirit through Christ Jesus, transmitting his visible signs and invisible grace by faith, exhibiting personal proclamation over interpersonal relations and mystical communion as part of a total human family acting in union with the flow of God's Kingdom life.

An exemplary embodiment of “Church Leadership Fashion/Model:” 1.) A good shepherd lay down his life for his sheep. 2.) One who leads by modeling godliness and righteousness in his own life and encouraging others to follow his example in Christ Jesus. A model may also be visualized as a visualization model. Visualization models comprise of direct links between data and some graphic or image output that may be linked with other type of models to convert the intended output into a visually useful format.

A model may also consist of abstractions of reality to deliberately emphasize one part of the reality at the expense of other parts. This is necessary due to objective power limitations, and may enable others to focus their attention on an important aspect of the model. Models are also mathematical, logical, business, corporate, or some other structured representation of reality consisting of the specific applications of the models to arrive at some outcome.

Fashion is an art, ultimately consisting of individual statement of expression. It is also a religion, a job, a peek into a personality, playfulness, an escape, or a disguise. Fashion is a feast for the eyes. Fashion is not something that exists in dresses only. Fashion is in the sky, in the streets, and has to do with ideas, the way we live, what is happening around the society. Fashion isn't defined solely by clothing choices, but it is also conveyed through the way we carry ourselves, our personalities and our views of the world. Fashion comprises of a prevailing style, custom, dress, or behavior.

Fashion also comprises fashion trends, consisting of anything which is popular in a culture at any given time. Fashion is inclusive of areas such as; style of dress, cuisine, literature, art, architecture, and structures, fashion trends and many other popular factors. Though fashion trends often change rapidly, fashion is often used to describe the latest version of these trends. Fashion is also used positively as a synonym for style, glamour and beauty. However, fashion can also be expressed to have negative connotations of fads and trends, and materialism.

Dress Code is a set of rules governing what garments may be worn together and in what setting to convey a social message. Clothing can convey a social message, even if none is intended. If the receiver's code of interpretation differs from the sender's code of communication, misinterpretation follows. In every culture, current time fashion governs the manner of consciously constructing, assembling, and wearing clothing to convey a social message. Clothes convey other social messages, including the stating, claiming personal, cultural identity, establishing, maintaining, defying social group norms, and appreciating comfort and functionality.

The platform further comprises the virtual private network (VPN), which is a network that uses primarily public telecommunication infrastructure, such as the Internet for connectivity, to provide remote offices that include addresses, blogs, link-sites, websites, and/or traveling client/users through to allow access to topics of information in the central organizational network for the distributions of data relating to potential knowledge in models, fashion, and dress code. The VPN typically requires remote users of this network to be authenticated and secure data with encryption technologies to prevent disclosure of private information to unauthorized parties. The VPN may serve any network functionality that is found on any network, such as sharing of data and access to network resources such as printers, databases, websites, etc. In this regard, a VPN user typically “registered users” would be able to experience the central network in a manner that is identical to being connected directly to the central network. The VPN further includes a technology via the public Internet to replace the need to requisition and maintain expensive dedicated leased-line telecommunication circuits found typical in wide-area network installations. Further benefit of the virtual private network technology includes costs. The VPN reduces costs because it would not need physical lease lines to connect remote users to the Intranet “a network of computers, using World Wide Web conventions, accessible only to authorized users within a company” operations. The VPN system is classified by:
The protocol used to tunnel the traffic; the tunnel's termination point, i.e., customer edge or network-provider edge; whether they offer site-to-site or remote-access connectivity; the levels of security provided; the OSI layer they present to the connecting network, such as Layer 2 circuits or Layer 3 network connectivity

The VPN security comprises of cryptographic tunneling protocols to provide:
Confidentiality by blocking intercepts and packet sniffing and for allowing sender authentication to block identity spoofing and message integrity by preventing message alteration

The MPLS is a platform consisting of a mechanism in high-performance telecommunication networks that directs data from one network node “one registered member” to the next “registered member” based on short path labels rather than long network addresses, so that long complex lookups in a routing table would be avoided. In this embodiment, the labels would identify virtual links (paths) between distant nodes “terminal or points in the network where a message/data can be created, received, or transmitted” rather than endpoints “transmitting and receiving.” The MPLS should be able to encapsulate packets “message or part of a message packaged as a fixed-size segment of data for transmission through the FMDC network” for communications with various network protocols. The MPLS should also be able to support a range of access technologies, including T1/E1, Tier1, Tier2, Tier3, ATM, Frame Relay and DSL. The MPLS is highly scalable, protocol agnostic, and further comprise of data-carrying mechanism. In FMDC MPLS network, data packets are assigned labels. Packet-forwarding decisions are made solely on the contents of this label, without the need to examine the packet itself. This would allow the FMDC network to create end-to-end circuits across any type of transport medium, using any protocol. The primary benefit is to eliminate dependence on a particular OSI model data link layer technology, such as Asynchronous Transfer Mode (ATM), Frame Relay, Synchronous Optical Networking (SONET) or Ethernet, and also eliminate the need for multiple layer-2 networks to satisfy different types of traffic. The FMDC MPLS network consists of a family of packet switching networks.

The platform further comprises a decision support system (DSS), consisting of a computer-based information system that supports business or organizational decision making activities. The DSS would be able to serve the management, operations, and planning levels of our organization and help us to make decisions, which may be rapidly changing and not easily specified in advance.

The DSS is a knowledge based system consisting of interactive software-based system intended to help organization decision makers compile useful information from a combination of raw data, documents, personal knowledge, or business models to identify and solve problems and make decisions for the company to enable serve our users better. The decision support application includes gathering of information such as: inventories of information assets (including legacy and relational data sources, cubes, data warehouses, and data marts), comparative sales figures between one period and the next, projected revenue figures based on product sales assumptions.

The platform further comprises means for communicating with servers, including computer programs running to serve the requests of other programs such as the clients. The server is configured to perform some computational task on behalf of “clients”. The clients may either run on the same computer or connect through the network. The servers are also physical computer such as a computer hardware system dedicated to running one or more such services as host, to serve the needs of users of the other remote computers on the network. The services further require a database server, a file server, a mail/email server, a print server, a web server and other servers to support the efficient operation of the network. At least one server may operate as a socket listener to provide other essential services across the network, either to private users inside a large organization or to public users via the Internet. For example, a query is routed in a search engine server from client computer over the internet to the servers that store all the relevant web pages. The results are sent back by the server to client computer. Our network environment would employ the following servers:
Application server, a server dedicated to running certain software applications
Catalog server, a central search point for information across a distributed network
Communication server, carrier-grade computing platform to enable network communications
Database server, provides database services to other computer programs or computers
Fax server, provides fax services for clients
File server, provides file services
Sound server, provides multimedia broadcasting, streaming.
Standalone server, an emulator for client-server (web-based) programs
Web server, a server that HTTP clients connect to in order to send commands and receive responses along with data contents
Client server, almost the entire structure of the Internet is based upon client server model. Other servers would include high-level root name server, DNS server, and routers operable to direct traffic on the internet to our platform.

The platform further include a multicast for the delivery of a message or information to a group of destination client computers simultaneously in a single transmission from the FMDC network “the source” creating copies automatically in other network elements, such as routers, only when the topology of the network requires it. The multicast is commonly implemented in IP multicast, which is employed in Internet Protocol (IP) applications of streaming media and Internet television. In IP multicast the implementation, the multicast concept would occur at the IP routing level, where routers create optimal distribution paths for data-grams sent to a multicast destination addresses. At the Data Link Layer, multicast describes one-to-many distribution such as Ethernet multicast addressing, Asynchronous Transfer Mode, (ATM) point-to-multipoint virtual circuits (P2MP) or Infiniband multicast. The platform further includes a packet consisting of a formatted unit of data that is carried by a packet mode computer network. Computer communications links that do not support packets, such as traditional point-to-point telecommunications links, simply transmit data as a series of bytes, characters, or bits alone. When data is formatted into packets, the bitrate of the communication medium can be better shared among users than if the network were circuit switched.

The FMDC network further comprise a platform comprising of a neural network consisting of an interconnected group of artificial neurons that processes information using a connectionist approach to computation. The neural network may include an ANN consisting of an adaptive system that changes its structure based on external or internal information that flows through the network during the learning phase. The neural networks may further comprise of a non-linear statistical data modeling tools for modeling complex relationships between inputs and outputs or to find patterns in data. The neural network may further be configured with network element, being defined as a manageable logical entity uniting one or more physical devices. This would allow distributed devices to be managed in a unified way using one management system such as the centralized FMDC network.

According to Telecommunications Act of 1996, the term ‘network element’ means a facility or equipment used in the provision of a telecommunications service. Such term also includes features, functions, and capabilities that are provided by means of such facility or equipment, including subscriber numbers, databases, signaling systems, and information sufficient for billing and collection or used in the transmission, routing, or other provision of a telecommunications service.

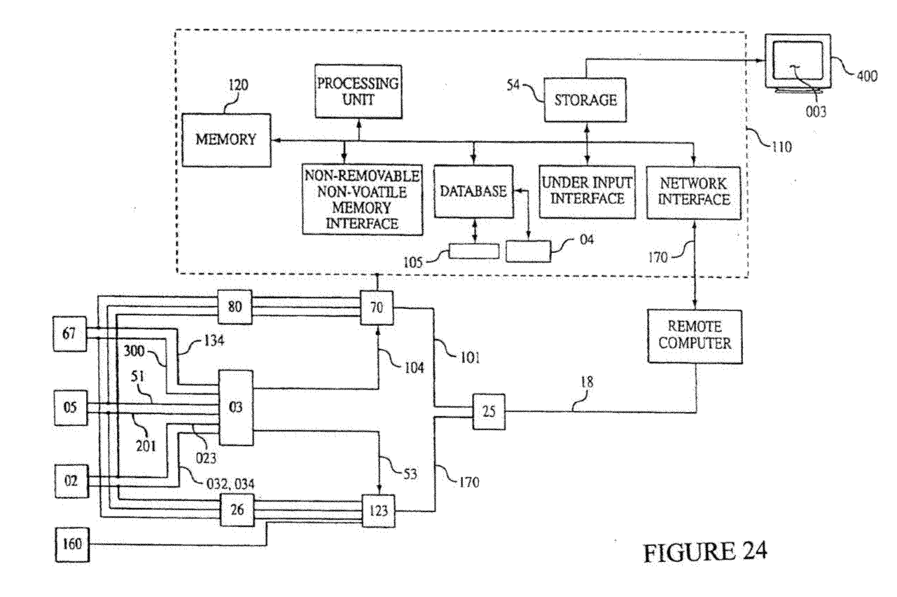

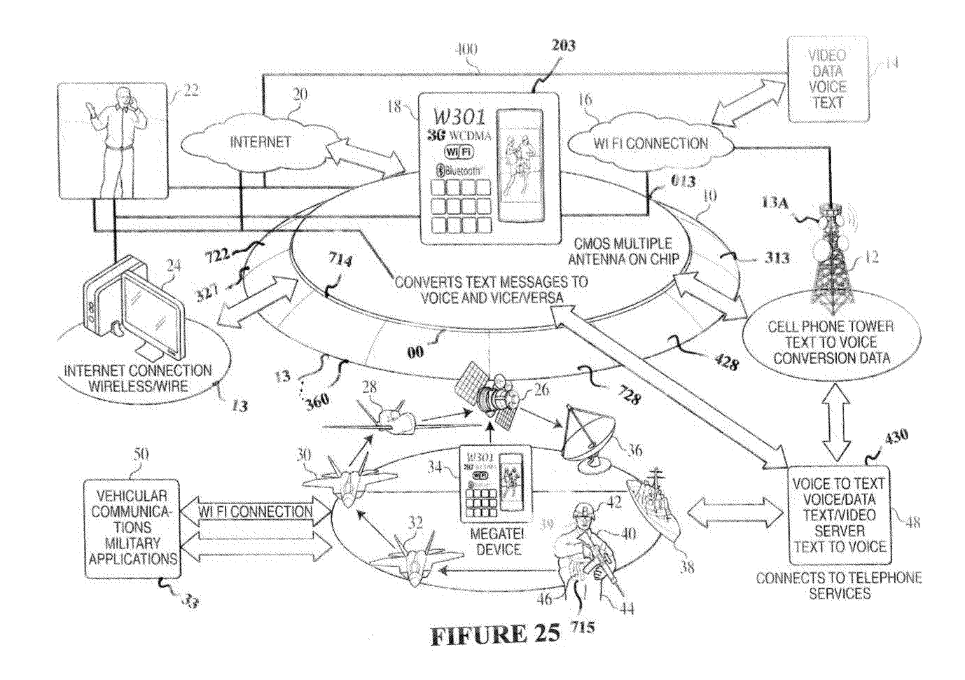

Referring to FIG. 24 is seen further exemplary embodiment of the communication apparatus 400 comprising, storage medium 54, a processing unit 122, and CMOS 142, in communication with a memory device 120. Disclosed embodiments further provide a non-removable non-volatile memory interface, a database, input interface and network interface 170. Certain embodiments provide a communication apparatus comprising hardware 105, a graspable hardware/browser 04, and a display device 003. Other embodiments provide a communication apparatus 400 comprising software 300, central processor 51, a RAM 05, a ROM 02, a network adaptor 160, and a media device 201. Disclosed embodiments further provide a communication apparatus 400 comprising at least an output device 70, a remote computer in communication with a connection key 25. The connection key is further in communication with industrial files 18, network files 110, decision engine 123, graphic user interface 101, sensors 104, and system memory 53. Certain embodiments provide a communication apparatus being further configured with system bus architecture 67 in communication with an input device 80. Some embodiments provide the output device 70 further comprises a report generator 134 in communication with an instruction program 26. At least a CPU 03 is provided, in communication with a java class 023, a clickn Vest Servlet class 032, and a Servletrunner application 034.

Referring to FIG. 25 is seen exemplary embodiment of the disclosure, comprising a communication apparatus 400 in communication with CMOS multiple antennas on chip 10. The CMOS multiple antennas on chip is configured with silicon substrate microfiber/nano-fiber. Disclosed embodiments provide the CMOS multiple antennas on chip configured for communications and for converting text messages to voice auditory messages and for converting voice messages to text messages. The CMOS multiple antennas on chip is configured for installation on cell phone towers 12, further operable for converting electromagnetic radiation into electrical energy. Certain embodiments provide the CMOS multiple antennas on chip comprising a video data/voice text device 14. Some embodiments provide the CMOS multiple antennas on chip operable for WiFi connections 16. Other embodiments provide the CMOS multiple antennas on chip comprising at least a receiver apparatus and/or a transmitter apparatus for communication device 18. The communication device may comprise at least a 4 G and/or at least a 5 G communication device operable on at least a millimeter wave spectrum. The communication device may comprise a 4 G and/or 5 G operable on a WCDMA and/or a WiFi network. Some embodiment provides the communication device comprising an energy harvesting smart phone “E-PHONE.”

The computer network 24 further provides information including a media segment guide and information utilized to update fields of the database 113. The guide further includes software program 300 in communication with a plurality of media segment identifiers along with availability information associated with each media segment. In one embodiment, the software 300 provides information including a plurality of media segment identifiers, an available time associated with each media segment, such as the time at which the media segment is broadcast, and access information associated with each media segment identifier, including information from the radio station that the media segment will be broadcast on. In other embodiment, the media segment software 300 is periodically updated within the storage medium 54. Disclosed embodiments provide the media segment software 300 being downloaded from the Internet. In an alternative embodiment, the software 300 is stored externally such that a system for exhibiting media segments may access the software 300 from the Internet, but the system for exhibiting media segments does not store the software 300. Disclosed embodiments provide the GPS device 412 further configured to provide information relating to a global position. In one embodiment, the GPS device 412 provides GPS coordinates indicative of a current global position of the network 24. In one embodiment, the GPS device 412 communicates to the network 24 through the communications apparatus 400. In one embodiment, the GPS device 412 communicates with the network 24 either wirelessly or through communication wires.

The storage medium 54 further comprises a storage device for storing digitally encoded data. Exemplary storage devices for the storage medium 54 include flash memory storage devices, magnetic hard drive storage devices, solid state storage devices, and like data storage devices. Some embodiments provide the storage medium 54 comprising a single storage device accessible by the processing unit 122. Certain embodiments provide, the storage medium 54 comprises multiple storage devices, wherein each storage device is accessible by the processing unit 122.

The data stored by the storage medium 54 includes data associated with the software 300, data associated with a memory device 120, data associated with recorded media segments 201, data associated with a database 113, and data associated with other processing software 023. The memory device 120 includes media segment identifiers that identify media segments available for exhibition. In one embodiment, the media segment available for exhibition includes recorded media segments and media segments data that are available to be received from the remote communication devices via the communications apparatus 400. Other embodiments provide the media segment identifiers of the memory device 120 are associated with user selection preferences. In one embodiment, the media segment identifiers of the memory device 120 are associated with media segments having high user selection scores. The recorded media segments include data that are processed by the processing unit 122 for exhibition by the media segment controller 421. In one embodiment, the recorded media segments are stored in a compressed media storage format that can be decompressed by the processing system utilizing the processing software 023. The database 113 includes both a storage structure and several records that are stored, accessible, and updateable within the storage structure to define a user selection criteria database. Each record includes a user selection criteria field and a score field associated with the user selection criteria field.

The user selection criteria field includes criteria descriptive of a particular media segment. Disclosed embodiments provide the selection criteria comprises of non-limiting examples wherein the user selection criteria field can include criteria descriptive of a particular media segment comprising at least one of: fashion, model dress code, soccer news, short story reading, science, plasma physics, Performer, Rock Band, soul music, electronic-commence, electronic tailing, electronic market place, talk, music, electronic learning, news, world news, local news, world weather, local weather, national weather, national sports, local sports, regional information, football news, out of class learning, movies, country music, surf music, fast beat music, melancholy beat music, worship, Christmas music, games, plays, events, and song title. The exemplary listing of user selection criteria fields exemplifies that the user selection criteria fields can cover a large number of media segments or a small number of media segments. Disclosed embodiments provide a listing that exemplifies a single media segment and/or a segment greater than at least one user selection criteria fields associated therewith, and the database can contain at least one user selection criteria fields.

The score field includes values and algorithms that are associated with the user selection criteria field. In one embodiment, the algorithms include complex algorithms wherein the algorithm has variables associated with several user selection criteria fields, wherein each field is given a different level of weight when associating the selection criteria with the media segments. Certain embodiments provide the score field being updated based on a user selection from the directory. Some embodiments provide the score field being updated based on external modification values. In one embodiment, the external modification values are based on collaborative data based on other users having similar tastes in media content. The collaborative data can be stored on a database of the computer network 24. The collaborative data can include selection data from multiple users and can be analyzed to predicted future preferences of any one of the users based upon past selections of the multiples users. The collaborative data allows the communication apparatus 400, in association with the software 300, to score media segments based on information regarding the interests of several people. The communication apparatus 400 can access the collaborative data via the computer network 24. In one embodiment, the score field is updateable by accessing transactional information from the electronic commence, for example information relating to items purchased by the user, items purchased by other people having a similar taste to the user, and items recommended by other people. In one embodiment, the external modification values are based on information.

The E-PHONE comprises a smart phone disposed with a housing made of silicon substrate microfiber comprising a solar cell platform. The housing could be a combination of both solar cell material and piezoelectric element. The reason is to increase the energy efficiency since solar cell is band gap limitation. Certain embodiment provides the communication apparatus comprising a CMOS multiple antennas on chip, being embedded on a communication circuit board 13. The shorted end is configured with nano-wires in association with a rectifying circuit capable of harvesting microwave and infrared power, and converting these powers and/or electromagnetic radiation into electrical energy. The communication circuit board further comprise a platform for converting solar energy into DC power and for converting electromagnetic radiation into DC power. The rectifying circuit may comprise of a thin oxide layer for measuring the voltage, providing a platform for converting electromagnetic radiation and solar energy into DC power. Because photovoltaic cells are only 35-40 percent efficient, converting electromagnetic radiation into usable power is required since the rectifying circuit is not band gap limitation and would harvest energy based on the wave behavior of light. The nano-wires provide good electrical properties, and may consist of gold. Disclosed embodiments further provide the communication device comprising at least a Bluetooth. Certain embodiments provide the CMOS multiple antennas on chip further comprising Internet device 20, operable for communications and for providing faster data transmission and communication clarity. The Internet device further comprises at least a handheld device 22. Some embodiments provide the Internet device further comprises a computer apparatus 24 configured for wired/wireless Internet connectivity in association with the millimeter wave spectrum. Other embodiments provide the Internet device comprising apparatus operable for Intranet communications. Disclosed embodiments further provide the CMOS multiple antennas on chip device comprising at least a transceiver apparatus 26. Certain embodiments provide the transceiver apparatus further comprising at least aircraft 28. Some embodiments provide the transceiver apparatus further comprises at least airplane 30. Other embodiments provide the transceiver apparatus further comprises military craft 32, at least a vehicle 33 comprising a mobile backhaul link. Disclosed embodiment further provides the backhaul link comprising multiple antennas being opened on one end and shorted on the other end. At least the shorted end is disposed with nano-wires/tubes 714 operable for converting electromagnetic radiation into DC power.

At least an acoustic sensor 203 is configured with the circuit board 13 for providing other source of energy harvesting platform within the environment where the phone may be used. The acoustic sensor 203 is in association with the CMOS multiple antennas 201 to harvest energy from two fronts. 2A.) The acoustic sensor would convert sound waves “Voice communication” into usable energy. 2B.) The CMOS multiple antennas is further disposed on a circuit board 13, which is further made of solar cell platform to convert electromagnetic radiation and solar energy into usable energy. Because the energy from the acoustic sensor depends on the sound level, the acoustic sensor is not a stand alone alternative to energy harvesting.

The E-PHONE is an energy harvesting phone, and each day we do not account for the areas of energy that are being used. When we dial a number using our phones, we are actually applying pressure on the surface of the phone, which is another phone of energy. Some people go jugging with their phones attached to their bodies. The incorporation of the piezoelectric element on the display or in association with the phone housing provides a sensory platform for converting force/vibration into electrical energy. This is an optional configuration for energy harvesting. The touch screen, in other embodiment, is part of the E-PHONE because any amount of pressure on the surface could be converted into electrical energy. The touch screen device is also configured with the communication circuit board. However, the touch screen could be a stand alone device. Disclosed embodiment further provide a cell phone case disposed with a converter affixed on a male USB port, similar to the conventional charger inserts for smart phones. The converter is configured to convert one form of energy into DC power and is connected to the case by a flexible elastic structure. The flexible elastic structure may comprise of an elastic ribbon-like structure with conductive nano-wires.” The DC power is further directed to the conventional female charge port for smart phones through the male USB port to keep the battery charged “Battery circuit.” Some embodiment provide a meta material structure cavity 722 and nano-sensors 327 and 360 are further embedded in the solar cell material to provide an electromagnetic wave transport stream for electromagnetic wave absorption. In this endeavor, the electromagnetic energy would be converted into DC power to compensate for the band gap limitation of solar cell and to increase the efficiency of the energy harvesting cell phone case 715 and the E-PHONE.

Disclosed embodiments further provide the transceiver apparatus 313 and 428 further comprising at least a portable communication device 34. In the disclosure, the transceiver apparatus may comprise at least a stationary communication apparatus 36. Certain embodiments provide the transceiver apparatus further disposed on at least a vessel apparatus 38. Some embodiments provide at least military personnel 39, being outfitted with the transceiver apparatus, comprising at least a battlefield gear consisting of at least one of: a camouflage 40 and 44; a head gear 42; a communication apparatus 46. Other embodiments provide the transceiver apparatus further comprising communication apparatus 48 configured to connect to at least a telephone service. The telephone service may comprise at least voice to text monitoring/transmission, voice data monitoring/transmission, text data monitoring/transmission, video data monitoring/transmission, text to voice, and server data monitoring/transmission. The transceiver apparatus further comprises vehicular communication apparatus 50. Disclosed embodiments further provide the vehicular communication apparatus further operable for military applications. Some embodiments provide the vehicular apparatus further comprises at least a mega telecommunication apparatus “MEGATEL.” Certain embodiments provide a communication apparatus 400 comprising at least of: a transmitter apparatus; a receiver apparatus; a transceiver apparatus.

Disclosed embodiment further provides a base station 13 comprising a cellular communication system for providing wireless communication among wireless users 22. The base stations 13 may include a stationary and at least a mobile base station disposed with low and high speed wireless transceivers, a connecting station comprising a millimeter wave spectrum 00, a wireless transceiver 313 is configured to communicate at millimeter wave frequencies higher than or between 30-300 GHz with a fiber optic or high-speed cable communication network 12. The base stations are constructed with CMOS multiple antennas on chip and disposed with nano-wires for harvesting energy from electromagnetic wave. The chip is further embedded on a solar cell platform for energy harvesting. The antennas are opened at one end and shorted on the other end and serve as a separate communication cell. The shorted ends are further configured with the nano-wires disposed for harvesting the heat due to electromagnetic radiation, converting the heat into electrical energy. Embodiment further provide multiple base station 13 equipped with low frequency wireless transceiver 313 for communicating with the wireless users within the communication cell at a radio frequency lower than 6 GHz and with a millimeter wave wireless transceiver 428 operating at a millimeter wave frequency higher than 60 GHz. Some embodiments provide the wireless transceiver operable for communicating with another millimeter wave transceiver 728 at another base station or a millimeter wave transceiver 428 at the connecting station. The connecting station may comprise a backhaul link 13A. At least a data transfer device 430 in association with a database is operable for transferring data communicated through the low frequency wireless transceiver 313 to the millimeter wave wireless transceiver 428, 728. The data transfer device is operable to transfer data communicated through the millimeter wave wireless transceiver 428, 728 to the low frequency wireless transceiver 313. The low frequency wireless transceiver may comprise one cellular base stations or a mobile base station.

The E-PHONE device comprises of nanotechnology application comprising sensors embedded in silicon substrate microfiber. The E-PHONE comprises a fully integrated CMOS multiple antennas from RF to millimeter wave frequencies using a scalable Orthogonal Frequency Division Multiplexing with Multiple Access (OFDMA). Embodiment further provides the E-PHONE, further configured to utilize WiMAX for “wireless” broadband. WiMAX (Worldwide Interoperability for Microwave Access), an evolving standard for point-to-multipoint wireless networking, and works for the “last mile” in the same way that Wi-Fi “hotspots” work for the last one hundred feet of networking within a building or a home. In addition to “last mile” broadband connections, WiMAX has a number of other applications in hotspots, cellular backhaul and in high speed enterprise connectivity.

Certain embodiment provides the CMOS multi-antenna comprising a receiver front-end capable of accommodating various multi-antenna schemes including spatial multiplexing (SM), spatial diversity (SD), and beam forming (BF). The use of orthogonal code-modulation at the RF stage of multi-antenna signal paths enables linear combination of all mutually orthogonal code-modulated RF received signals. The combined signal is fed to a single RF/baseband/ADC chain 13. The primary advantages of this architecture include a significant reduction in area and power consumption. Some embodiments provide a path-sharing of multiple RF signals to mitigate the issues of LO routing/distribution and cross-talk between receive chains. The system is operable to exhibit system-level analyses of variable gain/dynamic range, bandwidth/area/power trade-off, and minimize interference. The millimeter wave network is further operable at frequency band of 8-38 GHz, 71-76 GHz, 81-86 GHz, and 92-95 GHz, and at data delivery/wireless connectivity at gigabits per second. The network comprises of network processors, baseband modules, and radio frequency frontend.

The communication apparatus 400 further comprises a 5 G-BETTER Wi-Fi. The 5 G-BETTER Wi-Fi encompasses the 3 G/4 G, and comprise a solar cell technology platform that includes energy harvesting for electronic devices, including cell phone devices “E-PHONES” and wireless communication network applications. The E-PHONE would operate on networks such as Wi-Fi, CDMA, WAN, LAN, MAN, WPAN, WWAN, WLAN, GSM, NADC, TDMA, E-TDMA, WCDMA, and CDMA-2000, providing solar cell platform for phone devices, delivery, marketing and maintenance of secure wireless communications for individuals, businesses & entire communities. Wi-Fi is quickly becoming the standard in the delivery of Internet connectivity throughout many organizations, government agencies and businesses. But 5 G-BETTER Wi-Fi is configured to deliver better and secure Wi-Fi services to commercial and residential property owners as well as traditional Internet service providers that are looking to improve the service offerings. Embodiments provide a 5 G-BETTER Wi-Fi comprising full service wireless networks for businesses, individual building owners and municipalities. Certain embodiment provides 5 G-BETTER Wi-Fi comprising great solution for upgrading conventional Wi-Fi network. As connectivity to the Internet has become a necessary utility, just like water, phone and electrical hookups, so has the trend of providing a central Internet connection, and 5 g-BETTER Wi-Fi further provide better data transmission speed. In this regards, truck Stops would receive accelerated Wi-Fi services throughout any region quickly and efficiently. Embodiment further provides 5 G-BETTER ISP Wi-Fi—Internet Service Providers (ISPs), providing network connectivity at much better speeds. This connectivity can be distributed throughout an entire area without the need to re-wire any current wired connections. Not only is this faster than older wired networks, but it's also easier to scale up and upgrade the technology, providing further applications. 5 G-BETTER Wi-Fi provides the ability to distribute large amounts of bandwidth up to 30 miles between Wi-Fi base stations.

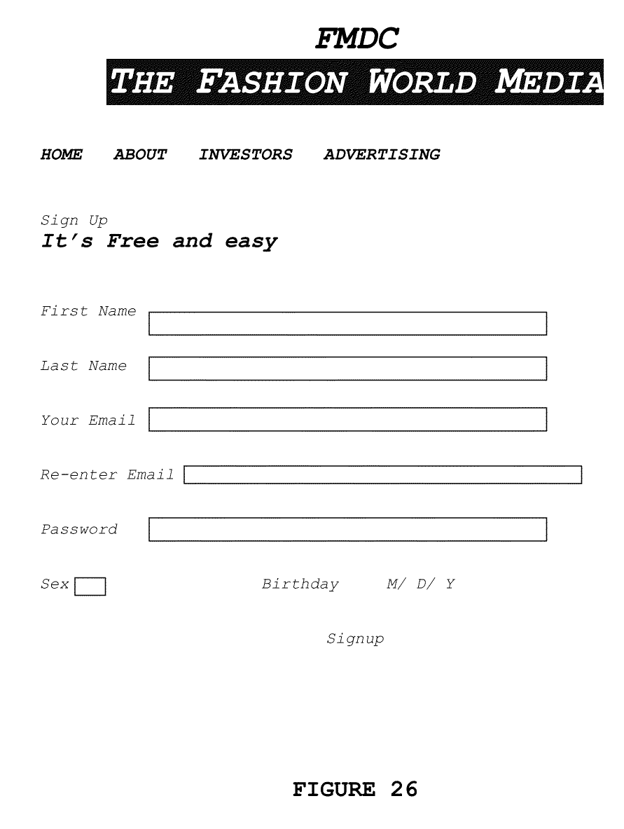

Referring to FIG. 26 is an exemplary embodiment of a signup page. At least one environment comprises the fashion world media, a social platform for publicly declaring the will of positivism, sharing human knowledge for organized studies, dealings with the body of facts and truths to explain the phenomena of social media in the environment of natural fashion media, model media, and dress code media “FMDC,” a dimension of social sustainability to gracefully improve corporate and community well being through social, cultural, environmental, and economic vision by the goodness of change. Change can be embraced with the hope for sustainable cultural independence. Disclosed embodiments further provide the signup page comprising at least one of: the fashion world media, FMDC, home, about, investor, advertising, signup, it's free and easy, name, last name, email, re-enter email, password, sex, birthday, and month, day, year “M/D/Y.”

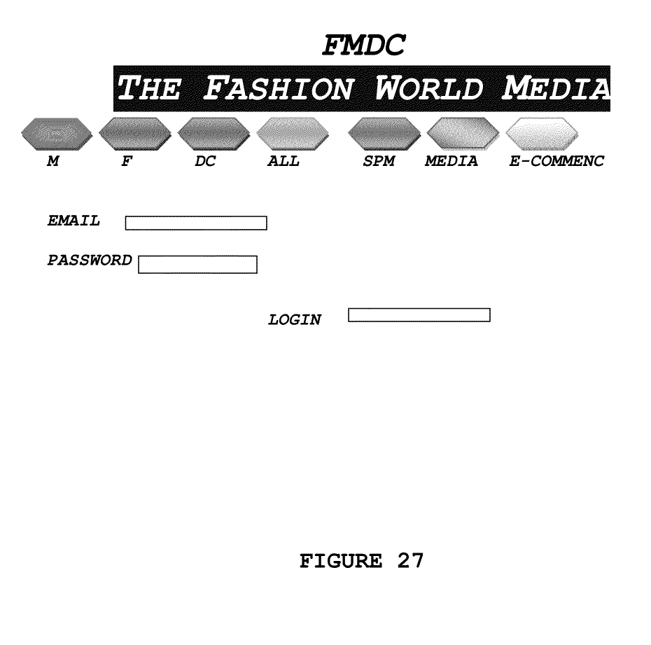

Referring to FIG. 27 is seen an exemplary embodiment of the login page. Knowledge are reliably shared to produce useful feeds relating to a person, a product, a culture, an association, entertainment, a sport, an event, a career, a show, a business, an organization, a program, an educational institution, a corporation, consisting of topics of information to aid and educate the society through the environment of social media, asserting the influence of positivism for the betterment of the society. Disclosed embodiments further provide the login page comprising at least one of: the fashion world media, FMDC, model “M”, fashion “F”, dress code “DC”, all mails “All”. Special mails “SPM”, media, e-commence, email, password, and login.

The Fashion World Media (FWM) is launched as innovative, fashion-inspired social media platform for cultural interest aficionados and for the general public, and would be found at this link: www.thefashionworldmedia.com. Let the world capture fashion power-trends by examining the universe of model-related products and beauty services.

FWM is a platform for exploring some of the key fashion industry markers including:
A. Power Trends
A. Support System for fashion style announcements
B. Centralized Communication-hub for brand awareness
C. Improved fashion community awareness via social networking

Embodiments provide fashion social networking environment that is spearheaded by individuals and regularly feature professional models, fashion outlets, businesses, corporations, product models, business models, photographers, make up artists, hairstylists, fashion employees, beauticians, and other interested, qualified groups, consists of the following:
A. Fashion Media
B. Model Media
C. Dress Code Media

While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure. It is to be understood that the scope of the present invention is not limited to the above description, but encompasses the following claims;

What is claimed:

1. A method of managing topics of information in a centralized communication environment; comprising: a computer readable medium comprising software code configured for a media management applications; at least a user interface; said software code further operable for implementing functions for at least one of: generating an application environment within said user interface, providing a search engine environment, said environment comprising at least a platform; displaying in said platforms a listing of at least a topic source, said topic source providing access to media files; displaying in said platforms a listing of user selectable media file identifiers, each identifier associated with at least one media file and with at least one topic source to cause at least a computer device to receive at least a reference topic document; displaying selected topic document as a topic of information associated with at least one of: said topic source, said listed media file identifiers; at least a support system associated with said computer recordable medium for mapping desired communications; and said user interface further comprising at least a control interface associated with said platforms for directing at least one of: said media files, aid topic source, in association with said identifiers.

2. The method of managing topics of information of claim 1, wherein said application environment in association with said support system, further comprises a social media network environment.

3. The method of managing topics of information of claim 1, wherein said social network environment further comprises at least a sharing environment for at least one of: fashion media; model media; and dress code media.

4. The method of managing topics of information of claim 1, wherein said user interface further comprises means for receiving users information associated with users of said social media network environment.

5. The method of managing topics of information of claim 1, wherein said topic sources further comprises media topics being accessed by users of said social media network environment.

6. The method of managing topics of information of claim 1, wherein said platforms further comprises means for retaining an association between said social media network environment and at least a media content communication apparatus.

7. The method of managing topics of information of claim 1, wherein said search engine environment further comprising searching said media content communication apparatus for social network users that have been associated with said social media network environment and retaining an association between at least a new social media network user and said social media network environment.

8. The method of managing topics of information of claim 1, wherein said computer readable medium is associated with said platforms, further comprising columns containing at least one attribute associated with each of said media files.

9. The method of managing topics of information of claim 7, wherein each said attribute is selected from a group comprising at least one of: fashions, models, make up artists, artists, beauticians, hairstylists, photographers, fashion employees, individuals, businesses, at least a title associated with said media file, an artist name associated with a media file, at least an album name associated with said media file, at list a playing list associated with said media file; at least a gaming list associated with said media file; and at least a genre name associated with said media file.

10. The method of managing topics of information of claim 7, wherein said attribute further comprises means for sorting said media file rating.

11. The method of managing topics of information of claim 1, wherein said topic sources further comprises a source selected from a group of sources comprising at least one of: search engine environment; science topics of information; data associated with at least a portable mobile device; at least an Internet radio station; at least a user local library; at least an online media service; at least a server; at least a cache engine; at least a content distribution device; at least a remote communication device; and at least an instant messaging platform.

12. The method of managing topics of information of claim 1, wherein said platforms further configured with said media file identifiers for providing access to said topic sources to affect at least a media file associated with said selected media file identifier.

13. The method of managing topics of information of claim 1, wherein said applications further comprises method of sharing at least a content item on said content distribution device.

14. The method of managing topics of information of claim 1, wherein said computer readable medium further configured for establishing a browsing session between at least a communication apparatus and at least a content source.

15. The method of managing topics of information of claim 1, wherein said platforms further comprising means for providing a selection of at least a content item by at least a user.

16. The method of managing topics of information of claim 1, wherein said platforms further comprising means for sharing knowledge relating to at least one of: engineering topics; transportation topics; science topics; topics of information relating to at least one of: fashion, model, dress code.

17. The method of managing topics of information of claim 1, wherein said platforms further comprising means for posting at least one of: photos; videos; blogs; text; tweets; discussions; drawings; and comments, relating to at least one of: fashion; model; dress code.

18. The method of managing topics of information of claim 1, wherein said computer readable medium further comprising means for loading at least an identifier of the content topic sources in at least an application to cause at least a shared environment.

19. The method of managing topics of information of claim 1, wherein said computer readable medium further comprising means for tracking data associated with the browsing and sharing of the content topics.

20. The method of managing topics of information of claim 1, wherein said computer readable medium further comprising means for populating feeds from at least a media file associated with said selected media file identifier for transmission within said social media network environment.

21. The method of managing topics of information of claim 1, wherein said platforms further comprises at least a computing system for implement said social media network environment.

22. The method of managing topics of information of claim 1, wherein said platforms further comprising means for accessing at least a data storage medium, further comprising plurality of nodes each corresponding to at least one of: a respective user of said social media network environment; a respective concept of at least a fashion social media network environment; at least an edge that is defined by a connection between at least a node and at least a set of user nodes representing at least a social relationship.

23. The method of managing topics of information of claim 22, wherein each said user has at least a user account and at least an administrative privilege with respect to the user's corresponding user node.

24. The method of managing topics of information of claim 23, wherein each said node further comprises at least one of: means for storing corresponding webpage; means for identifying corresponding webpage; means for hosting corresponding webpage; means for providing at least a communication environment; means for providing at least a user profile for a hosted page; means for modifying at least a user profile, means for identifying at least a concept note; means for providing at least a concept profile page for at least a user.

25. The method of managing topics of information of claim 24, wherein said concept node further corresponding to at least a concept profile page hosted by at least a computer system for performing at least one of: administering to at least a registered user with said social media network environment; modifying said concept page; generating at least data of actions taken by at least a user; contributing to said concept page; writing to said concept page.

26. The method of managing topics of information of claim 1, wherein said computer readable medium further associated with said platform to enable at least one of: searching at least a database for at least one science topics of information; an editor.

27. The method of managing topics of information of claim 1, further comprising providing searched results on at least a display device comprising posting the searched data with multiple features for at least one similar devices to enable at least a user make a purchase decision based on at least one information on the posted multiple features.

28. The method of managing topics of information of claim 27, wherein said posted multiple features further comprises at least one of: make, model, specification, price, design, color, warranty, fashion, manufacturer, country, brand, trend, style, awareness, uniqueness, product life, name, e.t.c.

29. The method of managing topics of information of claim 1, wherein said platform further configured with means for connecting at least multiple users of the network, further comprises at least a button comprising at least one of: FASHION; MODEL; DRESS CODE; LIKE; FOLLOW; CONNECT; MEMBER; DRIVE; FLY; SHIP; WALK; HIDE; RUN; JUMP; ACT; FEED; LOVE; and ALIGN.

30. The method of managing science topics of information of claim 26, wherein searching said database further comprises searching for at least one of: new media content; new image objects; new video objects; new text objects; and new concept.

31. The method of managing science topics of information of claim 1, wherein said computer readable medium further comprises at least a sensor means associated with at least a camera apparatus, said camera apparatus further comprising at least one of: an LED, CMOS, opto-isolator, a chip, a flash memory, a network apparatus, a media device, each said camera device configured for network applications, comprising at least one of: obtaining images; transmitting images; providing a communication network; providing entertainment network; providing detection network; enabling user classification; transmitting a wave carrier signal; and means for exchanging network information.

32. The method of managing science topics of information of claim 1, wherein said user interface further comprises at least one of: interactive television application; wavelet carrier signal; means for exchanging information; interactive detection application; interactive communication application; wireless device applications; wired device applications; means for sensing the state of an environment; a wireless computer in communication with a network; a wired computer in communication with a network; an electronic device in communication with a network; a camera apparatus in communication with a network; at least a CMOS processor; a radio frequency transceiver; a radio frequency; an RF transceiver; an IR transceiver; a data transmission device, IR transmitter; a transducer; a CMOS multiple antenna on chip; a packet control device; means for receiving request messages; a call control interface; a MOS based active sensor array; a MOSFET active sensors array; a CMOS based active sensor array; and apparatus for distributing data.
